(19) United States
(12) Patent Application Publication
(10) Pub. No.: US 2007/0214925 A1
(43) Pub. Date: Sep. 20, 2007

(54) SUBSTRATE DICING SYSTEM, SUBSTRATE MANUFACTURING APPARATUS, AND SUBSTRATE DICING METHOD

(75) Inventors: Yoshitaka Nishio, Osaka (JP); Yasutomo Okajima, Osaka (JP); Yukio Oshima, Osaka (JP); Hiroyuki Onari, Hyogo (JP); Kazuhiro Yoshimoto, Osaka (JP)

Correspondence Address: SNELL & WILMER L.L.P. (Main), 400 EAST VAN BUREN, ONE ARIZONA CENTER, PHOENIX, AZ, 85004-2202, US

(73) Assignee: MITSUBISHI DIAMOND INDUSTRIAL CO., LTD, OSAKA (JP)

(21) Appl. No.: 10/595,201

(22) PCT Filed: Sep. 24, 2004
(86) PCT No.: PCT/JP04/13962

§ 371 Date: Jan. 2, 2007

(30) Foreign Application Priority Data
Sep. 24, 2003 (JP) 2003332416

(51) Int. Cl. B26D 7/06; B26D 5/08; B26D 9/00

(52) U.S. Cl. 83/401; 83/517; 83/559; 83/733; 901/40

(57) ABSTRACT

The objective of the present invention is to make an entire system compact and provide a substrate cutting system capable of efficiently cutting a variety of substrates. A substrate cutting system according to the present invention includes: pair of scribing line forming means arranged facing each other; pair of scribing devices for supporting the pair of scribing forming line means such that one of the pair of scribing forming line means moves on a first surface of a substrate in an X axial direction and the other of the pair of scribing forming means moves on a second surface of the substrate in the X axial direction; a scribing device guide body for supporting the pair of scribing devices such that the pair of scribing devices moves in a Y axial direction; and a substrate supporting means for supporting the substrate in an X-Y plane such that the pair of scribing forming line means scribes the first surface of the substrate and the second surface of the substrate.

### TECHNICAL FIELD

The present invention relates to a substrate cutting system and a substrate cutting line system used for cutting a mother substrate made of a variety of materials including a mother substrate (e.g., a glass substrate used as a display panel for a liquid crystal display device, etc). In particularly, the present invention relates to a substrate cutting system, a substrate manufacturing apparatus and a substrate cutting method preferably used for cutting a bonded mother substrate for which a pair of brittle material substrates is bonded to each other.

### BACKGROUND ART

Normally, a display panel for a liquid crystal display device, etc is formed with a glass substrate which is a brittle material substrate. In the liquid crystal display device, the display panel is fabricated by bonding a pair of glass substrates with an appropriate space formed therebetween and thereafter, injecting a liquid crystal in the space therebetween.

When such a display panel is fabricated, a bonded mother substrate for which a pair of mother substrates is bonded to each other is cut so as to retrieve a plurality of display panels from the bonded mother substrate. A scribing device used for cutting the bonded mother substrate is disclosed in Japanese Utility Model Publication for Opposition No. 59-22101 (Reference 1).

FIG. 68 shows a view schematically showing the scribing device in Reference 1. The scribing device 950 includes tables 951 having side edges on both sides of a bonded mother substrate 908 mounted thereon, respectively. A clamp member 952 is attached to the table 951 for clamping each side edge of the bonded mother substrate 908. The scribing device 950 includes a pair of cutter heads 953 and 954. The cutter heads 953 and 954 are provided above and below the bonded mother substrate 908 respectively. The cutter heads 953 and 954 are in a state of facing each other with the bonded mother substrate 908 therebetween.

For example, a cutter wheel (disclosed in Patent Document No. 3074143) is used for the cutter heads 953 and 954, which forms a deep vertical crack on a surface of the substrate.

In the scribing device 950 having such a structure, when the bonded mother substrate 908 is fixed to each table 951 by each clamp member 952, a top surface and a bottom surface of the bonded mother substrate 908 are simultaneously scribed, respectively, by the pair of cutter heads 953 and 954, and scribing lines are formed.

Reference 1: Japanese Utility Model Publication for Opposition No. 59-22101

### DISCLOSURE OF THE INVENTION

However, the scribing device 950 requires a breaking device, separately, for cutting the bonded mother substrate 908 on which the scribing lines have been formed. Also, when the bonded mother substrate 908 is cut by the breaking device, it is necessary to invert the bonded mother substrate 908 (inverting such that the upper surface of the bonded mother substrate 908 becomes the lower surface) in order to cut the mother substrate on the other side of the bonded mother substrate 908 after the mother substrate on one side of the bonded mother substrate 908 is cut. Thus, in order to cut display panels from the bonded mother substrate 908, a complex line system has to be constructed.

In order to cut display panels from the bonded mother substrate 908 by using the scribing device 950, a complex line system has to be constructed. The complex system has a footprint area several times larger than the scribing device 950, which is one of the reasons of the manufacturing cost of display panel increases.

The scribing device 950 shown in FIG. 68 simultaneously scribes the top and bottom surfaces of the bonded mother substrate 908 for which a pair of mother substrate is bonded. However, the direction of scribing is limited to only one direction and therefore, a cross scribing (scribing in a direction perpendicular to a scribing line) can not be performed.

Accordingly, another scribing device is further required in order to perform a cross scribing. Therefore, a problem exists that the efficiency of scribing the bonded mother substrate 908 is extremely poor.

Even when a variety of mother substrates are simultaneously cut from the top and bottom surfaces of the substrate by using a device similar to the aforementioned scribing device 950, there is a problem that with one setting for a substrate, a process can not be performed in two directions perpendicular to each other.

The present invention is made to solve the aforementioned problems. The objective thereof is to reduce the footprint area so as to be compact and to provide a substrate cutting system, a substrate manufacturing apparatus and a substrate cutting method capable of cutting a variety of mother substrates efficiently.

A substrate cutting system according to the present invention includes: a pair of scribing line forming means arranged facing each other; a pair of scribing devices for supporting the pair of scribing forming line means such that one of the pair of scribing forming line means moves on a first surface of a substrate in an X axial direction and the other of the pair of scribing forming means moves on a second surface of the substrate in the X axial direction; a scribing device guide body for supporting the pair of scribing devices such that the pair of scribing devices moves in a Y axial direction; and a substrate supporting means for supporting the substrate in an X-Y plane such that the pair of scribing forming line means scribes the first surface of the substrate and the second surface of the substrate, thereby the objective described above being achieved.

The substrate supporting means may include: a substrate supporting device being supporting by the scribing device guide body and moving together with the pair of scribing devices in the Y axial direction; and a fixing device for fixing the substrate in the X-Y plane.

The substrate supporting device may support the substrate such that the substrate supporting device does not rub the substrate or exert any force on the substrate when the pair of scribing devices and the scribing device guide body move in the Y axial direction.

The substrate supporting device may include: a first substrate supporting section being provided on one side of the substrate supporting device with respect to a moving direction of the scribing device guide body.

The first substrate supporting section may include a plurality of first substrate supporting units, the plurality of first substrate supporting units moving in parallel along the moving direction of the scribing device guide body, and the plurality of first substrate supporting units moves together with the scribing device guide body along with the movement of the scribing device guide body.

The first substrate supporting unit may include a substrate supporting means for supporting the substrate.

The substrate supporting section may be a plurality of cylindrical rollers.

The substrate cutting system may include at least one rotation transmission means for rotating the plurality of cylindrical rollers in accordance with the movement of the scribing device guide body.

The substrate cutting system may include a control section for rotating the plurality of cylindrical rollers in accordance with the movement of the scribing device guide body.

The substrate supporting means may be a plurality of belts.

The substrate cutting system may include at least one rotation transmission means for circling the plurality of belts in accordance with the movement of the scribing device guide body.

The substrate cutting system may include a control section for circling the plurality of belts using a motor in accordance with the movement of the scribing device guide body.

The substrate supporting device may include: a second substrate supporting section being provided on another side of the substrate supporting device with respect to a moving direction of the scribing device guide body.

The second substrate supporting section may include a plurality of second substrate supporting units, the plurality of second substrate supporting units moving in parallel along the moving direction of the scribing device guide body.

The second substrate supporting unit may include a substrate supporting means for supporting the substrate.

The substrate supporting section may be a plurality of cylindrical rollers.

The substrate cutting system may include at least one rotation transmission means for rotating the plurality of cylindrical rollers in accordance with the movement of the scribing device guide body.

The substrate cutting system may include a control section for rotating the plurality of cylindrical rollers in accordance with the movement of the scribing device guide body.

The substrate supporting means may be a plurality of belts.

The substrate cutting system may include at least one rotation transmission means for circling the plurality of belts in accordance with the movement of the scribing device guide body.

The substrate cutting system may include a control section for circling the plurality of belts using a motor in accordance with the movement of the scribing device guide body.

The pair of scribing devices may include a cutter head for transmitting a pressing force of the scribing forming means onto the substrate using a servo motor.

The substrate cutting system may include a steam unit section for spraying steam onto the first surface and the second surface of the substrate.

A substrate drying means may be provided in the steam unit section, the substrate drying means being for drying the first surface and the second surface of the substrate.

The substrate drying means may include: at least one air knife body having a slit section formed thereon, the slit section capable of discharging a pressurized gas; an air knife supporting section for supporting the at least one air knife body such that a fluid lead-in path is formed between the at least one air knife body and a main surface of the substrate in a substrate transportation path, the at least one air knife body and the substrate move relative to each other in the substrate transportation path, the fluid lead-in path having approximately a uniform shape in a direction perpendicular to the relative moving direction; and a wall face, arranged facing the at least one air knife body in the relative moving direction, for constituting a fluid lead-out path, the fluid lead-out path leading out the dry gas such that the dry gas, which has been discharged from the slit section and passed through the fluid lead-in path, moves away from the main surface of the substrate.

The wall face may be arranged at a position facing the at least one air knife unit body such that a fluid-sectional area of the fluid lead-out path is larger than fluid-sectional area of the fluid lead-in path.

The air knife supporting section may include a clearance adjustment means for adjusting a clearance between the at least one air knife body and the main face of the substrate using the Venturi effect which occurs when the dry gas passes through the fluid lead-in path.

The clearance adjustment means may include: an elastic member for supporting the at least one air knife body between the elastic member and the main surface of the substrate in an oscillating manner; and a laminar flow forming face for passing the dry gas between the laminar flow forming face and the main surface of the substrate in a laminar flow state, the laminar flow forming face being formed on one side surface of the at least one air knife body, the one side surface facing the main surface of the substrate and forming a portion of the fluid lead-in path.

Each side of the at least one pair of air knife bodies on which the slit section is formed may be arranged facing each other.

The substrate cutting system may include a substrate carry-out device for retrieving the substrate cut by the steam unit section.

The substrate carry-out device may include a carry-out robot, the carry-out robot including: a substrate holding means for holding the substrate; a substrate rotating means for rotating the substrate holding means, having the substrate supported thereby, around a first axis vertical to the substrate; and a substrate circling means for circling the substrate rotating means around a second axis, the second axis being different from the first axis vertical to the substrate held by the substrate holding means.

The circling of the substrate holding means by the substrate circling means may be transmitted to the substrate rotating means by a dynamic power transmission mechanism which results in the rotation of the substrate rotating means to rotate.

The rotating direction of the substrate holding means by the substrate rotating means may be opposite to the circling direction of the substrate holding means by the substrate circling means.

The rotating angle of the substrate holding means by the substrate rotating means may be twice the circling angle of the substrate holding means by the substrate circling means.

The rotating drive of the substrate holding means by the substrate rotating means and the circling drive of the substrate holding means by the substrate circling means may be independent from each other.

The dynamic power supply of the substrate rotating means and the dynamic power supply of the substrate circling means may be independent from each other.

The substrate cutting system may further include a substrate inversion device for inverting the top and bottom surfaces of the substrate transported by the substrate transportation device.

The substrate cutting system may include a positioning unit section for positioning the substrate.

The positioning unit section may include a plurality of vacuum adsorption heads for holding the substrate.

The substrate holding means may be a plurality of vacuum adsorption heads for holding the substrate.

The vacuum adsorption head may include: a vacuum adsorption pad for vacuum-adsorbing the substrate; a suction shaft for holding the suction pad and having an exhaust hole provided thereon, the exhaust hole for exhausting air into the adsorption pad; a casing section for regulating the moving range of the suction shaft to hold the suction shaft such that the suction shaft is slightly movable; and an elastic supporting member for elastically holding the suction shaft such that the suction shaft is slightly movable within the casing section in its axial direction and in a direction oblique to the axial direction.

The suction shaft includes the step section in a shape of flange provided at approximately in the middle of the casing section, the casing section may include: a cylindrical section having a space therewithin, the space for holding the elastic supporting member such that the elastic supporting member is deformable; an upper casing plate for closing an upper end of the cylindrical section with a first opening remaining open; and a lower casing plate for closing a lower end of the cylindrical section with a second opening remaining open, the elastic supporting section including: an upper spring held between the upper casing plate and the step section; a lower spring held between the lower casing plate and the step section.

The plurality of vacuum adsorption heads may include a plurality of adsorption pads for holding the substrate by suction or causing compressed air to gush so as to float the substrate, and the plurality of vacuum adsorption heads positions the substrate in a state in which a laminar flow is formed between each of the plurality of adsorption pads and the substrate.

The substrate cutting system may include a removal means for removing an unnecessary portion of the cut substrate.

The plurality of belts may be wound around between a frame on a carry-in side of the substrate and a frame on a carry-out side of the substrate, and the plurality of belts may lower below the scribing device guide body or may emerge above the scribing device guide body from under the scribing device guide body while the first substrate supporting section is moving.

The plurality of belts may be wound around between a frame on a carry-in side of the substrate and a frame on a carry-out side of the substrate, and the plurality of belts may lower below the scribing device guide body or may emerge above the scribing device guide body from under the scribing device guide body while the second substrate supporting section is moving.

The substrate may be a bonded mother substrate for which a pair of mother substrates is bonded to each other.

A substrate manufacturing apparatus may include: a substrate cutting system according to claim 1; and a chamfering system for chamfering an edge face of a cut substrate, wherein the substrate cutting system is connected to the chamfering system.

The substrate manufacturing apparatus may include: a substrate cutting system according to claim 1; and an inspection system for inspecting the function of a cut substrate, wherein the substrate cutting system is connected to the inspection system.

The substrate manufacturing apparatus may further include an inspection system for inspecting the function of the cut substrate.

A method according to the present invention for cutting a plurality of unit substrates from a mother substrate includes: a forming step of forming scribing lines on a first surface of the mother substrate and a second surface of the mother substrate by a pair of scribing line forming means, the forming step includes the step of forming, on the mother substrate, a first scribing line for cutting a first unit substrate from the mother substrate and a second scribing line for cutting a second unit substrate from the mother substrate by moving the pressure onto the mother substrate by each of the pair of scribing line forming means such that the pressure onto the mother substrate is not interrupted, thereby the objective described above being achieved.

The forming step may further include the step of forming number N scribing line for cutting number N unit substrate from the mother substrate by moving the pressure onto the mother substrate such that the pressure onto the mother substrate is not interrupted, and N is an integer which is larger than or equal to 3.

The forming step may include the steps of: (1) forming the scribing line on the mother substrate by moving the pressure onto the mother substrate along the outside’ side of the first unit substrate and the outside’ side of the second unit substrate; (2) forming the scribing line on the mother substrate by moving the pressure onto the mother substrate on an edge of an outer circumference of the mother substrate; and (3) forming the scribing line on the mother substrate by moving the pressure onto the mother substrate along the inside’ side of the first unit substrate and the inside’ side of the second unit substrate.

The inside’ side of the second unit substrate faces the inside's side of the first unit substrate, the step (3) may include the steps of: (3a) forming the scribing line on the mother substrate by moving the pressure onto the mother substrate along the inside’ side of the first unit substrate; (3b) after performing (3a), forming the scribing line on the mother substrate by moving the pressure onto the mother substrate on an edge of an outer circumference of the substrate; (3c) after performing (3b), forming the scribing line on the mother substrate by moving the pressure onto the mother substrate along the inside’ side of the second unit substrate; (3d) after performing (3c), forming the scribing line on the mother substrate by moving the pressure onto the mother substrate on an edge of an outer circumference of the substrate;

The forming step further includes the step of reducing the pressure onto the mother substrate.

The forming step may include the steps of: forming the scribing line along a first direction; and moving the pressure onto the mother substrate such that a scribing line formed along the first direction and a scribing line to be formed along a second direction are connected to each other by a curve, the second direction being different from the first direction.

A method according to the present invention for cutting a brittle material substrate, the brittle material substrate being cut by a device, the device including: a substrate supporting device for supporting a lower surface of the brittle material substrate and fixing at least one end of the brittle material substrate; and a pair of scribing line forming means arranged on both sides of the brittle material substrate's surface, the pair of scribing forming section facing each other with the brittle material substrate therebetween, the substrate supporting device has a space in the center of the substrate supporting device, the pair of scribing line forming means is arranged in the space in the middle of the substrate supporting device, the method including the step of: moving the pair of scribing line forming means in at least one direction of an X axial direction and a Y axial direction and further moving the substrate supporting device in at least one direction of the X axial direction and the Y axial direction so as to cut the brittle material substrate, thereby the objective described above being achieved.

The substrate supporting device may support the brittle material substrate so as not to rub the substrate or exert any force on the brittle material substrate.

Hereinafter, the function of the present invention will be described.

According to the substrate cutting system of the present invention, a substrate supporting means supports a substrate such that a space is movable on an X-Y plane surface, the space between which each scribing line forming means from one main surface side and the other main surface side faces each other. Therefore, each scribing line forming means respectively can scribe the substrate in accordance with undulations and bendings of the substrate such that each of the scribing line forming means balances the load applied to each of the scribing line forming means facing each other, respectively. As a result, the scribing lines formed on the substrate have an excellent quality. When the substrate is cut along the scribing lines, the cut face of the substrate has an extremely excellent quality.

Furthermore, according to the substrate cutting system, a space is provided between the scribing device guide body and the substrate supporting device. The space can be moved in the Y direction and the substrate can be fixed by a fixation device, thereby preventing the substrate being shifted from a predetermined position when the space is moved or both main surfaces of the substrate are scribed

According to the substrate cutting system, when a substrate supporting device moves in the Y axis direction, the substrate supporting device does not rub the substrate and supports the substrate or does not exerts any force on the substrate. Thus, when the scribing line forming means generates a vertical crack into the substrate, there is no possibility that an undesired crack will result from the cutter wheel.

Furthermore, according to the substrate cutting system, a space is provided between the scribing device guide body and the first substrate supporting section. The space is moved in the Y direction. When the space is moved or both main surfaces are scribed, the first substrate supporting section does not rub the substrate or does not exert any force on the substrate. Therefore, when a vertical crack is created within the substrate by the scribing line forming means, there is no possibility that an undesired crack will result from scribing line forming means.

Furthermore, according to the substrate cutting system, with a structure such that a space is provided between the scribing device guide body and the first substrate supporting unit, the space is moved in the Y direction, and the substrate is fixed by the fixation device, when the space is moved or scribing is performed on both mains surfaces of the substrate, the first substrate supporting unit does not rub the substrate or does not exert any force on the substrate, As a result, when a vertical crack is created within the substrate by the scribing line forming means, there is no possibility that an undesired crack will result from the scribing line forming means.

Furthermore, according to the substrate cutting system of the present invention, when the substrate supporting means moves in the Y direction, the first substrate supporting means does not rub the substrate or does not exert any force on the substrate 90. As a result, when a vertical crack is created within the substrate by the scribing line forming means, there is no possibility that an undesired crack will result from the scribing line forming means.

Furthermore, according to the substrate cutting system, the first substrate supporting means is include a plurality of cylindrical rollers. Thus, the substrate is firmly supported.

Furthermore, according to the substrate cutting system of the present invention, a rotation transmission means can select the direction of rotation or stop the rotation of the plurality of cylindrical rollers in accordance with the movement of the space. In this case, when the clamping of the substrate by the fixation device is released, the substrate supporting device can be used for transporting the substrate.

Furthermore, according to the substrate cutting system of the present invention, the outer circumferential speed of the plurality of cylindrical rollers is controlled so as to match the moving speed of the scribing device guide body in the Y direction. Therefore, when the plurality of cylindrical rollers moves in the Y direction, the plurality of cylindrical rollers does not rub the substrate or does not exert any force on the substrate. As a result, when a vertical crack is created within the substrate by the scribing line forming means, there is no possibility that an undesired crack will result from scribing line means.

Furthermore, according to the substrate cutting system of the present invention, the substrate supporting means is a plurality of belts, the surface of the substrate is supported on a surface of the belt compared to when a cylindrical roller is used. As a result, the substrate is stably supported.

Furthermore, according to the substrate cutting system of the present invention, the rotation transmission means can select the direction of the circling movement or stop the circling movement of plurality of belts in accordance with the movement of the space. Therefore, when the fixation of the substrate by the fixation device is released, the substrate supporting device can be used for transporting the substrate.

Furthermore, according to the substrate cutting system of the present invention, the circling speed of the plurality of belts is controlled so as to match the moving speed of the scribing device guide body in the Y direction. Therefore, when the plurality of belt moves in the Y direction, the plurality of belts does not rub the substrate or does not exert any force on the substrate. As a result, when a vertical crack is created within the substrate by the scribing line forming means, there is no possibility that an undesired crack will result from the scribing line forming means.

Furthermore, according to the substrate cutting system of the present invention, when the second substrate supporting section moves together with the movement of the space, the second substrate supporting section provides assistance to support the portion of the substrate which is not supported by the first substrate supporting section. When the space is moved or both main surfaces are scribed, the second substrate supporting section does not rub the substrate or exert any force on the substrate. Therefore, when a vertical crack is created within the substrate by the scribing line forming means, there is no possibility that an undesired crack will result from the scribing line forming means.

Furthermore, according to the substrate cutting system, with a structure such that a space is provided between the scribing device guide body and the second substrate supporting unit, the space is moved in the Y direction, and the substrate is fixed by the fixation device, when the space is moved or scribing is performed on both mains surfaces of the substrate, the second substrate supporting unit does not rub the substrate or does not exert any force on the substrate. As a result, when a vertical crack is created within the substrate by the scribing line forming means, there is no possibility that an undesired crack will result from the scribing line forming means.

Furthermore, according to the substrate cutting system of the present invention, when the substrate supporting means moves in the Y direction, the first substrate supporting means does not rub the substrate or does not exert any force on the substrate 90. As a result, when a vertical crack is created within the substrate by the scribing line forming means, there is no possibility that an undesired crack will result from the scribing line forming means.

Furthermore, according to the substrate cutting system, the first substrate supporting means is include a plurality of cylindrical rollers. Thus, the substrate is firmly supported.

Furthermore, according to the substrate cutting system of the present invention, a rotation transmission means can select the direction of rotation or stop the rotation of the plurality of cylindrical rollers in accordance with the movement of the space. In this case, when the clamping of the substrate by the fixation device is released, the substrate supporting device can be used for transporting the substrate.

Furthermore, according to the substrate cutting system of the present invention, the outer circumferential speed of the plurality of cylindrical rollers is controlled so as to match the moving speed of the scribing device guide body in the Y direction. Therefore, when the plurality of cylindrical rollers moves in the Y direction, the plurality of cylindrical rollers does not rub the substrate or does not exert any force on the substrate. As a result, when a vertical crack is created within the substrate by the scribing line forming means, there is no possibility that an undesired crack will result from scribing line means.

Furthermore, according to the substrate cutting system of the present invention, the substrate supporting means is a plurality of belts, the surface of the substrate is supported on a surface of the belt compared to when a cylindrical roller is used. As a result, the substrate is stably supported.

Furthermore, according to the substrate cutting system of the present invention, the rotation transmission means can select the direction of the circling movement or stop the circling movement of plurality of belts in accordance with the movement of the space. Therefore, when the fixation of the substrate by the fixation device is released, the substrate supporting device can be used for transporting the substrate.

Furthermore, according to the substrate cutting system of the present invention, the circling speed of the plurality of belts is controlled so as to match the moving speed of the scribing device guide body in the Y direction. Therefore, when the plurality of belt moves in the Y direction, the plurality of belts does not rub the substrate or does not exert any force on the substrate. As a result, when a vertical crack is created within the substrate by the scribing line forming means, there is no possibility that an undesired crack will result from the scribing line forming means.

Furthermore, according to the substrate cutting system of the present invention, since the pressure force of the scribing line forming means is transmitted to the substrate by using the servo motor, the transmittance of the pressure force to the substrate becomes responsive. Thus, the pressure force (scribing load) of the scribing line forming means to the substrate during the scribing can be changed.

Furthermore, according to the substrate cutting system of the present invention, in the case that the substrate is a brittle substrate, when the steam is sprayed onto the top and bottom surfaces of the substrate where a scribing line is formed, the heated moisture infiltrates inside a vertical crack of each scribing line, and the vertical crack extends due to the expanding force. As a result, the substrate can be cut.

Furthermore, according to the substrate cutting system of the present invention, since a substrate-adhered material removal means is provided in order to dry the top and bottom surfaces of the substrate, steam is sprayed on the top and the bottom surfaces of the substrate, and the moisture on the top and the bottom surfaces of the substrate can be completely removed after the substrate is cut. Therefore, there is no need to provide a device having a special anti-water means for the next step.

Furthermore, according to the substrate cutting system of the present invention, the flow of dry gas is formed in the fluid lead-in path, the dry gas being uniformly compressed in a direction perpendicular to the moving direction of the substrate. The fluid material adhered to top and bottom surfaces of the substrate is mixed with the dry gas in the fluid lead-in path and is guided to the fluid lead-out path whose sectional area is larger than that of the fluid lead-in path. The dry gas diffused in the fluid lead-out path forms the flow which accompanies the fluid adhered material in misty state and moves away from top and bottom surfaces of the substrate along the wall surfaces. Thus, the dry gas is compressed in the fluid lead-in path, and thereafter, the dry gas is diffused in the fluid lead-out path. Therefore, the material adhered to the top and bottom surfaces of the substrate does not condense and is mixed into the fluid so as to reduce the size of the material (misty, fineness), whereby the material adhered to the substrate is removed. As a result, both sides of the substrate can be completely dried.

Furthermore, according to the substrate cutting system of the present invention, a wall surface is arranged on a position facing an air knife unit such that the cross-sectional area of the fluid lead-out path is larger than the cross-sectional area of the fluid lead-in path. Thus, the pressurized fluid gushes out from the narrow fluid lead-in path to the wide fluid lead-out path with a great force. Therefore, the flow speed of the fluid increase in one shot. As a result, the capability of removing the adhered material from the top and bottom surfaces of the substrate is further increased.

Furthermore, according to the substrate cutting system of the present invention, air knife supporting sections include clearance automatic adjustment means which adjusts the clearance between air knife bodies and the corresponding top and bottom surfaces of the substrate using the Venturi effect which occurs when the fluid passes through the fluid lead-in path. Thus, the clearance can by stably maintained by adsorbing the bendings and the like of the substrate.

Furthermore, according to the substrate cutting system of the present invention, the clearance adjustment means includes elastic bodies and laminar flow forming faces, the elastic bodies supporting the air knife bodies such that the air knife bodies can oscillate between the elastic bodies and the respective main surfaces (top or/and bottom) surfaces, and the laminar flow forming faces facing the respective top and bottom surfaces of the substrate, forming portions of the fluid lead-in path on one side surface of the respective air knife main bodies and passing the fluid in laminar flow between the laminar flow forming faces and the respective top and bottom surfaces of the substrate. Thus, the laminar flow passes through the fluid lead-in path which is formed on the laminar flow forming faces and the respective top and bottom surfaces of the substrate. As a result, negative pressure is created in the vicinity of the main surfaces of the substrate. The compressive spring of the elastic bodies for holding the air knife bodies upward (holding force) and the negative pressure for attracting the air knife body (suction force) are balanced. As a result, the fluid lead-in path is easily created, the fluid lead-in path having approximately a uniform shape between the air knife bodies and the main surfaces of the substrate in a direction perpendicular to the moving direction of the substrate.

Furthermore, according to the substrate cutting system of the present invention, since air knife bodies are arranged facing each side where slit section is formed, the dry gas steadily flows along the fluid lead-out path so as to move away from the main surface of the substrate, thereby facilitating the drying of the substrate.

Furthermore, according to the substrate cutting system of the present invention, a cut unit substrate is retrieved by using the substrate carry-out device. Thus, it is easy to pass the substrate with the device for the next step.

Furthermore, according to the substrate cutting system of the present invention, the substrate carry-out device includes at least one carry-out robot which includes the substrate rotation means and the substrate circling means. The substrate rotation means rotates the substrate holding means around the first axis and the substrate circling means causes the substrate holding means to circle around the second axis. Thus, the substrate carry-out device can transport the cut unit substrate to the next step with a desired attitude on a plane where the substrate is transported and can simultaneously transport the cut substrate to a plurality of devices for the next step.

Furthermore, according to the substrate cutting system of the present invention, when the rotation operation of substrate rotation means and the circling operation of the substrate circling means are combined, the carry-out robot can transport the cut unit substrate to the next step with a desired attitude on a plane where the substrate is transported.

Furthermore, according to the substrate cutting system of the present invention, the unit substrate can be set at a desired attitude on a transportation plane such that the moving range of a robot arm is minimized.

Furthermore, according to the substrate cutting system of the present invention, the movement of the robot arm can be minimized.

Furthermore, according to the substrate cutting system of the present invention, the attitude of a unit substrate on a transportation plane is readily set.

Furthermore, according to the substrate cutting system of the present invention, the unit substrate can be easily set at a desired attitude on a transportation plane.

Furthermore, according to the substrate cutting system of the present invention, when it is necessary to invert the substrate (invert the sides of a unit panel) for a device of the next step, it is easily handled.

Furthermore, according to the substrate cutting system of the present invention, since the substrate is positioned on the first substrate supporting section before scribing lines are formed. Thus, scribing lines can be accurately formed along lines to be scribed on the top and bottom surfaces of the substrate.

Furthermore, according to the substrate cutting system of the present invention, the plurality of vacuum adsorption heads firmly can receive the substrate from the previous step and stably lift the substrate so as to position the substrate.

Furthermore, according to the substrate cutting system of the present invention, the cut substrate is firmly received and passed on by the plurality of vacuum adsorption heads.

Furthermore, according to the substrate cutting system of the present invention, adsorption shafts of the plurality of vacuum adsorption heads are slightly movable in its axial direction and in a direction diagonal to the axial direction, and are elastically supported so as to move accordingly. Thus, the adsorption pad can firmly hold the substrate in accordance with the main surface of the substrate even if there is a presence of undulations or bendings on the substrate.

Furthermore, according to the substrate cutting system of the present invention, the adsorption pad of the vacuum adsorption head is returned to a state, due a restoring force of the spring, in which the adsorption face of the adsorption pad virtually faces directly downward before the adsorption pad adsorbs the substrate and when the adsorption pad stops adsorbing the substrate. Thus, when the adsorption pad adsorbs the substrate, there is no possibility that the adsorption pad causes damages to the substrate and it does not fail to adsorb the substrate.

Furthermore, according to the substrate cutting system of the present invention, the compressed air is caused to gush out from the respective adsorption pads of the vacuum adsorption heads, and the adsorption pads follow undulations or bendings of the substrate due to the Venturi effect. The compressed air moves so as to maintain the interval constant, the interval being between the substrate and the adsorption pads. Thus, the flow of air between the substrate and the adsorption pads becomes a laminar flow, and the interval between the substrate and the adsorption pads are maintained constant. As a result, the substrate is not damaged and can be accurately positioned.

Furthermore, according to the substrate cutting system of the present invention, undesired portions remaining on unit substrates cut from the substrate can be easily removed.

Furthermore, according to the substrate cutting system of the present invention, the substrate is not rubbed and any force does not exert on the substrate. Therefore, when a vertical crack is created within the substrate by scribing line forming means, there is no possibility that an undesired crack will result from the scribing line forming means.

Furthermore, according to the substrate cutting system of the present invention, the substrate is not rubbed and any force does not exert on the substrate. Therefore, when a vertical crack is created within the substrate by scribing line forming means, there is no possibility that an undesired crack will result from the scribing line forming means.

As a bonded mother substrate for which mother substrates are bonded to each other, since a bonded mother substrate, for which brittle material substrates are bonded to each other and is used for an FPD, is bonded by using an adhesive, bendings and undulations are created in the bonded mother substrate. In the substrate cutting system according to the present invention, each scribing line forming means can scribe the substrate in accordance with the undulations and bendings of the substrate so as to balance the load applied to each scribing line forming means facing each other. Thus, the scribing line forming means can be effectively applied to cutting the bonded mother substrate.

According to a substrate manufacturing apparatus, when a cut unit substrate is transported to a device for the next or later step, an edge of an end face of the cut unit substrate can be chipped and a micro fissure cab be created. As a result, a crack resulting from the chip or the fissure can extend in the entire unit substrate and damage the substrate. However, a chamfering system is connected to the substrate cutting system according to the present invention so as to chamfer end faces of the unit substrate. Thus, it is possible to prevent the damage to the substrate.

According to a substrate manufacturing apparatus, powder (cullet powder) created when the substrate is cut into the unit substrates damages the top surface of the substrate and cuts an electrode formed on the unit substrate. However, the inspection system is connected to the substrate cutting system so as to be able to detect a defect in the substrate (e.g., a scratch or cut of the electrode) at an early stage. Thus, the cost for the unit substrate in manufacture can be reduced.

When a cut unit substrate is transported to a device for the next or later step, an edge of an end face of the cut unit substrate can be chipped and a micro fissure cab be created. As a result, a crack resulting from the chip or the fissure can extend in the entire unit substrate and damage the substrate. However, according to the substrate manufacturing apparatus of the present invention, a chamfering system is connected to the substrate cutting system according to the present invention so as to chamfer end faces of the unit substrate. Thus, it is possible to prevent the damage to the substrate.

According to a substrate manufacturing apparatus, powder (cullet powder) created when the substrate is cut into the unit substrates damages the top surface of the substrate and cuts an electrode formed on the unit substrate. However, according to the substrate manufacturing apparatus of the present invention, the inspection system is connected to the substrate cutting system so as to be able to detect a defect in the substrate (e.g., a scratch or cut of the electrode) at an early stage. Thus, the cost for the unit substrate in manufacture can be reduced.

According to a substrate cutting method, a first scribing line and a second scribing line are formed without stopping the movement of pressure onto the mother substrate. Thus, the scribing processing time for forming the scribing lines can be reduced. The scribing lines formed on the mother substrate can prevent the mother substrate from being cut by an external factor (e.g., the movement of the substrate supporting device). Furthermore, since the mother substrate is unlikely to be cut into two or more portions during forming the scribing lines, it is unlikely that a chip, an oblique cut face or the like will be created on the cut faces of the unit substrate onto which steam is sprayed by the steam unit section.

Furthermore, according to a substrate cutting method, since the scribing lines formed on the mother substrate is unlikely to be cut by an external factor, the mother substrate is prevented from being cut into larger than or equal to two during forming the scribing lines. Thus, it is unlikely that a chip, an oblique cut face or the like will be created on the cut faces of the N unit substrates onto which steam is sprayed by the steam unit section.

Furthermore, according to a substrate cutting method, a first scribing line and a second scribing line are formed without stopping the movement of pressure onto the mother substrate. Thus, the scribing processing time for forming the scribing lines can be reduced. The scribing lines formed on the mother substrate are unlikely to be cut an external factor (e.g., the movement of the substrate supporting device). Thus, since the mother substrate is unlikely to be cut into two or more portions during forming the scribing lines, it is unlikely that a chip, an oblique cut face or the like will be created on the cut faces of the unit substrate onto which steam is sprayed by the steam unit section.

Furthermore, according to a substrate cutting method, a first scribing line and a second scribing line are formed without stopping the movement of pressure onto the mother substrate. Thus, the scribing processing time for forming the scribing lines can be reduced. The scribing lines formed on the mother substrate are unlikely to be cut by an external force. Thus, since the mother substrate can be prevented from being be cut into two or more portions during forming the scribing lines, it is unlikely that a chip, an oblique cut face or the like will be created on the cut faces of the unit substrate onto which steam is sprayed by the steam unit section.

Furthermore, according to a substrate cutting method, since pressure onto the mother substrate is reduced when the mother substrate is pressed by the scribing line forming means, abrasion of the scribing line forming means can be suppressed.

According to a substrate cutting method, the pressure onto the mother substrate can be moved such that the scribing line formed along the first direction and the scribing line to be formed along the second direction are connected by a curve. Thus, damage to each scribing line forming means can be reduced, the damage being created when the direction of each scribing line forming means is changed from the first direction to the second direction.

According to a substrate cutting method, the substrate supporting device is moved together with the pair of scribing line forming means. Thus, a scribing line is formed at a desired location and a brittle material substrate can be cut while the brittle material substrate is partially supported without bending the brittle material substrate.

According to a substrate cutting method, when the substrate supporting device is moved, an external force which exerts on the brittle material substrate is suppressed. Thus, it is possible to suppress the creation of an undesired crack (horizontal crack) when a scribing line is formed.

The substrate cutting system according to the present invention is capable of simultaneously performing a cutting processing in two directions orthogonal to each other on the top and bottom surfaces of the substrate with one setting of the substrate since the substrate cutting system according to the present invention has a structure that the substrate is held by clamp devices and is supported by a substrate supporting device which slides in accordance with to the movement of a cutting guide body. Thus, the size of the entire system can be reduced, and a variety of substrates can be effectively cut.

### BRIEF DESCRIPTION OF THE DRAWINGS

FIG. 1 is a perspective view schematically showing a substrate cutting system 1 according to Embodiment 1 of the present invention.

FIG. 2 is a perspective view schematically showing the substrate cutting system 1 when viewed from another direction.

FIG. 3 is a perspective view schematically showing enlarged important constituents of the substrate cutting system 1.

FIG. 4 is a perspective view schematically showing other enlarged important constituents of the substrate cutting system 1.

FIG. 5A is a view for explaining a carry-out robot 140 of a substrate carry-out device 80.

FIG. 5B is a view for explaining the carry-out robot 140 of the substrate carry-out device 80.

FIG. 5C is a view for explaining a carry-out robot 500.

FIG. 5D is a view for explaining the carry-out robot 500.

FIG. 5E is a view for explaining the carry-out robot 500.

FIG. 6 is a side view showing a first substrate supporting unit provided on the substrate carry-out device 80.

FIG. 7 is a front view showing a first substrate supporting section when viewed from a scribing device guide body's side of the substrate cutting system 1.

FIG. 8 is a block diagram schematically showing a clutch unit provided on a substrate supporting section of the substrate cutting system 1.

FIG. 9 is a side view showing the clutch unit.

FIG. 10 is a front view showing important constituents of a steam unit section of the substrate cutting system 1.

FIG. 11 is a side cross-sectional view partially showing the structure of a steam unit of the steam unit section.

FIG. 12 is a perspective view showing the structure of a clamp device provided in the substrate cutting system 1 and explaining the operation thereof.

FIG. 13 is a perspective view showing the structure of the clamp device provided in the substrate cutting system 1 and explaining the operation thereof.

FIG. 14 is a side view showing an example of a cutter head provided in a substrate cutting device of the substrate cutting system 1.

FIG. 15 is a front view showing important constituents of the cutter head.

FIG. 16 is a front view showing another example of the cutter head provided in the substrate cutting device.

FIG. 17 is a schematical plan view for explaining the operation of the substrate cutting system 1.

FIG. 18 is a schematical plan view for explaining the operation of the substrate cutting system 1.

FIG. 19 a diagram showing a scribing pattern when a substrate is scribed in the substrate cutting system.

FIG. 20 is a broken cross-sectional view showing the structure of the vacuum adsorption head 600.

FIG. 21 is a cross-sectional view showing the structure of the vacuum adsorption head 600.

FIG. 22 is an exploded perspective view showing the structure of the vacuum adsorption head 600.

FIG. 23 is a cross-sectional view showing an example of an adsorption pad used in the vacuum adsorption head 600.

FIG. 24 is a view schematically showing a vacuum adsorption device 640 used in the vacuum adsorption head 600.

FIG. 25A is a diagram schematically showing a positional change of the adsorption pad in the vacuum adsorption head.

FIG. 25B is a diagram schematically showing a positional change of the adsorption pad in the vacuum adsorption head.

FIG. 25C is a diagram schematically showing a positional change of the adsorption pad in the vacuum adsorption head.

FIG. 26 is a diagram schematically showing a state an object to be adsorbed having a step is adsorbed in the vacuum adsorption device 640.

FIG. 27 is a top view showing a table having vacuum adsorption heads used thereon.

FIG. 28 is a side view showing a table having vacuum adsorption heads used thereon.

FIG. 29 is an explanatory diagram for explaining the positioning operation.

FIG. 30 is a diagram schematically showing a state in which an object to be adsorbed is floated.

FIG. 31 is a cross-sectional view showing the structure of an adsorption pad in the conventional example 1.

FIG. 32 is a cross-sectional view showing the structure of an adsorption pad in the conventional example 2.

FIG. 33 is a perspective view schematically showing an example of a substrate-adhered material removal device 700.

FIG. 34 is a perspective view schematically showing an air knife unit and a unit holding section which holds the air knife unit.

FIG. 35 is a schematical cross-sectional view for explaining the structure of an air knife which constitutes the air knife unit.

FIG. 36 is a diagram for explaining a state of air knife units before the substrate is transported to a substrate processing section.

FIG. 37 is a diagram for explaining a state of the air knife units when the air knife units process the top and bottom surfaces of the substrate.

FIG. 38 is a perspective view schematically showing a substrate-adhered material removal device 1000.

FIG. 39 is a perspective view schematically showing the structure of another unit holding section.

FIG. 40 is a perspective view schematically showing a substrate-adhered material removal device 1500.

FIG. 41 is an external cross-sectional view showing a connection air knife unit 1600.

FIG. 42 is a diagram schematically showing the structure of a substrate-adhered material removal device 2000.

FIG. 43 is a perspective view schematically and entirely showing a substrate cutting system 200.

FIG. 44 is a plan view schematically showing the substrate cutting system 200.

FIG. 45 is a side view schematically showing the substrate cutting system 200.

FIG. 46 is a perspective view schematically showing a positioning unit section of the substrate cutting system 200.

FIG. 47 is a plain view schematically showing a lift conveyor section of the substrate cutting system 200.

FIG. 48 is a side view showing a third substrate supporting unit of the lift conveyor section 200.

FIG. 49 is a schematical view for explaining a panel separation section of the substrate cutting system 200.

FIG. 50 is a partial schematical plan view for explaining the operation of the substrate cutting system 200.

FIG. 51 is a partial schematical plan view for explaining the operation of the substrate cutting system 200.

FIG. 52 is a partial schematical plan view for explaining the operation of the substrate cutting system 200.

FIG. 53 is a partial schematical plan view for explaining the operation of the substrate cutting system 200.

FIG. 54 is a partial schematical plan view for explaining the operation of the substrate cutting system 200.

FIG. 55 is a partial schematical plan view for explaining the operation of the substrate cutting system 200.

FIG. 56 is a perspective view schematically and entirely showing an example of a substrate cutting system 400.

FIG. 57A is a perspective view schematically showing a first substrate supporting unit of a substrate supporting device of the substrate cutting system 400.

FIG. 57B is a perspective view schematically showing a first substrate supporting unit of the substrate supporting device of the substrate cutting system 400.

FIG. 58 is a side view for explaining the operation of the substrate supporting device of the substrate cutting system 400.

FIG. 59 is a schematical plan view for explaining the operation of the substrate cutting system 400.

FIG. 60 is a schematical plan view for explaining the operation of the substrate cutting system 400.

FIG. 61 is a schematical plan view for explaining the operation of the substrate cutting system 400.

FIG. 62 is a schematical plan view for explaining the operation of the substrate cutting system 400.

FIG. 63 is a diagram schematically showing an example of the structure of a substrate manufacturing apparatus 801 according to the present invention.

FIG. 64 is a diagram showing the structure of a substrate manufacturing apparatus 802 and a substrate manufacturing apparatus 803 according to the present invention.

FIG. 65 is a flowchart showing a procedure for cutting the bonded mother substrate 90 according to an embodiment of the present invention.

FIG. 66 is a diagram showing the bonded mother substrate 90 which is used in the scribing step performed in step 1102 (FIG. 65).

FIG. 67 is a flowchart showing a scribing procedure which is performed during the scribing step performed in step 1102 (see FIG. 65).

FIG. 68 is a front view showing the structure of a conventional scribing device.

### BEST MODE FOR CARRYING OUT THE INVENTION

Hereinafter, embodiments of the present invention will be described in detail with reference to the drawings.

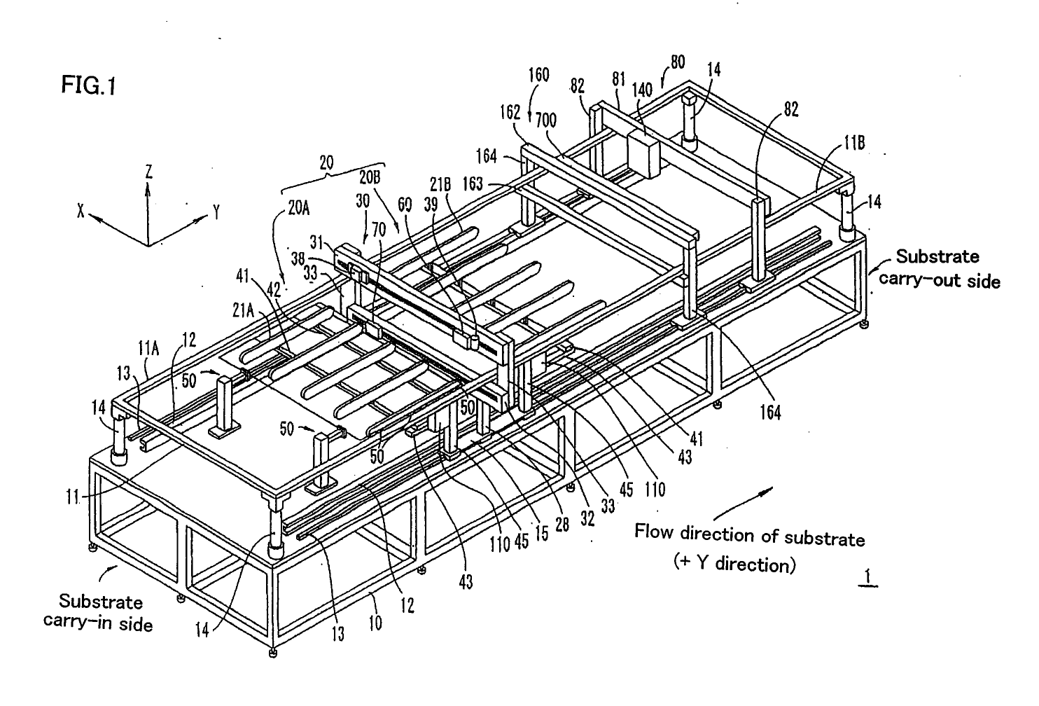

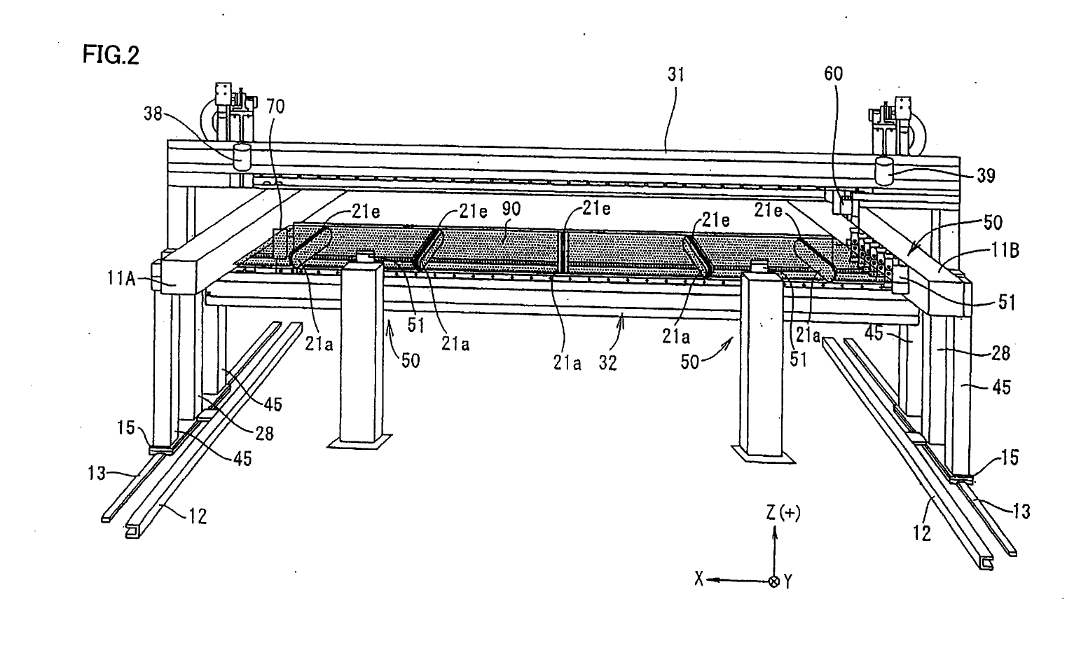

FIGS. 1 and 2 are perspective views entirely and schematically showing one example of a substrate cutting system according to the present invention. FIGS. 1 and 2 are viewed from different directions.

In the present invention, the term “substrate” includes a single plate, such as a mother substrate cut into a plurality of substrates, a metal substrate (e.g., a steel plate), a wood plate, a plastic plate and a brittle material substrate (e.g., a ceramic substrate, a semiconductor substrate and a glass substrate). However, the substrate according to the present invention is not limited to such a single plate. Furthermore, the substrate according to the present invention includes a bonded substrate for which a pair of substrates is bonded to each other and a stacked substrate for which a pair of substrates is stacked on each other.

In the substrate cutting system in the present invention, for example, when a panel substrate (bonded substrate for display panel) for a liquid crystal device is manufactured from a pair of glass substrates bonded to each other, a plurality of panel substrates (bonded substrate for display panel) are cut, by the substrate cutting system according to the present invention, from the bonded mother substrate 90 for which a pair of mother glass substrates is bonded to each other.

In a substrate cutting system 1 according to Embodiment I of the present invention, description will be made by referring to the side where a first substrate supporting section 20A is arranged, as a “substrate carry-in side” and the side where a substrate carry-out device 80 is arranged, as a “substrate carry-out side”, respectively. In the substrate cutting system 1 according to the present invention, the direction in which a substrate is transported (flow direction of the substrate) is +Y direction from the substrate carry-in side to the substrate carry-out side. The direction in which the substrate is transported is a direction perpendicular to a scribing device guide body 30 in a horizontal state. The scribing device body guide 30 is provided along the X direction.

The substrate cutting system 1 includes a mounting base 10 in a hollow rectangular parallelepiped. Four pillars 14 are provided on the upper surface of the mounting base 10. A main frame 11 having a frame shape is provided at the top portion of the pillars 14. A substrate supporting device 20 is arranged on the upper surface of the mounting base 10. The substrate supporting device 20 supports the bonded mother substrate 90 in a horizontal state, the bonded mother substrate 90 being transported to the substrate cutting system 1 by a transportation robot.

As shown in FIG. 1, the substrate supporting device 20 includes a first substrate supporting section 20A and a second substrate supporting section 20B. The first substrate supporting section 20A is arranged on the substrate carry-in side of the substrate cutting system 1 in order to support the bonded mother substrate 90 which is carried onto the main frame 11. The second substrate supporting section 20B is arranged on the substrate carry-out side in order to support the bonded mother substrate 90 after the bonded mother substrate 90 is cut and display panels are sequentially carried out from the substrate cutting system. The first substrate supporting section 20A side in the mounting base 10 is referred to as a substrate carry-in side. The second substrate supporting section 20B side in the mounting base 10 is referred to as a substrate carry-out side.

As shown in FIG. 2, above the mounting base 10, clamp devices 50 are provided in order to hold the substrate. The substrate is supported in a horizontal state by the substrate supporting device 20 (first substrate supporting unit 21A). Furthermore, as shown in FIG. 1, a scribing device guide body 30 is provided on the top surface of the mounting base 10. The scribing device guide body 30 is slidable along frames 11A and 11B in a longitudinal direction of the main frame 11. The scribing device guide body 30 includes an upper side guide rail 31 above the main frame 11 and a lower side guide rail 32 below the main frame 11. The upper side guide rail 31 is constructed along the X direction which is perpendicular to the frames 11A and 11B in the longitudinal direction of the main frame 11. The lower guide rail 32 is constructed along the upper guide rail 31. The upper guide rail 31 and the lower guide rail 32 integrally move along the frames 11A and 11B in the longitudinal direction (Y direction) of the main frame 11.

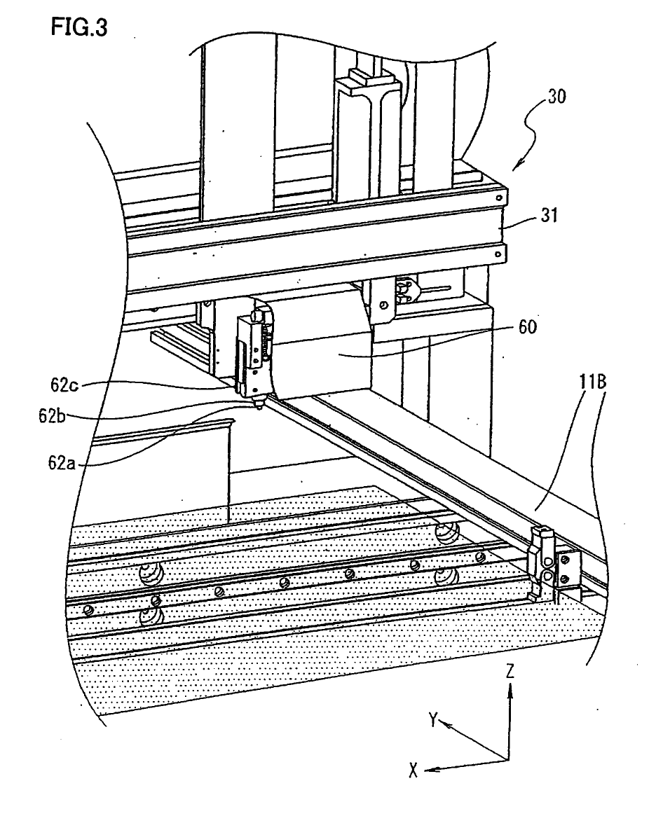

FIG. 3 is a view schematically showing the vicinity of the upper guide rail 31 of the scribing device guide body 30. An upper substrate cutting device 60 is attached to the upper scribing guide rail 31 so as to be movable along the upper guide rail 31.

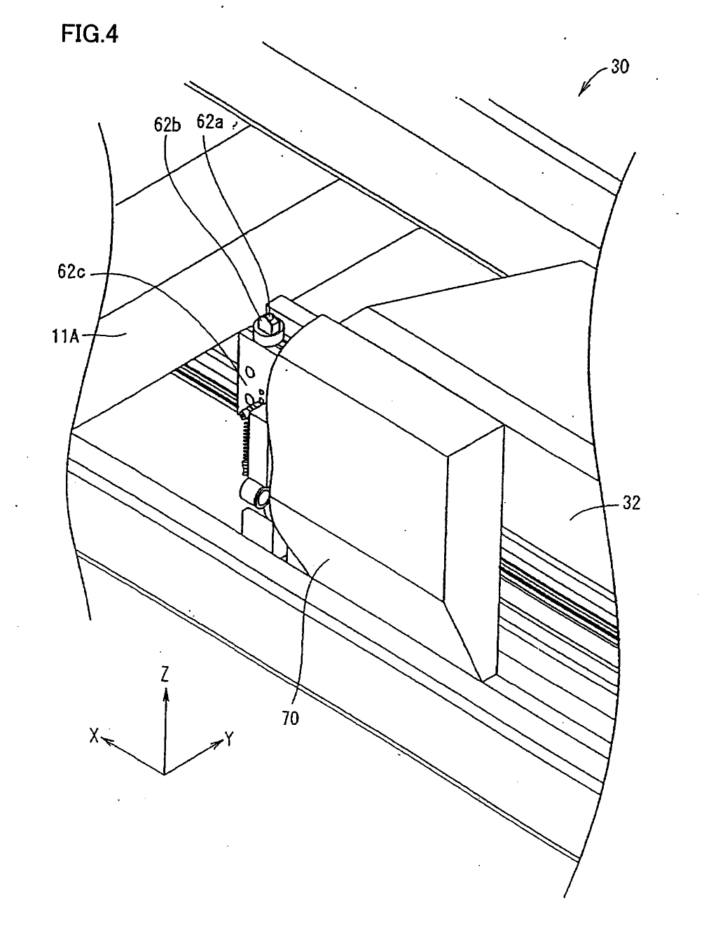

FIG. 4 is a view schematically showing the vicinity of the lower guide rail 32 of the scribing device guide body 30. A lower substrate cutting device 70 is attached to the lower scribing guide rail 32 so as to be movable along the lower scribing guide rail 32.

The upper substrate cutting device 60 and the lower substrate cutting device 70 reciprocate along the upper guide rail 31 and the lower guide rail 32, respectively, due to linear motors. Stators for the linear motors are attached to the upper guide rail 31 and the lower guide rail 32. Movers for the linear motors are attached to the upper substrate cutting device 60 and the lower substrate cutting device 70. The upper substrate cutting device 60 and the lower substrate cutting device 70 cut each glass substrate on the upper and lower sides of the bonded mother substrate 90 into a plurality of display panels, the mother substrate 90 being held in a horizontal state by the clamp devices 50 and supported by the substrate supporting device 20 to provide assistance in holding the mother substrate 90.

A first optical device 38 is provided at one end of the scribing device guide body 30 so as to be movable along the scribing device guide body 30. The first optical device 38 captures a first alignment mark provided on the bonded mother substrate 90 which is held by the clamp devices 50 and supported by the substrate supporting device 20. A second optical device 39 is provided at the other end of the scribing device guide body 30 so as to be movable along the scribing device guide body 30. The second optical device 39 captures a second alignment mark provided on the bonded mother substrate 90.

Stators 12 for the linear motors are provided on the upper surface of the mounting base 10 along the frames 11A and 11B in the longitudinal direction of the main frame 11. The linear motors having the stators 12 move the scribing device guide body 30. Each stator 12 is formed in a shape of a flat and hollow rectangular parallelepiped, the outside surface thereof being open. The cross section thereof is formed in a shape of “ [symbol] ”. Movers (not shown) for the linear motors is inserted in each of the stators, respectively. The motors are movable along the frames 11A and 11B in the longitudinal direction of the main frame 11 with respect to guide bases 15. The guide bases 15 hold the pillars 28 which support both ends of the scribing device guide body 30.

A plurality of permanent magnets is arranged on each stator 12 along the longitudinal direction of the main frame 11. Magnetic poles of adjacent permanent magnets are in a state opposed to each other. Each mover is constructed with an electromagnet, respectively. When the magnetic pole of the electromagnet which constitutes each mover is sequentially changed, each mover slides along each stator 12.

As shown in FIG. 3, the upper substrate cutting device 60 is attached to the upper guide rail 31 of the scribing device guide body 30. As shown in FIG. 4, the lower substrate cutting device 70 is attached to the lower guide rail 32. The lower substrate cutting device 70 has a similar structure to the upper substrate cutting device 60 but is in an inverted state.

As described above, the upper substrate cutting device 60 and the lower substrate cutting device 70 slide along the upper guide rail 31 and the lower guide rail 32, respectively, due to the linear motors.

For example, in the upper substrate cutting device 60 and the lower substrate cutting device 70, cutter wheels 62a (a scribing ling forming section) are rotatably attached to tip holders 62b, respectively. The cutter wheels 62a scribe an upper glass substrate of the bonded mother substrate 90. Furthermore, the tip holders 62b are rotatably attached to cutter heads 62c. The tip holders 62b are rotatable about an axis in the vertical direction with respect to the surface of the bonded mother substrate 90 which is held by the clamp devices 50. The cutter heads 62c are movable, along the vertical direction, with respect to the surface of the bonded mother substrate 90. The cutter heads 62c are movable by a driving means (not shown). A load is applied to the cutter wheels 62a by an energizing means (not shown) when appropriate.

The upper substrate cutting device 60 supports the cutter wheel 62a such that the cutter wheel 62a moves on the upper glass substrate in the X direction.

The lower substrate cutting device 70 provided on the lower guide rail 32 has a similar structure to the upper substrate cutting device 60 but is in an inverted state. The cutter wheel 62a (see FIG. 4) of the lower substrate cutting device 70 is provided so as to face the cutter wheel 62a of the upper substrate cutting device 60.

The cutter wheel 62a of the upper substrate cutting device 60 is pressed so as to make contact onto the top surface of the bonded mother substrate 90 by the aforementioned energizing means and a moving means for moving the cutter head 62c. The cutter wheel 62a of the lower substrate cutting device 70 is pressed so as to make contact onto the bottom surface of the bonded mother substrate by the aforementioned energizing means and a moving means for moving the cutter head 62c. The bonded mother substrate 90 is cut by simultaneously moving the upper substrate cutting device 60 and the lower substrate cutting device 70 in the same direction.

The substrate supporting device 20 supports the bonded mother substrate 90 such that the cutter wheel 62a scribes the upper glass substrate.

As described above, according to the substrate cutting system 1, the substrate supporting device 20 supports the bonded mother substrate 90 such that a space is movable on an X-Y plane surface, the space between which each cutter wheel 62a from the upper glass substrate side and the lower glass substrate side faces each other. Therefore, each cutter wheel 62a respectively can scribe the bonded mother substrate 90 in accordance with undulations and bendings of the bonded mother substrate 90 such that each of the cutter wheels 62a balances the load applied to each of the cutter wheels 62a facing each other, respectively. As a result, the scribing lines formed on the bonded mother substrate 90 have an excellent quality. When the bonded mother substrate 90 is cut along the scribing lines, the cut face of the bonded mother substrate 90 has an extremely excellent quality (above, function of claim 1).

Furthermore, according to the substrate cutting system 1, a space is provided between the scribing device guide body 30 and the substrate supporting device 20. The space can be moved in the Y direction and the bonded mother substrate 90 can be fixed by the clamp device 50, thereby preventing the bonded mother substrate 90 being shifted from a predetermined position when the space is moved or both main surfaces are scribed (above, function of claim 2).

Furthermore, according to the substrate cutting system 1, a space is provided between the scribing device guide body 30 and the first substrate supporting section 20A. The space is moved in the Y direction. When the space is moved or both main surfaces are scribed, the first substrate supporting section 20A does not rub the bonded mother substrate 90 or exert any force on the substrate. Therefore, when a vertical crack is created within the bonded mother substrate 90 by the cutter wheel 62a, there is no possibility that an undesired crack will result from the cutter wheel 62a (above, function of claim 4).

Furthermore, according to the substrate cutting system 1, when the second substrate supporting section 20B moves together with the movement of the space, the second substrate supporting section 20B provides assistance to support the portion of the substrate which is not supported by the first substrate supporting section 20A. When the space is moved or both main surfaces are scribed, the second substrate supporting section 20B does not rub the bonded mother substrate 90 or exert any force on the substrate. Therefore, when a vertical crack is created within the bonded mother substrate 90 by the cutter wheel 62a, there is no possibility that an undesired crack will result from the cutter wheel 62a (above, function of claim 13).

As shown in FIGS. 1 and 2, both ends of the scribing device guide body 30, in which each end face of the upper guide rail 31 and the lower guide rail 32 are connected to each other by connection plates 33, are supported by the pillars 28. The pillars 28 are held on the upper surface of the guide bases 15. Movers for linear motors are attached to the guide bases 15, respectively. Each mover is driven in synchronization with each other and is slid along the stator 12.

As shown in FIG. 1, a steam unit section 160 is arranged on the substrate carry-out side of the second substrate supporting section 20B and the substrate carry-in side of the substrate carry-out device 80 above the substrate carry-out side of the mounting base 10. The steam unit section 160 is provided such that the bonded mother substrate 90, which is not completely cut after the scribing, is completely cut.

Above the substrate carry-out side of the mounting base 10, the substrate carry-out device 80 is arranged on the substrate carry-out side with respect to the scribing device guide body 30. The substrate carry-out device 80 includes a carry-out robot 140 and a substrate carry-out device guide 81. The carry-out robot 140 carries out each display panel that has been cut from the bonded mother substrate 90. The substrate carry-out device guide 81 is constructed in order to move the carry-out robot 140 in the X direction which is perpendicular to the frames 11A and 11B in the longitudinal direction of the main frame 11. Ends of the substrate carry-out device guide 81 slide, by linear motors, along the guide rails 13 through supporting members 82. The guide rails 13 are provided on the upper surface of the mounting base 10. In this case of the linear motors, movers (not shown) for the linear motors are respectively inserted in the stators 12 of the linear motors provided on the upper surface of the mounting base 10. The movers for the linear motors are attached to the ends of the substrate carry-out device 80.

An adsorption section (not shown) is provided on the carry-out robot 140 of the substrate carry-out device 80. The adsorption section adsorbs each display panel cut from the bonded mother substrate 90 by suction. While the display panel is in a state of being adsorbed by the adsorption section, when the entire substrate carry-out device 80 is slid to the substrate carry-out side, each cut display panel is carried out from the substrate supporting device 20.

As described above, according to the substrate cutting system 1, a cut unit substrate is retrieved by using the substrate carry-out device 80. Thus, it is easy to pass the substrate with the device for the next step (above, function of claim 31).

According to the substrate cutting system 1, the substrate supporting device 20 is moved together with the upper substrate cutting device 60 and the lower substrate cutting device 70. Thus, a scribing line is formed at a desired location and a brittle material substrate can be cut while the brittle material substrate is partially supported without bending the brittle material substrate (above, function of claim 58).

According to the substrate cutting system 1, when the substrate supporting device 20 is moved, an external force which exerts on the brittle material substrate is suppressed. Thus, it is possible to suppress the creation of an undesired crack (horizontal crack) when a scribing line is formed (above, function of claim 59).

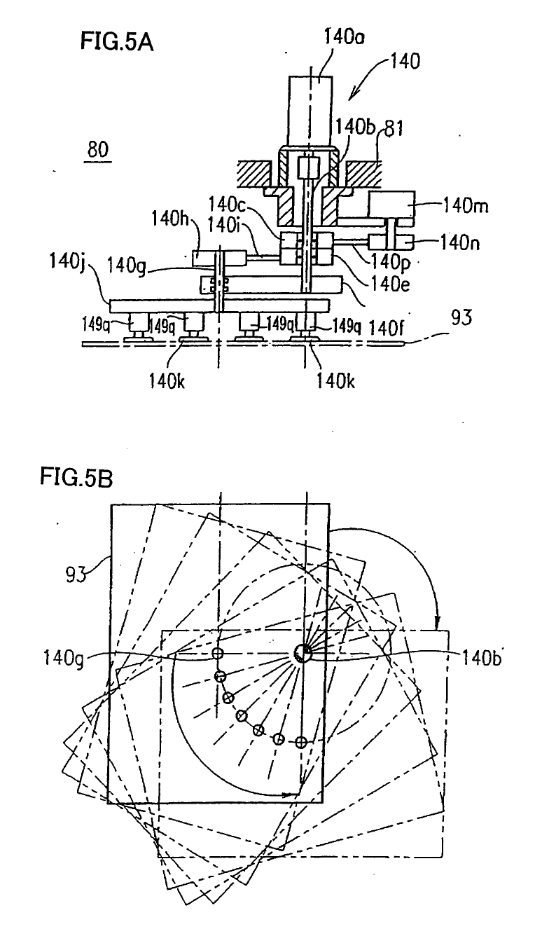

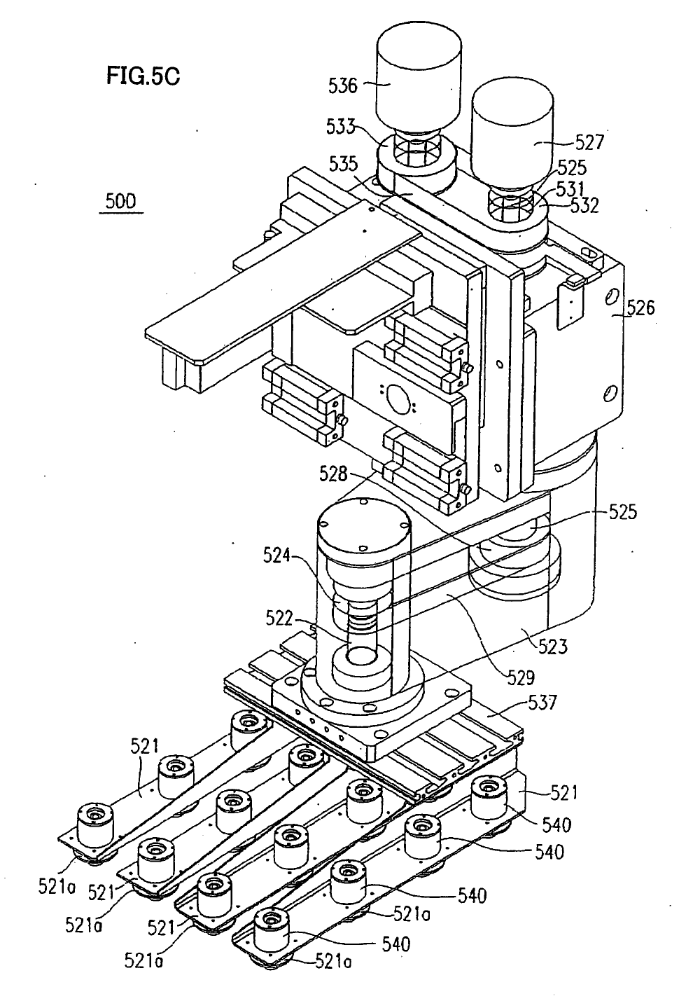

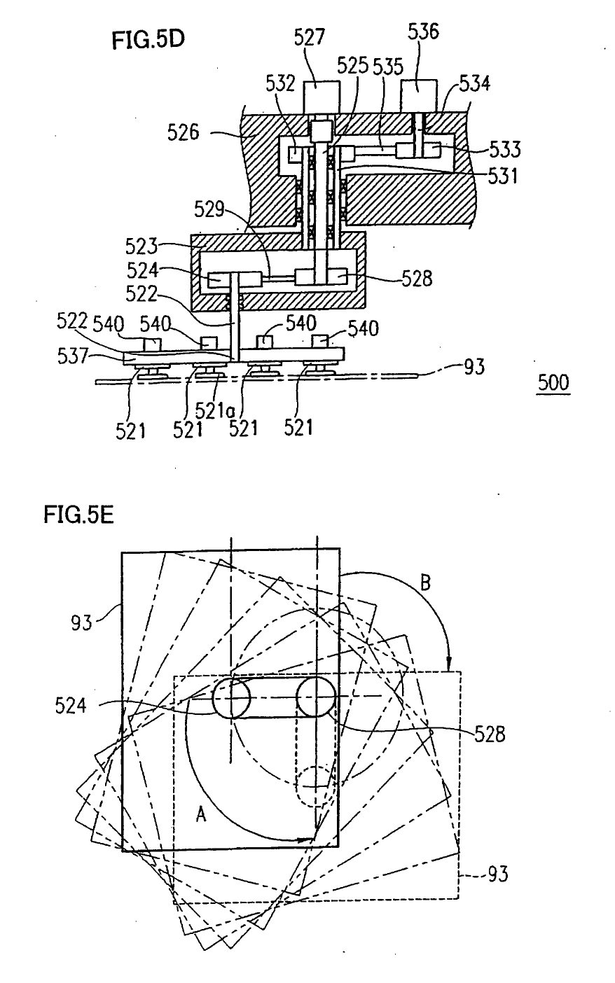

FIG. 5 is a diagram for explaining the function of the carry-out robot.

FIG. 5A is a diagram schematically showing the structure of the carry-out robot 140 of the substrate carry-out device 80. The carry-out robot 140 is attached to the substrate carry-out device guide 81. The carry-out robot 140 is movable by a moving mechanism in a direction (X direction) along the substrate carry-out device guide 81. The moving mechanism combines a driving means due to a linear motor or a servo motor and a straight-line guide.

The carry-out robot 14 includes two servo motors 140a and 140m. The servo motor 140a is connected to a driving shaft 140b. A first pulley 140c and a second pulley 140e are integrally attached to each other and are attached to the driving shaft 140b via a bearing. When the driving shaft 140b is rotated, the first pulley 140c and the second pulley 140e detach from the driving shaft 140b. An end of an arm 140f is integrally attached to the driving shaft 140b. The arm 140f rotates with the driving shaft 140b as its center due to the rotation of the driving shaft 140b. A rotating shaft 140g is supported on the tip of the arm 140f so as to be rotatable. The rotating shaft 140g penetrates the arm 140f. A third pulley 140h is integrally attached to one end of the rotating shaft 140g. For example, a belt (e.g., a timing belt 141i) is wound around the second pulley 140e and the third pulley 140h.

Furthermore, a fourth pulley 140n is attached to the rotating axis of the servo motor 140m. For example, a belt (e.g., a timing belt 141p) is wound around the fourth pulley 140n and the first pulley 140c. Therefore, the rotation of the servo motor 140m is transmitted to the first pulley 140c through the belt 140p and is further transmitted to the third pulley 140h through the belt 140i. As a result, the rotating shaft 140g rotates.

The center of a vacuum adsorption head attachment plate 140j is integrally attached to the other end of the rotating shaft 140g. Vacuum adsorption heads 140q are provided on the vacuum adsorption head attachment plate 140j. The vacuum adsorption head 140q includes adsorption pad 140k. The adsorption pad 140k adsorbs a substrate, by using an adsorption mechanism (not shown), cut by the substrate cutting system 1. The vacuum adsorption head 140q will be described later in detail.

When the carry-out robot 140 having such a structure is set using the combination of the rotating direction and the rotating angle of each servo motor 140a and 140m, the cut substrate 93 can be carried out to an device for the next step while minimizing the distance moved by the arm 140f and maintaining the direction of the cut substrate being at a horizontal state or being changed to a variety of angle directions.

In the transportation of the cut substrate, the cut substrate 93 is held by the adsorption of the adsorption pad. After the entire carry-out robot 140 is moved upward by an up-and-down moving mechanism (not shown) once, the cut substrate 93 is transported to the device for the next step. Thereafter, the carry-out robot 140 is moved downward by the up-and-down moving mechanism (not shown) again and then, the cut substrate 93 is mounted at a predetermined position at a predetermined state in the next step.

Next, the case in which the direction of the cut substrate is, for example, changed by 90 degrees by using the carry-out robot 140 having such a structure will be described with reference to FIG. 5B. When each adsorption pad 140k of each vacuum adsorption head 149q, attached to the vacuum adsorption head attachment plate 140j adsorbs the cut substrate 93, the entire carry-out robot 140 moves upward by the up-and-down moving mechanism. As a result, the servo motor 140a is driven and the driving shaft 140b is rotated by 90 degrees, the rotation direction of the driving shaft 140b being anti-clockwise when viewed from the substrate side. When the driving shaft 140b is rotated by 90 degrees, the arm 140f is rotated by 90 degrees with the driving shaft 140b as its center of rotation, the rotation direction of the arm shaft 140f being anti-clockwise when viewed from the substrate side. As a result, the vacuum adsorption head attachment plate 140j is rotated, along with the arm 140f, by 90 degrees with the driving shaft 140b as its center of rotation. The vacuum adsorption head attachment plate 140j being rotatably supported by the tip of the arm 140f through the rotating shaft 140g and the rotation direction of the vacuum adsorption head attachment plate 140j being anti-clockwise when viewed from the substrate side. In this case, the rotating shaft 140g attached to the vacuum adsorption head attachment plate 140j is rotated with the driving shaft 140g as its center of rotation.

Concurrently, the rotation of the servo motor 140m is transmitted to the first pulley 140o through the belt 140p and is further transmitted to the third pulley 140h through the belt 140i. As a result, the rotating shaft 140g is rotated by 180 degrees clockwise. The vacuum adsorption head attachment plate 140j, attached to the driving shaft 140g, rotates by 180 degrees clockwise with the driving shaft 140g as its center of rotation. Therefore, while the vacuum adsorption head attachment plate 140j rotates by 90 degrees with the driving shaft 140d as its center of rotation, the rotation direction of the vacuum adsorption head attachment plate 140j is anti-clockwise when viewed from the substrate side, and the vacuum adsorption head attachment plate 140j rotates by itself by 180 degrees clockwise, when viewed from the substrate side, with the driving shaft 140g as its center. As a result, as shown in FIG. 5B, the cut substrate 93 adsorbed by each adsorption pad 140k is rotated, within a relatively small space, by 90 degrees clockwise when viewed from the substrate side while rotating around the center of the rotation.

FIG. 5C is a perspective view showing a carry-out robot 500 as another example of the carry-out robot according to the present invention. FIG. 5D is a diagram schematically showing the structure of the carry-out robot 500 according to the present invention. FIG. 5E is an explanatory diagram for explaining the operation of the carry-out robot 500 according to the present invention. The carry-out robot 500 is attached to a supporting beam (not shown) of the carry-out robot 500 through a connection block 526. The supporting beam of the carry-out robot 500 is used for transporting the cut substrate 93 to a predetermined position (see FIG. 5E). In the connection block 526, a connection shaft 531 arranged in a vertical state is rotatably penetrated via a bearing. A driving shaft 525 is rotatably inserted into the connection shaft 531 via a bearing. The connection shaft 531 and the driving shaft 525 independently rotate from each other.

The upper end of the connection shaft 531 and the upper end of the driving shaft 525 protrude above the connection block 526. A driving axis of a servo motor 527 for rotating is connected to the upper end of the driving shaft 525 which is inserted into the connection shaft 531.

A coupled driving pulley 532 for circling is attached to the upper end of the connection shaft 531 which protrudes upward from the connection block 526. A main pulley 533 for circling adjacent to the coupled driving pulley 532 for circling is provided above the connection block 526. The main pulley 533 for circling is attached to a rotation axis 534 which is in a vertical state and rotatably arranged. A transmission belt 535 for circling is wound around the main pulley 533 for circling and the coupled driving pulley 532 for circling. The main pulley 533 for circling, the coupled driving pulley 532 for circling and the transmission belt 535 for circling constitute a belt transmission mechanism. The rotation axis 534 attached to the main pulley 533 for circling is rotated by a servo motor 536 for circling.

The base end of a hollow circling arm 523 is attached to the lower end of the connection shaft 531 which penetrates the connection block 526 so as to integrally rotate with the connection shaft 531. The circling arm 523 is provided in a horizontal state. The rotation of the servo motor 536 for circling is transmitted to the connection shaft 531 through the main pulley 533 for circling, the transmission belt 535 for circling and the coupled driving pulley 532 for circling. When the connection shaft 531 is rotated, the tip of the circling arm 523 integrally rotates with the connection shaft 531 around the axis of the connection shaft 531.

The lower end of the driving shaft 525 penetrating through the connection shaft 531 is located inside the hollow circling arm 523. A main pulley 528 for rotating is attached to the lower end portion of the driving shaft 525 so as to integrally rotate with the driving shaft 525.

A rotation axis 522 in a vertical state is provided within a tip of the circling arm 523 so as to be rotatable via a bearing. A coupled driving pulley 524 for circling located in the circling arm 523 is attached to the rotation axis 522 so as to integrally rotate with the rotation axis 522. A transmission belt 529 for rotating is wound around the coupled driving pulley 524 for rotating and the main pulley 528 for rotating. The coupled driving pulley 524 for rotating, the main pulley 528 for rotating and the transmission belt 529 for rotating constitute a belt transmission mechanism. When the driving shaft 525 is rotated by the servo motor 527 for rotating, the rotation of the driving shaft 525 is transmitted to the rotation axis 522 through the main pulley 528 for rotating, the transmission belt 529 for rotating and the coupled driving pulley 524 for rotating.

The rotation axis 522 to which the rotation of the driving shaft 525 is transmitted is attached to a connection body 537 provided below the circling arm 523. One of the ends of the four vacuum adsorption head supporting bodies 521 are attached to the connection body 537, the four vacuum adsorption head supporting bodies 521 being in a horizontal state and parallel to each other. Four vacuum adsorption heads 540 are provided on each vacuum adsorption head supporting body 521. Adsorption pads 521a for adsorbing the substrate 93 are attached to vacuum adsorption heads 540. The plurality of vacuum adsorption heads 540 functions as a substrate holding means in the present embodiment. Thus, according to substrate cutting system 1, the cut substrate is firmly received and passed on by the plurality of vacuum adsorption heads 540 (above, function of claim 41).

The vacuum adsorption head 540 will be described later in detail

According to the present embodiment, each vacuum adsorption head supporting body 521, each adsorption pad 521a and the connection body 537 constitute the substrate holding means. The rotation axis 522 attached to the connection body 537, the coupled driving pulley 524 for rotating attached to the rotation axis 522, the driving shaft 525, the main pulley 528 for rotating attached to the driving shaft 525, the transmission belt 529 for rotating wound around the coupled driving pulley 524 for rotating and the main pulley 528 for rotating, and the servo motor 527 for rotating constitute a substrate rotating means.

Furthermore, the circling arm 523 to which the rotation axis 522 is attached, the connection shaft 531 attached to the circling arm 523, the coupled driving pulley 532 for circling attached to the connection shaft 531, the servo motor 536 for circling, the main pulley 533 for circling attached to the servo motor 536 for circling and the transmission belt 535 for circling wound around the main pulley 533 for circling and the coupled driving pulley 532 for circling constitute a substrate circling means.

As described above, the substrate carry-out device 80 includes at least one carry-out robot 500 which includes the substrate rotation means and the substrate circling means. The substrate rotation means rotates the substrate holding means around the first axis and the substrate circling means causes the substrate holding means to circle around the second axis. Thus, the substrate carry-out device 80 can transport the cut unit substrate to the next step with a desired attitude on a transportation plane and can simultaneously transport the cut substrate to a plurality of devices for the next step (above, function of claim 32).

The carry-out robot 500 having such a structure can rotate the substrate 93 by 90 degrees when each adsorption pad 521a adsorbs the substrate 93.

In this case, when the servo motor 536 for circling is driven, the rotation of the servo motor 536 for circling is transmitted to the connection shaft 531 through the main pulley 533 for circling, the transmission belt 535 for circling and the coupled driving pulley 532 for circling. As a result, the connection shaft 531 is rotated. Thus, the circling arm 523 integrally attached to the lower end of the connection shaft 531 is, for example, rotated by 90 degrees, with the connection shaft 531 as its center, in the direction indicated by the arrow A in FIG. 5E. When the tip of the circling arm 523 is rotated, the rotation axis 522 attached to the tip of the circling arm 523 rotates in a circle with the connection shaft 531 as its center.

As described above, according to the substrate cutting system 1, the circling of the substrate holding means by the substrate circling means is transmitted to the substrate rotation means by a dynamic power transmission mechanism and, in connection therewith, rotates the substrate rotation means. Therefore, when the rotation operation of substrate rotation means and the circling operation of the substrate circling means are combined, the carry-out robot 500 can transport the cut unit substrate to the next step with a desired attitude on a transportation plane (above, function of claim 33).

Furthermore, the rotation of the substrate holding means by the substrate rotation means and the circling of the substrate holding means by the substrate circling means are independent from each other. Thus, the attitude of a unit substrate on a transportation plane is readily set (above, function of claim 36).

Concurrently, when the servo motor 527 for rotating is rotated, the driving shaft 525 is rotated. Therefore, the rotation of the driving shaft 525 is transmitted to the rotation axis 522 through the rotation main pulley 528, the transmission belt 529 for rotating and the coupled driving pulley 524 for rotating. As a result, the connection body 537 to which each vacuum adsorption head supporting body 521 is attached is rotated with the rotation axis 522 as its center, each vacuum adsorption head supporting body 521 being located at the lower end of the rotation axis 522.

In this case, the rotation direction of the driving shaft 525 rotated by the servo motor 527 for rotating and the rotation direction of the connection shaft 531 rotated by the circling servo motor 534 are opposite to each other. The rotation angle of the rotation axis 522 rotated by the driving shaft 525 is twice the rotation angle of the connection shaft 531 (i.e., the rotation angle of the circling arm 523). Therefore, due to the rotation of the rotation axis 522, the connection body 537 attached to the lower end of the rotation axis 522 rotates around the axis of the rotation axis 522, and at the same time, is caused to rotate in a circle around the axis of the connection shaft 531. The connection body 537 supports each vacuum adsorption head supporting body 521.

As described above, the rotation direction of the substrate holding means by the substrate rotation means and the circling direction of the substrate holding means by the substrate circling means are opposite to each other. Therefore, the unit substrate can be set at a desired attitude on a transportation plane such that the moving range of a robot arm is minimized (above, function of claim 34).

Furthermore, the rotation angle of the substrate holding means by the substrate rotation means is twice the circling angle of the substrate holding means by the substrate circling means. Therefore, the movement of the robot arm can be minimized (above, function of claim 35).

Additionally, the servo motor 527 for rotating and servo motor 534 for circling are independent from each other. Therefore, the unit substrate can be easily set at a desired attitude on a transportation plane (above, function of claim 37).

For example, as shown in FIG. 5E, in the case where the connection shaft 531 is rotated by 90 degrees in the direction indicated by the arrow A, when the circling arm 523 is circled by 90 degrees in the direction indicated by the arrow direction A, the rotation axis 522 is rotated by 180 degrees in a direction which is opposite to the direction indicated by the arrow A. Therefore, in a similar manner, while the vacuum adsorption head supporting body 521, attached to the lower end of the rotation axis 522, circles by 90 degrees with the connection shaft 531 as its center, the vacuum adsorption head supporting body 521 is rotated by 180 degrees with the rotation axis 522 as its center in a direction indicated by the arrow B which is opposite to the direction indicated by the arrow A.

Thus, the substrate 93 adsorbed by each adsorption pad 521a of each vacuum adsorption head 540 of each vacuum adsorption head supporting body 521 is rotated by 90 degrees in a direction indicated by the arrow B as shown in FIG. 5E while the position of the rotation axis 522 is being shifted. Therefore, the carry-out robot 500 according to the present embodiment includes all of the heavy-weighted driving motors in the base portion of the carry-out robots 500. Thus, the structure of the arm section can be simplified and light-weighted. As a result, the circling arm can be moved at a rapid speed with little inertia, and the substrate 93 can be rotated by 90 degrees in a relatively small space while being held in a horizontal state.

The carry-out robot has been described above in detail with reference to FIG. 5. The vacuum adsorption head 140q and the vacuum adsorption head 540 will be described later in detail.

Referring back to FIG. 1, the structure of the substrate cutting system 1 will be described.

The first substrate supporting section 20A and the second substrate supporting section 20B of the substrate supporting device 20 include, for example, five first substrate supporting units 21A and five second substrate supporting units 21B, respectively, as shown in FIG. 1. The first substrate supporting units 21A and second substrate supporting units 21B are movable in the same direction as the moving direction of the scribing device guide body 30. Each first substrate supporting unit 21A and each second substrate supporting unit 21B are arranged in line to each other along a direction (Y direction) parallel to the frames 11A and 11B in the longitudinal direction of the main frame 11, respectively. Each first substrate supporting unit 21A and each second substrate supporting unit 21B are arranged on the substrate carry-in side and the substrate carry-out side of the scribing device guide body 30, respectively.

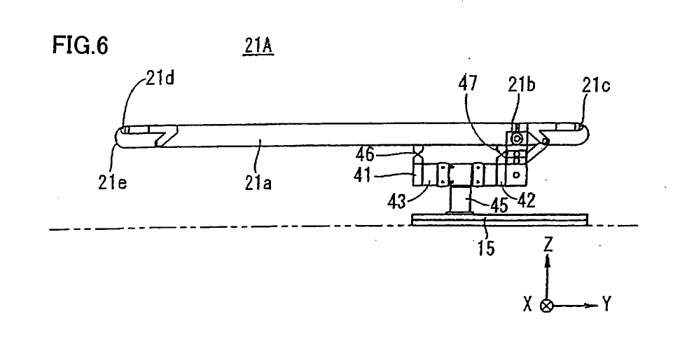

FIG. 6 is a diagram showing a side face of one of the first substrate supporting units 21A provided on the first substrate supporting section 20A. In the first substrate supporting unit 21A, a pillar 45 is provided on the upper surface of the guide base 15 held by each moving unit of the pair of guide rails 13 which are provided on the upper surface of the mounting base 10. A supporting member 43 is provided above the pillar 45 in parallel to the Y direction along the frames 11A and 11B of the main frame 11. Each supporting member 43 is attached to joining members 46 and 47 of two unit attachment members 41 and 42, which are constructed in the X direction perpendicular to the frames 11A and 11B of the main frame 11.

A plurality of first substrate supporting units 21A (five in the explanation of the present embodiment) is arranged with a predetermined interval therebetween, respectively. The first substrate supporting units 21A move together with the scribing device guide body 30 in the Y direction along the frames 11A and 11B of the main frame 11.

The first substrate supporting unit 21A includes a supporting body section 21a, which linearly extends along a direction (Y direction) parallel to the main frame 11. Timing pulleys 21c and 21d which, for example, guide a timing belt 21e, are attached to each end of the supporting body section 21a, respectively. The timing belt 21e is caused to circle when the timing pulley 21b for driving is rotated by a clutch (which will be described later) in connection with a driving axis.

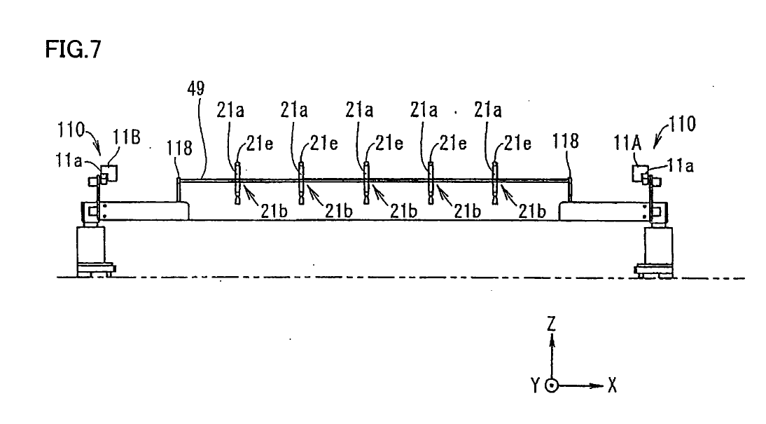

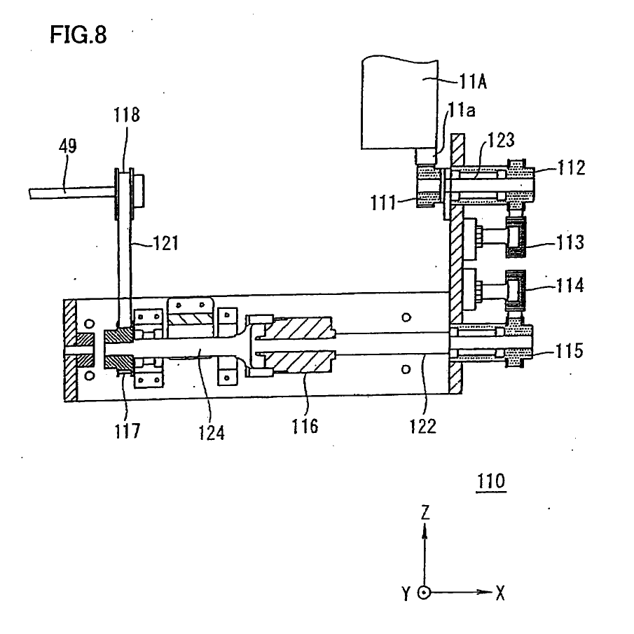

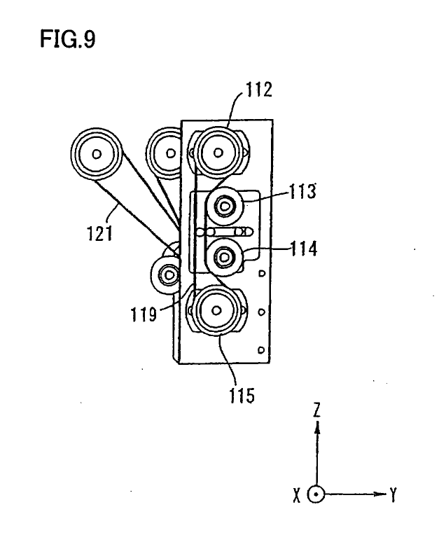

The mechanism having such a structure which moves the timing belt 21e of the first substrate unit 21A will be described with reference to FIGS. 7, 8 and 9. FIG. 7 is a front view when a plurality (five) of first substrate supporting units 21A provided on the first substrate supporting section 20A when viewed from the scribing device guide body 30. FIG. 8 is a diagram schematically showing the structure a clutch unit 110. FIG. 9 is a side view of the clutch unit 110.

As shown in FIG. 7, each timing pulley 21b for driving provided on the supporting body section 21a of the first substrate unit 21A is coupled to a rotating driving shaft 49 which is provided in parallel to the X direction perpendicular to the frames 11A and 11B in the longitudinal direction of the main frame 11. Both ends of the rotating driving shaft 49 are connected to clutch units 110, and whether the rotating driving shaft 49 rotates depends on its connection state with the driving axis of the clutch within the clutch unit 110. In other words, when the clutch within the clutch unit is connected to the driving axis 122, the rotating driving shaft 49 rotates. When the clutch within the clutch unit is detached from the driving axis 122, the rotating driving axis 49 does not rotate.

Racks 11a are attached to the lower surface of the frames 11A and 11B in the longitudinal direction of the main frame 11. The racks 11a rotate pinions 111 of the clutch units 110.

The pinion 111 of the clutch unit 110 is coupled to one end of an axis 123. A timing pulley 112 for a timing belt 119 is coupled to the other end of the axis 123.

A timing pulley 115 is coupled to one end of the driving axis 122. A timing belt 119 is wound around the timing pulley 112 and the timing pulley 115 through two idlers 113 and 114. Thus, the rotation of the axis 123 is transmitted to the driving axis 122.

A clutch 116 (e.g., an air clutch) is attached to the other end of the driving axis 122. When compressed air is injected into the clutch 116, the driving axis 122 and a coupled driving axis 124 connect. When the injection of the compressed air is interrupted and the air pressure within the clutch 116 becomes atmospheric pressure, the coupling between the driving axis 122 and the coupled driving axis 124 detaches.

A timing pulley 117 is coupled to the end which is not joined to the clutch 116 of the coupled driving axis 124. A timing belt 121 is wound around the timing pulley 117 and a timing pulley 118. The timing pulley 118 which is located at one end of the rotating driving shaft 49 to which each timing pulley 21b provided on the supporting body sections 21a of the first substrate unit 21A is coupled.

As shown in FIG. 7, the mechanism (clutch 110) which moves the timing belts 21e by rotating the timing pulleys 21b for driving of the five first substrate supporting units 21A provided on the first substrate supporting section 20A is also provided on the frame 11B side in the longitudinal direction of the main frame 11.

As described above, the pillar 45 on the frame 11A side and the pillar 45 on the frame 11B side which support the five first substrate supporting units 21A are held by the guide bases 15. The pillar 45 on the frame 11A side and the pillar 45 on the frame 11B side integrally move the guide bases 15 which hold the pillars 28. The pillars 28 support both ends of the scribing device guide body 30. Movers (not shown) for the linear motor are connected to the guide bases 15 which support the pillars 28. Thus, with the drive of the linear motor, the scribing device guide body 30 moves to the substrate carry-in side, and at the same time, the five first substrate supporting units 21A of the first substrate supporting section 20A move to the substrate carry-in side.

When the scribing device guide body 30 moves, the pinion 111 of the clutch unit 110 on the frame 11A side and the pinion 111 of the clutch unit 110 on the frame 11B side which are engaged with the racks 11a attached along the frames 11A and 11B respectively are rotated.

When the timing belts 21e are moved by rotating the timing pulleys 21b for driving of the first substrate supporting unit 21A, both clutches of the frame 11A and the frame 11B can be connected to the respective driving axes 122. Alternatively, either clutch of the frame 11A and the frame 11B can be connected to the driving axis 122.

The second substrate supporting section 20B of the substrate supporting device 20 includes, for example, five second substrate supporting units 21B. The second substrate supporting units 21B are movable in the same direction as the moving direction of the scribing device guide body 30. The second substrate supporting unit 21B has a similar structure to the first substrate supporting unit 20A. The second substrate supporting unit 21B is supported by the pillars 45 on the frame 11A side and the frame 11B side so as to be attached opposite to the Y direction with respect to the scribing device guide body 30. Each pillar is supported by the guide base 15.

The pillars 45 on the frame 11A side and the pillars 45 on the frame 11B side which support the five first substrate supporting units 21A are held by the guide bases 15. The pillars 45 on the frame 11A side and the pillars 45 on the frame 11B side which support the five second substrate supporting units 21B are held by the guide bases 15. Furthermore, the pillars 45 are connected so as to integrally move with the guide bases 15 which hold the pillars 28, the pillars supporting both ends of the scribing device guide body 30. Movers (not shown) for the linear motors are attached to the guide bases 15 holding the pillars 28 which support both ends of the scribing device guide body 30. Thus, with the drive of the linear motor, the scribing device guide body 30 moves to the substrate carry-in side, and at the same time, the five first substrate supporting units 21A of the first substrate supporting section 20A and the five second substrate supporting units 21B of the second substrate supporting section 20B move to the substrate carry-in side.

Clutch units 110 similar to those provided in the first substrate supporting section 20A are provided on the frame 11A side and on the frame 11B side of the second substrate supporting unit 20B. When the scribing device guide body 30 moves, the pinion 111 of the clutch unit 110 on the frame 11A side and the pinion 111 of the clutch unit 110 on the frame 11B side which are engaged with the racks 11a attached along the frames 11A and 11B respectively are rotated.

When the timing belts 21e are moved by rotating the timing pulleys 21b for driving of the second substrate supporting unit 21B, both clutches of the frame 11A and the frame 11B can be connected to the respective driving axes 122. Alternatively, either clutch of the frame 11A and the frame 11B can be connected to the driving axis 122.

As described above, the first substrate supporting section 20A includes the plurality of first substrate supporting units 21A which move in parallel along the moving direction of the scribing device guide body 30. The plurality of first substrate supporting units 21A move together with the scribing device guide body 30 along with the movement of the scribing device guide body 30. Thus, with a structure such that a space is provided between the scribing device guide body 30 and the first substrate supporting unit 21A, the space is moved in the Y direction, and the substrate 90 is fixed by the clamping device 50, when the space is moved or scribing is performed on both mains surfaces of the substrate 90, the first substrate supporting unit 21A does not rub the substrate 90 or exert any force on the substrate. As a result, when a vertical crack is created within the substrate 90 by the cutter wheel 62a, there is no possibility that an undesired crack will result from the cutter wheel 62a (above, function of claim 5).

Furthermore, the first substrate supporting units 21A include the timing belts 21e for supporting the substrate 90. Thus, the first substrate supporting unit 21A does not rub the substrate 90 or does not exert any force on the substrate 90 when the timing belts 21e move in the Y direction. As a result, when a vertical crack is created within the substrate 90 by the cutter wheel 62a, there is no possibility that an undesired crack will result from the cutter wheel 62a (above, function of claim 6).

The first substrate supporting unit 21A may include a plurality of cylindrical rollers. In this case, the substrate 90 is better supported (above, function of claim 7). For example, the plurality of cylindrical rollers is rotated by the clutch 116. The clutch 116 rotates the plurality of cylindrical rollers in accordance with the movement of the scribing device guide body 242. The clutch 116 can select the direction of rotation or stop the rotation of the plurality of cylindrical rollers in accordance with the movement of the space. In this case, when the clamping of the substrate 90 by the clamping device 50 is released, the substrate supporting device 20 can be used for transporting the substrate 90 (above, function of claim 8).

The clutch unit 110 rotates the plurality of cylindrical rollers in accordance with the movement of the scribing device guide body 30. For example, the outer circumferential speed of the plurality of cylindrical rollers is controlled so as to match the moving speed of the scribing device guide body 30 in the Y direction. Therefore, when the plurality of cylindrical rollers moves in the Y direction, the plurality of cylindrical rollers does not rub the substrate 90 or does not exert any force on the substrate 90. As a result, when a vertical crack is created within the substrate 90 by the cutter wheels 62a, there is no possibility that an undesired crack will result from the cutter wheels 62a (above, function of claim 9).

When the first substrate supporting unit 21A is the timing belt 21e, the surface of the substrate is supported on a surface of the timing belt 21e compared to when a cylindrical roller is used. As a result, the substrate is stably supported (above, function of claim 10).

As described above, even when the first substrate supporting unit 21A is the timing belt 21e, the clutch 116 can circle the plurality of belts in accordance with the movement of the scribing device guide body 30. In this case, the belt 21e can select, by the clutch 116, the direction of the circling movement or stop the circling movement of the belt 21e in accordance with the movement of the space. Therefore, when the clamping of the substrate 90 by the clamping device 50 is released, the substrate supporting device 20 can be used for transporting the substrate 90 (above, function of claim 11).

The clutch unit 110 circles the plurality of belts in accordance with the movement of the scribing device guide body 30. As described above, the circling speed of the plurality of belts 21e is controlled so as to match the moving speed of the scribing device guide body 30 in the Y direction. Therefore, when the plurality of belt 21e moves in the Y direction, the plurality of belts 21e does not rub the substrate 90 or does not exert any force on the substrate 90. As a result, when a vertical crack is created within the substrate 90 by the cutter wheel 62a, there is no possibility that an undesired crack will result from the cutter wheel 62a (above, function of claim 12).

The structure and the function of the first substrate supporting section 20A have been described above. The second substrate supporting section 20B may have a structure and a function similar to those of the first substrate supporting section 20A (above, function of claims 14 to 21).

As shown in FIG. 1, a steam unit section 160 is arranged between the substrate carry-out side of the second substrate supporting section 20B and the substrate carry-in side of the substrate carry-out device 80 above the substrate carry-out side of the mounting base 10. The steam unit section 160 is provided in order to completely cut the bonded mother substrate 90 which has not been completely cut after the scribing.

In the steam unit section 160, an upper steam unit attachment bar 162 and lower steam unit attachment bar 163 are attached to a pillar 164 on the frame 11A side and a pillar 164 on the frame 11B side, respectively, along the X direction which is perpendicular to the frame 11A and the frame 11B. The upper steam unit attachment bar 162 attaches a plurality of steam units 161 for spraying steam onto the mother substrate on the upper side of the bonded mother substrate 90. The lower steam unit attachment bar 163 attaches a plurality of steam units 161 for spraying steam onto the mother substrate on the lower side of the bonded mother substrate 90.

The respective pillars 164 on the frame 11A side and on the frame 11B side slide, by the linear motors, along the guide rails 13, respectively, provided on the upper surface of the mounting base 10. In this case of the linear motors, a mover (not shown) for the linear motors are respectively inserted in the stators 12 of the linear motors provided on the upper surface of the mounting base 10. The movers for the linear motors are attached to the steam unit section 160, respectively.

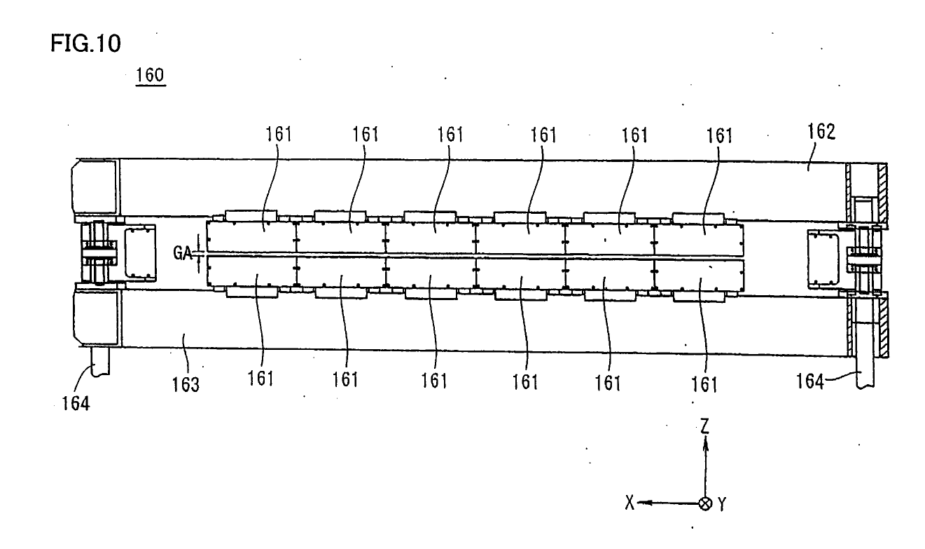

FIG. 10 is a front view of important constituents when the steam unit section 160 is viewed from the substrate carry-in side. Six steam units 161 are attached to the upper steam unit attachment bar 162. Six steam units 161 are attached to the lower steam unit attachment bar 163 with a gap GA with respect to the six steam units 161 on the upper steam unit attachment bar 162. The gap GA is adjusted such that the bonded mother substrate 90 passes through the gap GA when the steam unit section 160 moves to the substrate carry-in side.

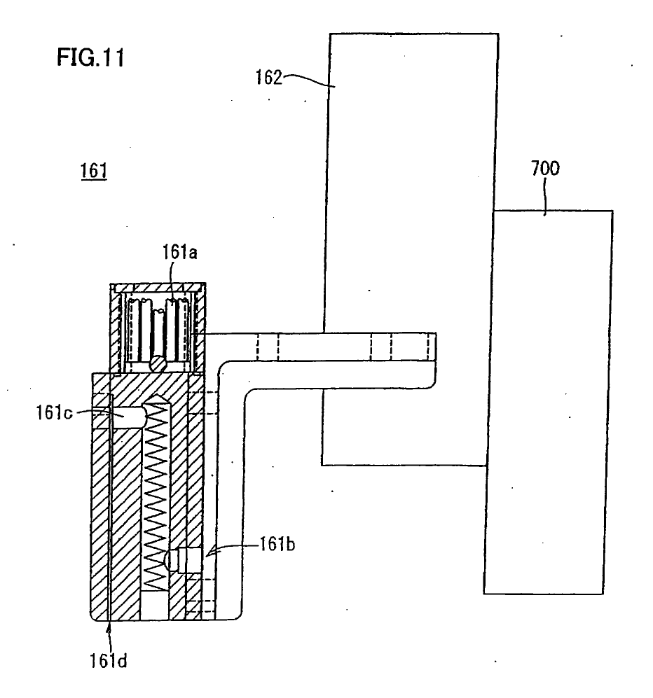

FIG. 11 is a partial sectional view showing the structure of the steam unit 161. The entire steam unit 161 is almost structured with aluminum material. A plurality of heaters 161a is imbedded in the steam unit 161 in a perpendicular direction. When an opening/closing valve (not shown) which automatically opens and closes is opened, water flows into the steam unit 161 from a water supplying mouth 161b. Then, the supplied water is heated by the heaters 161a and evaporates into steam. The steam is sprayed onto the surface of the mother substrate from a gushing opening 161d through a duct hole 161c. When the steam is sprayed onto the top and bottom surfaces of the substrate 90 where a scribing line is formed, the heated moisture infiltrates inside a vertical crack of each scribing line and the vertical crack extends due to the expanding force. As a result, the substrate can be cut (above, function of claim 23).

Any one of substrate adhesion removal devices 700 (air knife 700), 1000, 1500 and 2000 is provided on the carry-out side of the upper stem unit attachment bar 162. The substrate-adhered material removal device 700 (1000, 1500, 2000) is provided for removing the moisture which remains on the surface of the bonded mother substrate 90 after the steam is sprayed onto the upper surface of the bonded mother substrate 90. Since the substrate-adhered material removal device 700 (1000, 1500, 2000) is provided in order to dry the top and bottom surfaces of the substrate, steam is sprayed on the top and the bottom surfaces of the substrate, and the moisture on the top and the bottom surfaces of the substrate can be completely removed after the substrate is cut. Therefore, there is no need to provide a device having a special anti-water means for the next step (above, function of claim 24).

The substrate-adhered material removal devices 700, 1000, 1500 and 2000 will be described later in detail. A steam unit 161 and a substrate-adhered removal device 700 (air knife 700) similar to those attached to the upper steam unit attachment bar 162 are provided on the lower steam unit attachment bar 163.

The bonded mother substrate 90 is mounted on the first substrate supporting section 20A. When the bonded mother substrate 90 is positioned, the bonded mother substrate 90 thus positioned is held by the clamping device 50, and at the same time, is supported by each of the timing belts 21e of the first substrate supporting unit 21A.

In this state, first, after clutches 116 in the four clutch units 110 of the first substrate supporting section 20A and the second substrate supporting section 20B are coupled to the driving axes 122, the upper substrate cutting device 60 and the lower substrate cutting device 70 provided on the scribing device guide body 30 starts cutting the bonded mother substrate 90. As the scribing device guide body 30 moves to the substrate carry-in side, the first substrate supporting section 20A is slid to the substrate carry-in side and furthermore, the second substrate supporting section 20B slides to the substrate carry-in side. While the scribing device guide body 30 is moving to the substrate carry-in side, the timing belts 21e of the first substrate supporting units 21A of the first substrate supporting section 20A and the timing belts 21e of the second substrate supporting units 21B of the second substrate supporting section 20B circle at the same speed as the moving speed of the scribing device guide body 30 and move the bonded mother substrate 90 to the substrate carry-out side. Thus, the bonded mother substrate 90 being cut is in a state of being supported by the timing belts 21e of the first substrate supporting units 21A of the first substrate supporting section 20A and the timing belts 21e of the second substrate supporting units 21B of the second substrate supporting section 20B. However, while the scribing device guide body 30 is moving, the timing belts 21e of the first substrate supporting units 21A of the first substrate supporting section 20A and the timing belts 21e of the second substrate supporting units 21B of the second substrate supporting section 20B try to move the bonded mother substrate 90 in a direction opposite to the moving direction of the scribing device guide body 30 at the same speed as the moving speed of the scribing device guide body 30. Thus, the bonded mother substrate 90 actually does not move and remains held by the clamping device 50 and also, the bonded mother substrate 90 is supported by the timing belts 21e of the first substrate supporting units 21A of the first substrate supporting section 20A and the timing belts 21e of the second substrate supporting units 21B of the second substrate supporting section 20B without being rubbed.

In a state in which the cutting of the bonded mother substrate 90 is completed, the bonded mother substrate 90 is supported by each timing belt 21e of the second substrate supporting unit 21B of the second substrate supporting section 20B.

In a state in which the bonded mother substrate 90 is supported by each of timing belts 21e of the second substrate supporting unit 21B, the steam unit section 160 moves to the substrate carry-in side, sprays the steam onto the entire top and bottom surfaces of the bonded mother substrate 90 on which the scribing lines have been formed. As a result, the vertical cracks on the bonded mother substrate 90 are extended due to the thermal stress and the bonded mother substrate 90 is completely cut. At the same time, the moisture which remains on the top and bottom surfaces of the bonded mother substrate 90 is removed by the substrate-adhered material removal device 700 after the steam is sprayed on the bonded mother substrate 90.

Thereafter, all of the display panels (cut substrate 93) cut from the bonded mother substrate 90 on the timing belts 21e of the all of the second substrate supporting units 21B of the second substrate supporting section 20B are carried out by the carry-out robot 140 or the carry-out robot 500 of the substrate carry-out device 80, thereby the substrate 93 (edge member) being supported.

Next, the substrate carry-out device 80 and the steam unit section 160 move to the end of the substrate carry-out side.

Thereafter, the scribing device guide body 30, the second substrate supporting section 20B and the first substrate supporting section 20A are slid to the substrate carry-out side. At the same time, the timing belts 21e of the first substrate supporting units 21A of the first substrate supporting section 20A and the timing belts 21e of the second substrate supporting units 21B of the second substrate supporting section 20B circle as if the timing belts 21e of the first substrate supporting units 21A of the first substrate supporting section 20A and the timing belts 21e of the second substrate supporting units 21B of the second substrate supporting section 20B moved the bonded glass substrate 90 to the substrate carry-in direction at the same speed as the moving speed of the scribing device guide body 30.

Thus, the timing belts 21e of the first substrate supporting units 21A of the first substrate supporting section 20A and the timing belts 21e of the second substrate supporting units 21B of the second substrate supporting section 20B sequentially become in a non-contact state from the lower surface of the substrate 93 without rubbing thereof. Therefore, the support of the substrate 93 by each timing belt 21e is sequentially released. Thereafter, the holding of the substrate 93 (edge member) by the clamping device 50 is lifted. As a result, the substrate 93 (edge member) falls down. In this case, the substrate 93 (edge member, cullet) thus fallen is guided by a guide plate arranged in a slanted state so as to be accommodated into a cullet accommodation box.

As described above, the pair of scribing devices 60, 70 and the scribing device guide body 30 move in the Y axis direction, the substrate supporting device 20 does not rub the substrate 90 and supports the substrate 90 such that no force exerts on the substrate 90. Thus, when the cutter wheel 62a generates a vertical crack into the substrate, there is no possibility that an undesired crack will result from the cutter wheel 62a (above, function of claim 3).

A positioning device (not shown) is provided on the mounting base 10. The positioning device is provided for determining the position of the bonded mother substrate 90 supported by the first substrate supporting section 20A. In the positioning device, for example, a plurality of positioning pins (not shown) are provided along the frame 11B of the main frame 11 and along the direction perpendicular to the frame 11B with a fixed interval therebetween, respectively. Pushers (not shown) are provided with respect to the positioning pins arranged along the frame 11B. The pushers are provided to push the side edges of the bonded mother substrate 90 which face each positioning pin. Pushers (not shown) are provided with respect to the positioning pins arranged along the direction perpendicular to the frame 11B. The pushers are provided to push the side edges of the bonded mother substrate 90 which face each positioning pin.

Alternatively, for example, when a positioning device for determining the position of the bonded mother substrate 90 is provided separately from the present substrate cutting system immediately before the bonded mother substrate 90 is transported to the substrate cutting system according to the present invention, the positioning device in the present substrate cutting system can be omitted.

The positioning device in the present substrate cutting system is not limited to the positioning pins and pushers described above. Any device can be used as a positioning device as long as the device can fix the position of the bonded mother substrate 90 in the substrate cutting system.

Furthermore, the clamp device 50 is provided above the mounting base 10 supported by the first substrate supporting section 20A. The clamp device 50 is provided to clamp the bonded mother substrate 90 pushed and positioned by each positioning pin. For example, the clamp device 50 includes a plurality of clamp members attached with a fixed interval in the longitudinal direction and a plurality of clamp members arranged with a fixed interval along the direction perpendicular to each main frame 11 as shown in FIG. 2. The plurality of clamp members 51 are attached with a fixed interval in the longitudinal direction is provided to clamp the side edge of the bonded mother substrate 90 positioned along the frame 11B of the main frame 11. The plurality of clamp members 51 and are arranged with a fixed interval along the direction perpendicular to each main frame 11 are provided to clamp the side edges of the bonded mother substrate 90 positioned on the substrate carry-in side.

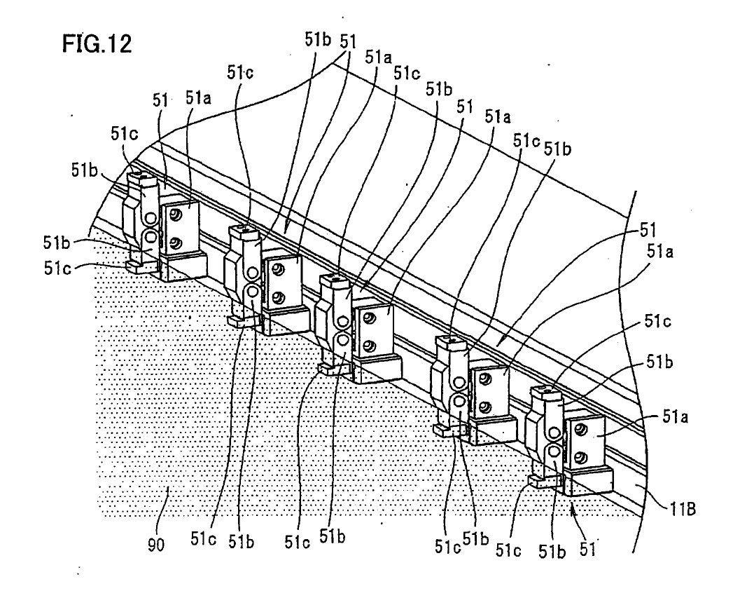

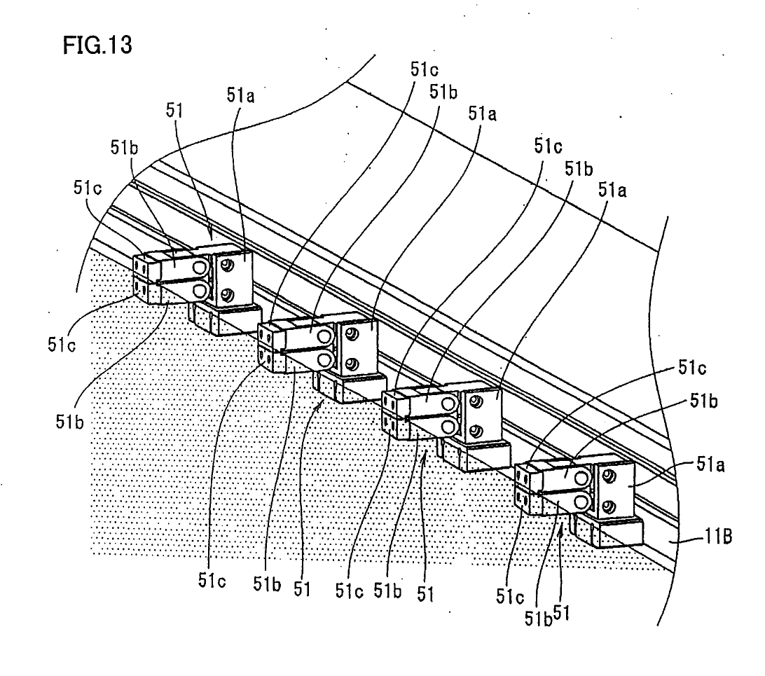

FIGS. 12 and 13 are perspective views for showing a plurality of clamp members 51 provided on the frame 11B of the main frame 11 and explaining the operation thereof. Each clamp member 51 has a structure similar to each other. The clamp member 51 includes a casing 51a and a pair of upper and lower turning arm sections 51b. The casing 51a is attached to the frame 11B of the main frame 11. The turning arm section 51b is attached to the casing 51a so as to be turnable from the vertical state to the horizontal state. Each turning arm section 51b can turn with one of the ends being the center, The ends which are the center of each turning are adjacent to each other. In a vertical state, the tip of the turning arm section 51b positioned on the upper side is positioned above the center of the turning as shown in FIG. 12. In a vertical state, the tip of the turning arm section 51b positioned on the lower side is positioned below the center of the turning as shown in FIG. 12. When each turning arm section 51b turns by 90 degrees toward the bonded mother substrate 90 side, each turning arm section 51b is in a horizontal state facing each other.

A clamp section 51c is attached to the tip of each turning arm section 51b. The clamp sections 51c contact the top surface and the bottom surface of the bonded mother substrate 90, respectively. Each clamp section 51c is made of an elastic body. At the same time when each turning arm section 51b is integrally turned from the vertical state to the horizontal state, each clamp member 51c is turned from the horizontal state to the vertical state. When each turning arm section 51b is turned to the horizontal state, the bonded mother substrate 90 is clamped by the clamp section 51c attached to the tip of each turning arm section 51b as shown in FIG. 13.

Each clamp member 51 which is arranged along the direction perpendicular to the frame 11B of the main frame 11 has a structure similar to each other. The clamp members 51 are integrally driven. When each side edge of the bonded mother substrate 90, perpendicular to each other, is in a state of being clamped by the plurality of clamp members 51, all of the clamp members 51 lower downward and then, the bonded mother substrate 90 is supported by the timing belts 21e of the first substrate supporting section 20A.

In the arrangement of the aforementioned clamp devices 50, the example has been explained in which the aforementioned clamp devices 50 for holding the bonded substrate 90 are provided on the frame 11B of the main frame 11 and on the substrate carry-in side along the direction perpendicular to the frame 11B. However, when the clamp device 50 is only provided on the frame 11B, the bonded mother substrate 90 can be supported without being damaged.

The structure of the aforementioned clamp devices 50 and the clamp members 51 only shows one example which is used in the substrate cutting system according to the present invention and is not limited to this. In other words, any structure can be used as long as the structure can grasp or hold the side edges of the bonded mother substrate 90. For example, when the size of the substrate is small of the substrate can be held by clamping one part of the side edges of the substrate, and the substrate can be cut without causing any defect to the substrate.

The upper substrate cutting device 60 is attached to the upper side guide rail 31 in the scribing device guide body 30 as shown in FIG. 3. The lower substrate cutting device 70 is attached to the lower side guide rail 253 as shown in FIG. 4. The lower substrate cutting device 70 has a structure similar to the upper substrate cutting device 60, but is provided in an inverted state thereto. The upper substrate cutting device 60 and the lower substrate cutting device 70 slide, by the linear motors, along the upper guide rail 31 and the lower guide rail 32 as described above.

For example, the cutter wheels 62a are rotatably attached to the tip holders on the upper substrate cutting device 60 and the lower substrate cutting device 70. The cutter wheel 62a scribes an upper glass substrate of the bonded mother substrate 90. Furthermore, the tip holders 62b are attached to the cutter heads 62c. The tip holders 62b are rotatable in a direction vertical, as their axes, to the surface of the bonded mother substrate 90 held by the clamp devices 50. The cutter heads 62c are movable, by a driving means (not shown), along the direction vertical to the surface of the bonded mother substrate 90. The cutter wheels 62 are loaded by an energizing means (not shown) as appropriate.

As the cutter wheel 62a held by the tip holder 62b, a cutter wheel which has a blade edge with the center in the width direction protruded in an obtuse V shape is used as disclosed in Japanese Laid-Open Publication No. 9-188534. The protrusions with a predetermined height are formed on the blade edge with a predetermined pitch in the circumferential direction.

The lower substrate cutting device 70 provided on the lower side guide rail 32 has a structure similar to the upper substrate cutting device 60, but is provided in an inverted state thereto. The cutter wheel 62a (see FIG. 4) of the lower substrate cutting device 70 is arranged so as to face the cutter wheel 62a of the upper substrate cutting device 60.

The cutter wheel 62a of the upper substrate cutting device 60 is pressed so as to make contact onto the top surface of the bonded mother substrate 90 by the aforementioned energizing means and the moving means of the cutter head 62c. The cutter wheel 62a of the lower substrate cutting device 70 is pressed so as to make contact onto the bottom surface of the bonded mother substrate 90 by the aforementioned energizing means and the moving means of the cutter head 62c. When the upper substrate cutting device 60 and the lower substrate cutting device 70 are simultaneously moved in the same direction, the bonded mother substrate 90 is cut.

As described above, the first substrate supporting section 241A includes the plurality of substrate supporting units 244A. The plurality of substrate supporting units 244A moves in parallel along the moving direction of the scribing device guide body 242. The plurality of first substrate supporting units 244A moves together with the scribing device guide body 242 along with the movement of the scribing device guide body 242. Thus, with a structure such that a space is provided between the scribing device guide body 242 and the first substrate supporting unit 244A, the space is moved in the Y direction, and the substrate 90 is fixed by the clamping device 251, when the space is moved or scribing is performed on both mains surfaces of the substrate 90, the first substrate supporting unit 244A does not rub the substrate 90 or exert any force on the substrate. As a result, when a vertical crack is created within the substrate 90 by the cutter wheel 62a, there is no possibility that an undesired crack will result from the cutter wheel 62a (above, function of claim 5).

Furthermore, the first substrate supporting units 244A include the timing belts for supporting the substrate 90. Thus, the first substrate supporting unit 21A does not rub the substrate 90 or does not exert any force on the substrate 90 when the timing belts 21e move in the Y direction. As a result, when a vertical crack is created within the substrate 90 by the cutter wheel 62a, there is no possibility that an undesired crack will result from the cutter wheel 62a (above, function of claim 6).

The first substrate supporting unit 244A may include a plurality of cylindrical rollers. In this case, the substrate 90 is better supported (above, function of claim 7). For example, the plurality of cylindrical rollers is rotated by the clutch 116. The clutch 116 rotates the plurality of cylindrical rollers in accordance with the movement of the scribing device guide body 242. The clutch 116 can select the direction of rotation or stop the rotation of the plurality of cylindrical rollers in accordance with the movement of the space. In this case, when the clamping of the substrate 90 by the clamping device 251 is released, the substrate supporting device (first substrate supporting section 241A and second substrate supporting section 241B) can be used for transporting the substrate 90 (above, function of claim 8).

The clutch unit 110 rotates the plurality of cylindrical rollers in accordance with the movement of the scribing device guide body 242. For example, the outer circumferential speed of the plurality of cylindrical rollers is controlled so as to match the moving speed of the scribing device guide body in the Y direction. Therefore, when the plurality of cylindrical rollers moves in the Y direction, the plurality of cylindrical rollers does not rub the substrate 90 or does not exert any force on the substrate 90. As a result, when a vertical crack is created within the substrate 90 by the cutter wheels 62a, there is no possibility that an undesired crack will result from the cutter wheels 62a (above, function of claim 9).

When the first substrate supporting unit 244A is the timing belt, the surface of the substrate is supported on a surface of the timing belt as compared to when a cylindrical roller is used. As a result, the substrate is stably supported (above, function of claim 10).

As described above, even when the first substrate supporting unit 244A is the timing belt, the clutch 116 can circle the plurality of belts in accordance with the movement of the scribing device guide body 244. In this case, the belt 21e can select, by the clutch 116, the direction of the circling movement or stop the circling movement of the belt in accordance with the movement of the space. Therefore, when the clamping of the substrate 90 by the clamping device 251 is released, the substrate supporting device 20 can be used for transporting the substrate 90 (above, function of claim 11).

The clutch unit 110 circles the plurality of belts in accordance with the movement of the scribing device guide body 244. As described above, the circling speed of the plurality of belts is controlled so as to match the moving speed of the scribing device guide body 242 in the Y direction. Therefore, when the plurality of belt moves in the Y direction, the plurality of belts does not rub the substrate 90 or does not exert any force on the substrate 90. As a result, when a vertical crack is created within the substrate 90 by the cutter wheel 62a, there is no possibility that an undesired crack is will result from the cutter wheel 62a (above, function of claim 12).

The structure and the function of the first substrate supporting section 241A have been described above. The second substrate supporting section 241B may have a structure and a function similar to those of the first substrate supporting section 241A (above, function of claims 14 to 21).

It is preferred that the cutter wheel 62a is rotatably supported by the cutter head 65 using the servo motor disclosed in WO 03/011777.

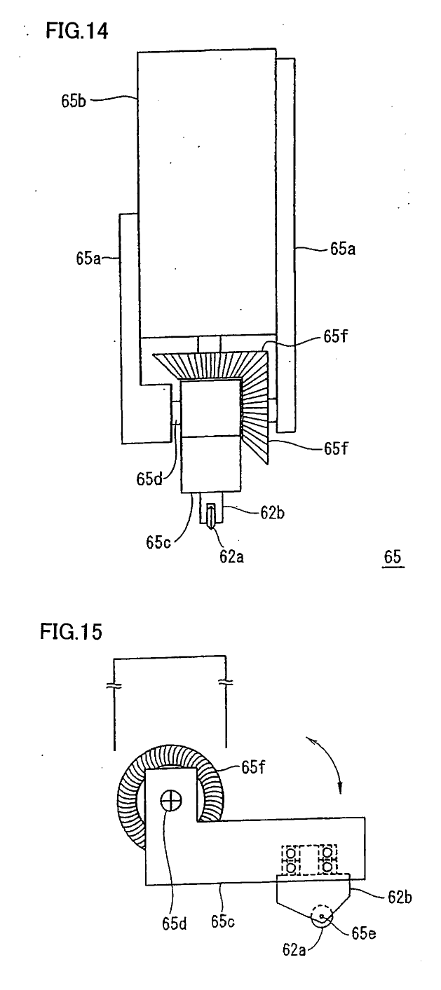

FIG. 14 shows a side view of the cutter head 65 and FIG. 15 show a front view of the important constituents thereof as one example of the cutter head 65 using the servo motor. The servo motor 65b is supported in an inverted manner between a pair of side walls 65a. A holder holding member 65c is provided below the pair of side walls 65a so as to be rotatable via a supporting axis 65d, the holder holding member 65c having an L shape when viewed from the side. A tip holder 62b is attached in front (on the right-hand side in FIG. 15) of the holder holding member 65c. The tip holder 62b is attached to rotatably support the cutter wheel 62a via an axis 65e. Flat bevel gears 65f are mounted on the rotation axis of the servo motor 65b and the supporting axis 65d so as to engage with each other. Thus, the holder holding member 65c performs an upwards and downwards tilt operation with the supporting axis 65d as its supporting point and the cutter wheel 62a moves upwards and downwards due to the forward and reverse rotation of the servo motor 65b. The cutter heads 65 themselves are provided on the upper substrate cutting device 60 and the lower substrate cutting device 70.

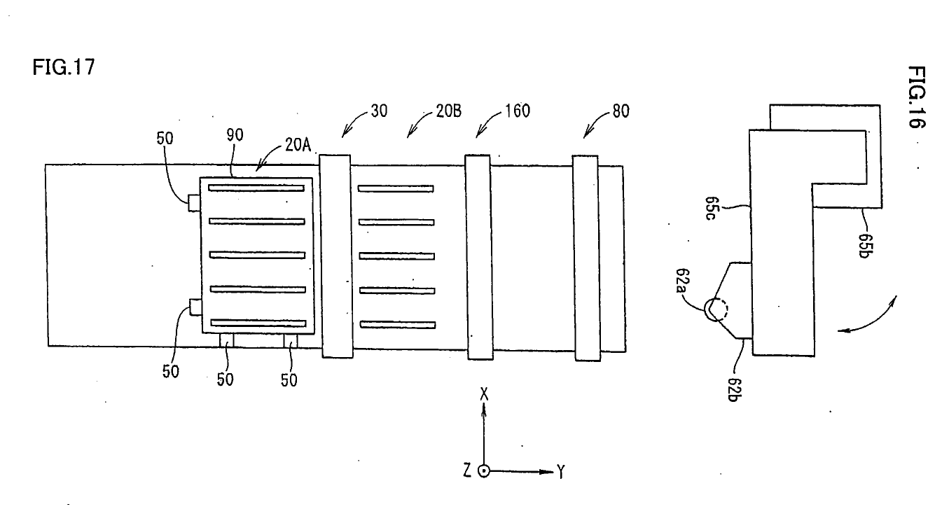

FIG. 16 is a front view showing another example of cutter head using a servo motor 65b. The rotation axis of the servo motor 65d is directly connected to the holder member 65c. The cutter heads shown in FIGS. 14 and 16 move the cutter wheels 62a upwards and downwards by rotating the servo motors using the position control so as to position the cutter wheel 62a. The cutter heads transmit the scribing pressure for the brittle material substrate to the cutter wheel 62a by controlling the rotation torque. The rotation torque acts to return the cutter wheel 62a to the set position when the position of the cutter wheel 62a is shifted from the positions set in the servo motors 65b beforehand during the scribing operation for forming a scribing line on the bonded mother substrate 90 by moving the cutter heads in a horizontal direction. In other words, the servo motor 65b controls the position in the perpendicular direction of the cutter wheel 62a, and at the same time, the servo motor 65b is an energizing means for the cutter wheel 62a.

By using the cutter head including the aforementioned servo motor, when the bonded mother substrate 90 is being scribed, the rotation torque of the servo motor is corrected immediately in response to the change of the scribing pressure by the change in resistive force received by the cutter wheel 62a. Thus, scribing is stably performed and a scribing line with an excellent quality can be formed. Furthermore, since the pressure force of the cutter wheel 62a is transmitted to the substrate 90 by using the servo motor, the transmittance of the pressure force to the substrate 90 becomes responsive. Thus, the pressure force (scribing load) of the cutter wheel 62a to the substrate 90 during the scribing can be changed (above, function of claim 22).

A cutter head is effectively applied to cutting the mother substrate in the substrate cutting system according to the present invention, the cutter head including a mechanism for vibrating a scribing cutter (e.g., a diamond point cutter or a cutter wheel) which scribes the bonded mother substrate 90 so as to periodically change the pressure force of the scribing cutter on the bonded mother substrate 90.

The structure of the upper substrate cutting device 60 and the lower substrate cutting device 70 is not limited to the aforementioned structure. In other words, any structure can be used, as long as the device has a structure for processing the top and bottom surfaces of the substrate so as to cut the substrate.

For example, the upper substrate cutting device 60 and the lower substrate cutting device 70 can be a device which cuts the mother substrate by using such as a laser light, a dicing saw, a cutting saw, a cutting blade or a diamond cutter.

When the mother substrate is made of a metal substrate (e.g., a steel plate), a wood plate, a plastic substrate or a brittle material substrate (e.g., a ceramic substrate, glass substrate or semiconductor substrate), a substrate cutting device for cutting the mother substrate by using, for example, a laser light, a dicing saw, a cutting saw, a cutting blade or diamond cutter is used.

Furthermore, when a bonded mother substrate for which a pair of mother substrate is bonded to each other, a bonded mother substrate for which different types of mother substrates are bonded to each other or a stacked substrate for which a plurality of mother substrates are stacked on each other is cut, a substrate cutting device similar to the one used for cutting the aforementioned mother substrate can be used.

For example, since a bonded mother substrate, for which brittle material substrates are bonded to each other and is used for an FPD, is bonded by using an adhesive, bendings and undulations are created in the bonded mother substrate 90. In the substrate cutting system 1 according to the present invention, each cutter wheel 62a can scribe the substrate in accordance with the undulations and bendings of the substrate 90 so as to balance the load applied to each cutter wheel 62a facing each other. Thus, the cutter wheel 62a can be effectively applied to cutting the bonded mother substrate 90 (above, function of claim 48).

The upper substrate cutting device 60 and the lower substrate cutting device 70 may include a cutting assistance means for assisting the cutting of the substrate. As a cutting assistance means, for example, a means for pressing (e.g., a roller on the substrate), a means for spraying compressed air onto the substrate, a means for irradiating a laser onto the substrate or a means for warming (heating) the substrate by spraying such as heated air onto the substrate is used.

Furthermore, in the description above, the upper substrate cutting device 60 and the lower substrate cutting device 70 have the same structure. However, the upper substrate cutting device 60 and the lower substrate cutting device 70 can have structures different from each other, depending on the cut pattern of the substrate or the cutting condition of the substrate.

The operation of the substrate cutting system having such a structure will be mainly described as an example for the case where a bonded substrate for which large-sized glass plates are bonded to each other is cut.

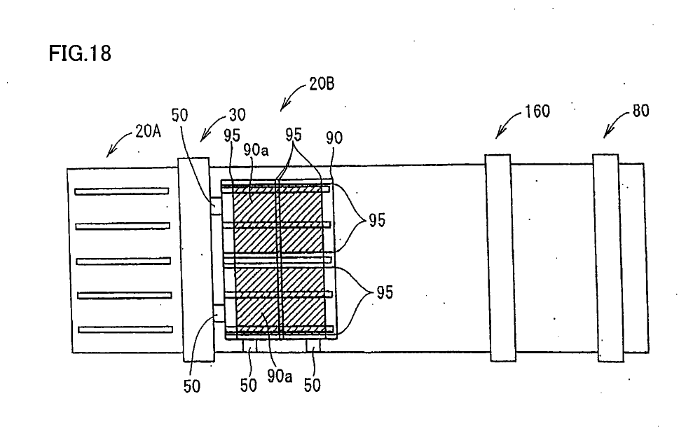

When the bonded mother substrate 90 for which large-sized glass substrates are bonded to each other is cut into a plurality of panel substrates 90a (see FIG. 18), first, as shown in FIG. 17, the bonded mother substrate 90 is carried in, by a transportation robot, etc., from the end of the substrate carry-in side to the present substrate cutting system. Thereafter, the bonded mother substrate 90 is mounted, in a horizontal state, on each timing belt 21e of all of the first substrate supporting units 21A of the first substrate supporting section 20A.

In this state, the bonded mother substrate 90 is pushed by pushers (not shown) so as to contact positioning pins (not shown) arranged along the frame 11B of the main frame 11, and at the same time, the bonded mother substrate 90 is pushed by pushers (not shown) so as to contact positioning pins (not shown) arranged along the direction perpendicular to the frame 11B. Thereby, the bonded mother substrate 90 is positioned in a predetermined position in the mounting base 10 in the substrate cutting system.

Thereafter, as shown in FIG. 17, the side edge of the bonded mother substrate 90 being positioned on the substrate carry-in side is clamped by each clamp member 51 of the clamp device 50, the side edge being along the frame 11B of the main frame 11, and at the same time, the side edge of the bonded mother substrate 90 is clamped by each clamp member 51 which is arranged on the substrate carry-in side in order to be perpendicular to the frame 11B.

When the side edge of the bonded mother substrate 90 is clamped by the clamp device 50, the side edge being perpendicular to each other, each clamp member 51 which clamps the side edge of the bonded mother substrate 90 lowers at approximately the same time due to the weight of the bonded mother substrate 90. Therefore, the bonded mother substrate 90 is additionally supported by the timing belts 21e of all of the first substrate supporting units 21A.

In this state, after the clutches 116 in the four clutch units 110 of the first substrate supporting section 20A and the second substrate supporting section 20B are coupled to the driving axes 122, the scribing device guide body 30 is slid to the substrate carry-in side so as to be at a predetermined adjacent position which is above the side edge of the bonded mother substrate 90 clamped by the clamp device 50 in a horizontal state. When the first optical device 38 and the second optical device 39 provided on the scribing device guide body 30 move along the scribing device guide body 30 from respective waiting positions, the first optical device 38 and the second optical device 39 capture the first alignment mark and the second alignment mark provided on the bonded mother substrate 90, respectively.

When the scribing guide body 30 slides, the first substrate supporting section 20A is slid to the substrate carry-in side and the second substrate supporting section 20B is slid to the substrate carry-in side, and at the same time, the timing belts 21e of the first substrate supporting units 21A of the first substrate supporting section 20A and the timing belts 21e of the second substrate supporting units 21B of the second substrate supporting section 21B move the bonded glass substrate in a direction opposite to the moving direction of the scribing device guide body 30 at the same speed as the moving speed of the scribing device guide body 30. Thus, the bonded mother substrate 90 remains held by the clamp device 50 and is supported by the timing belts 21e of the first substrate supporting units 21A of the first substrate supporting section 20A and the timing belts 21e of the second substrate supporting units 21B of the second substrate supporting section 20B without being rubbing.

Next, based on the result of the captured first alignment mark and second alignment mark, the inclination of the bonded mother substrate 90 with respect to the direction along the scribing device guide body 30 and the starting and ending position of cutting the bonded mother substrate 90 are calculated by an operational processing device (not shown). The bonded mother substrate 90 is supported by the clamp devices 50 in a horizontal state. Based on the result of the operation, the upper substrate cutting device 60 and the lower substrate cutting device 70 are moved in the X direction corresponding to the inclination of the bonded mother substrate 90, and at the same time, the scribing device guide body 30 is moved in the Y direction so as to cut the bonded mother substrate 90 (which is referred to as “scribing by linear interpolation” or “cutting” by linear interpolation). In this case, as shown in FIG. 18, each cutter wheel 62a facing each other is pressed so as to make contact onto the top surface and the bottom surface of the bonded mother substrate 90 and rolled on the top surface and the bottom surface of the bonded mother substrate 90, respectively, so as to form scribing lines on the top surface and the bottom surface of the bonded mother substrate 90.

The bonded mother substrate 90 is, for example, cut so that two panel substrates 90a are cut forming into two lines in a line direction along the upper guide rail 31 and the lower guide rail 32. The cutter wheel 62a of the upper substrate cutting device 60 and the cutter wheel 62a of the lower substrate cutting device 70 are pressed so as to make contact and rolled along the side edge of the panel substrates 90a in order to cut four panel substrates 90a from the bonded mother substrate 90.

In this case, vertical cracks are created by the cutter wheel 62a of the upper substrate cutting device 60 and the cutter wheel 62a of the lower substrate cutting device 70 on the part of the glass substrate where each cutter wheel 62a is pressed so as to make contact and rolled. As a result, scribing lines 95 are formed thereon. Protrusions are formed, with a predetermined pitch, on the outer circumferential ridge of the blade edge of each cutter wheel 62a. Thus, a vertical crack having about 90% of the thickness of the glass substrate in the thickness direction is formed on each glass substrate.

A scribing method is effectively applied to cutting the bonded mother substrate 90 in the substrate cutting system according to the present invention, the scribing method using the cutter head including a mechanism for vibrating a scribing cutter (e.g., a diamond point cutter or a cutter wheel) which scribes the bonded mother substrate 90 so as to periodically change the pressure force of the scribing cutter on the bonded mother substrate 90.

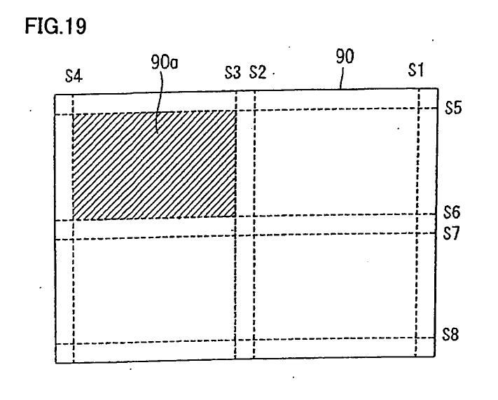

As a method for scribing the top and bottom surfaces of the bonded mother substrate 90, as shown in FIG. 19, a conventional method is commonly used, in which the formation of the scribing lines, in the following order, along lines S5 to S8 to be scribed in a lateral direction (direction with a longer side of the bonded mother substrate 90) are formed after the formation of scribing the lines, in the following order, along lines S1 to S4 to be scribed in a longitudinal direction (direction with a shorter side of the bonded mother substrate 90).

(Detailed Description of Vacuum Adsorption Head)

Hereinafter, a vacuum adsorption head 600 (e.g., a vacuum adsorption head 140q and a vacuum adsorption head 540) according to the present invention will be described in detail.

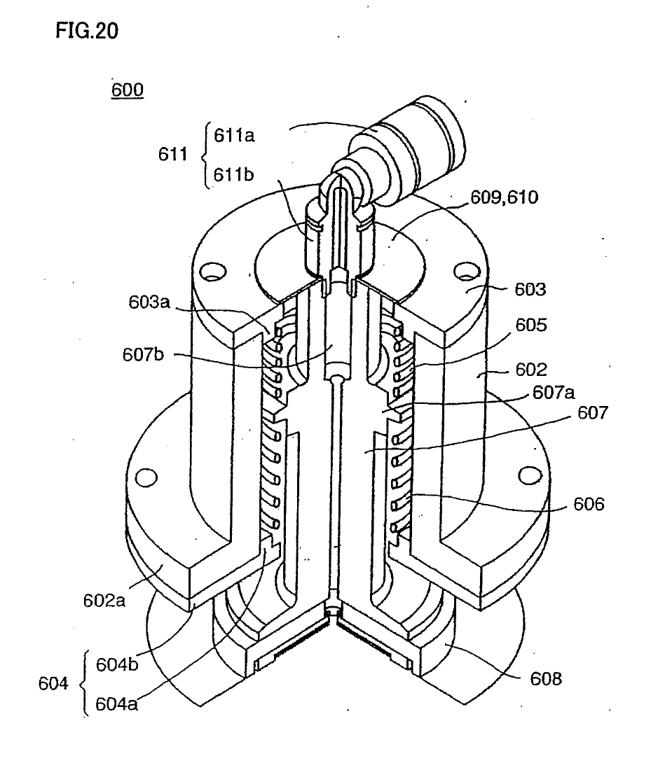

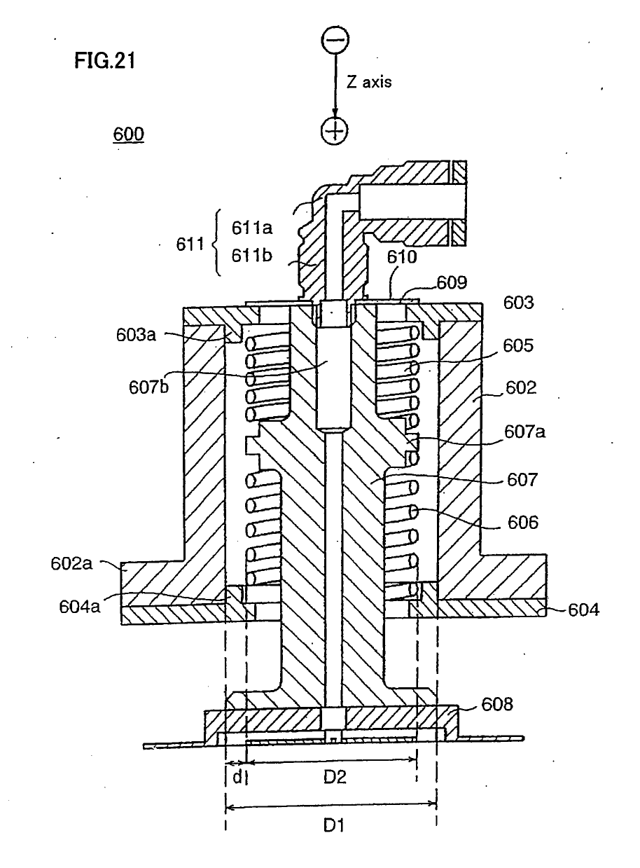

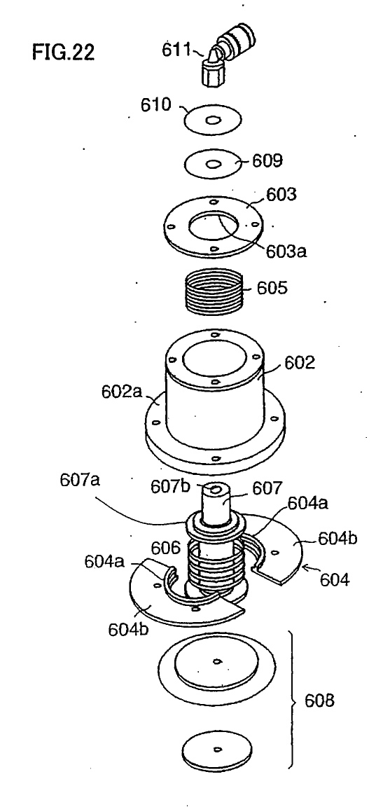

FIG. 20 is a broken cross-sectional view showing an inner structure of the vacuum adsorption head 600 according to the present embodiment. FIG. 21 is a cross-sectional view showing the vacuum adsorption head 600 which is cut along the central axis thereof. FIG. 22 is an exploded perspective view showing the mounting relationship between each constituent of the vacuum adsorption head 600.

The vacuum adsorption head 600 includes a casing section, an adsorption section and an elastic supporting section.

The adsorption section includes an adsorption pad 608 and a suction shaft 607. The adsorption pad 608 is provided in order to vacuum-adsorb the substrate 90. The suction shaft 607 is provided having an exhaust hole provided in order to exhaust air into the adsorption head 608. The casing section controls the movement range of the suction shaft 607 and supports the suction shaft 607 so that the suction shaft 607 is slightly movable. The elastic supporting section elastically supports the suction shaft 607 in the casing section so that the suction shaft 607 is slightly movable in its axial direction and in a direction diagonal to its axial direction.

The suction shaft 607 includes a step section 607a in a shape of flange provided approximately in the middle of the casing section.

The casing section includes a casing 602, an upper casing plate 603 and a lower casing plate 604. The casing 602 includes a space for deformably holding the elastic supporting section therein. The upper casing plate 603 closes an upper end of the casing 602 with a first opening remain opening. The lower casing plate 604 closes a lower end of the casing 602 with a second opening remaining open.

The elastic supporting section includes an upper spring 605 and a lower spring 606. The upper spring 605 is held between the upper casing plate 603 and the step section 607a. The lower spring 606 is held between the lower casing plate 604 and the step section 607a.

As shown in FIG. 21, description will be made assuming that the central axis of the vacuum adsorption head 600 is a z axis, the upper direction is −, and the lower direction is +. As described above, the casing section includes the casing 602, the upper casing plate 603 and the lower casing plate 604. As the elastic supporting section, the upper spring 605 and the lower spring 606 are provided within the casing 602. The casing section supports the adsorption section so that the adsorption section is movable via the elastic supporting section in the z axial direction and a diagonal direction tilted from the z axis (i.e., the adsorption section freely moves in accordance with the tilt). The casing section corrects the position of the suction shaft 607 in a predetermined direction using the inner spring force of the casing section. The adsorption section is configured by the suction shaft 607, the adsorption pad 608, a lubricating sheet 609, a stopper plate 610 and a connection section 611.

The casing section will be described with reference to FIGS. 20 to 22. The casing 602 is a cylindrical member with a flange 602a integrally formed at the lower portion of the casing 602. The inner diameter of the casing 602 is D1. It is assumed that each outer diameter of the upper spring 605 and the lower spring 606 is D2. Also, it is assumed that the clearance in which the upper spring 605 and the lower spring 606 can freely deform inside the casing 602 is d. In this case, D1=D2+2d. The flange section 602a fixes the casing 602 to the lower casing plate 604. The flange section 602a has a thickness such that a screw hole for fixing can be provided. The upper casing plate 603 has a first opening in the middle thereof. When the upper casing plate 603 holds the suction shaft 607 via the upper spring 605 and the lower spring 606 such that the suction shaft 607 can freely move in the upwards and downwards directions, the upper casing plate 603 fixes the upper portion of the upper spring 605. The outermost diameter thereof is the same size as the outer diameter of the cylindrical portion of the casing 602. The upper casing plate 603 is fixed to the upper end surface of the casing 602 by a screw. A protrusion 603a in a ring shape is provided inside the upper casing plate 603. The lower casing plate 604 is configured by two semicircular plates 604b as shown in FIG. 22. The lower casing plate 604 has a second opening in the center thereof. A protrusion 604a in a ring shape is provided inside the lower casing plate 604. The protrusion 603a controls the upper end position of the upper spring 605 so that the upper end position of the upper spring 605 is in the same axis as the upper casing spring plate 603. The protrusion 604a controls the lower end position of the lower spring 606 so that the lower end position of the lower spring 606 is in the same axis as the lower casing spring plate 604. The suction shaft 607 is contacted to the inside of the first opening and the second opening, the inside being provided in the center of the upper casing plate 603 and in the center of the lower casing plate 604, respectively, so that the tilt of the suction shaft 607 is controlled.

Next, the adsorption section will be described. The suction shaft 607 is a hollow shaft in which an intake hole is formed for exhausting air within the adsorption pad 608 and releasing negative pressure within the adsorption pad 608 when the vacuum adsorption head 600 contacts an object to be adsorbed while the suction shaft 607 holds the adsorption pad 608. A circular lubricating sheet 609 and a stopper plate 610 are attached to the end face of the upper side of the suction shaft 607 as shown in FIG. 22.

The connection section 611 can be either elbow-shaped or straight-shaped. However, the connection section 611 which has an elbow shape is shown herein. As shown in FIG. 20, the connecting section 611 has a connector 611a and a nipple 611b. When the nipple 611b is engaged with a female screw provided on the upper portion of the intake hole 607b of the suction shaft 607 and a male screw of the connector 611a, the connector 611a is connected to the suction shaft 607.

The elastic supporting section will be described. The upper spring 605 and the lower spring 606, which are the elastic supporting section, are coil springs having the same outer diameter D2 and inner diameter to each other. In order to hold the upper spring 605 and the lower spring 606 as shown in FIG. 20 or 21, the suction shaft 607 is of a simple body and the lower spring 606 is inserted from the upper portion of the suction shaft 607 while the lower spring 606 is deformed with the application of rewinding force so that the inner diameter thereof is enlarged. After the lower spring 606 passes the step section 607a, the rewinding force is released. Thus, the lower spring 606 can be held at a proper position. In this state, as shown in FIG. 22, the lower casing plate 604 divided in half is fixed to the flange section 602a of the casing 602 by a screw. The upper spring 605 only has to be inserted from the upper portion of the suction shaft 607 and then, the upper spring 605 can be held at a proper position. Next, compressive force (pressurization) is applied to the upper spring 605 and the lower spring 606. In this state, the upper casing plate 603 is fixed to the upper end face of the casing 602 by a screw. In this manner, the upper spring 605 and the lower spring 606 can be held while force is being applied to the upper spring 605 and the lower spring 606.

In order to fix the lubricating sheet 609 and the stopper plate 610, the nipple 611b is engaged with the intake hole 607b of the suction shaft 607. While in this state, when each component is set, the force applied to the upper spring 605 becomes larger than the force applied to the lower spring 606. Thus, the restoring force against the force applied to the upper spring 605 works and the suction shaft 607 is pulled closer in the +z axis direction. However, further movement of the suction shaft 607 in the +z axis direction is controlled when the stopper plate 610 contacts the upper surface of the upper casing plate 603. When the adsorption pad 608 contacts the object to be adsorbed, the suction shaft 607 moves in the −z axis direction.

As described above, the adsorption shaft 607 is slightly movable in its axial direction and in a direction diagonal to the axial direction, and is elastically supported so as to move accordingly. Thus, the adsorption pad 608 can firmly hold the substrate 90 in accordance with the main surface of the substrate 90 even if there is a presence of undulations or bendings on the substrate 90 (above, function of claim 42).

Furthermore, the adsorption pad 608 is returned to a state, due a restoring force of the spring, in which the adsorption face of the adsorption pad 608 virtually faces directly downward before the adsorption pad 608 adsorbs the substrate 90 and when the adsorption pad 608 stops adsorbing the substrate 90. Thus, when the adsorption pad 608 adsorbs the substrate 90, there is no possibility that the adsorption pad 608 causes damages to the substrate 90 and it does not fail to adsorb the substrate 90 (above, function of claim 43).

The upper casing plate 603, the casing 602 and the lower casing plate 604 are structured separately. The structure of the casing section is not limited to this structure as long as it can hold the degree of deformation of the elastic supporting member. The manner of inserting the upper spring 605 and the lower spring 606 is not limited to the method described above. Furthermore, each of the size of the inner diameter and outer diameter of the upper spring 605 and the lower spring 606 are not limited to a size that is same to each other. The lengths or spring constants of the upper spring 605 and the lower spring 606 are changed as appropriate in accordance with other conditions. When the outer diameter of the attachment section for the adsorption pad of the adsorption shaft 607 is small of the upper spring 605 can be inserted from the upper portion of the adsorption shaft 607, the lower spring 606 can be inserted from the lower portion of the adsorption shaft 607, using the step section 607a as a boundary therebetween. The shape of the adsorption shaft 607 is not limited to the one shown in FIGS. 20 and 21. For example, instead of the adsorption shaft 607's body having a step section 607a being integrally processed, an E ring or an 0 ring can be inserted onto the cylindrical portion of the adsorption shaft 607. Thus, the ring can hold the upper end of the upper spring 605 and the upper end of the lower spring 606. The thin plate stopper plate 610 is provided in order to control the movement of the adsorption shaft 607 in the +z direction. However, an E ring or an O ring can be inserted instead of stopper plate 610. Commonly-used connector 611a and the nipple 611b are used for the connection section 611. However, connection components having other structures can be used.

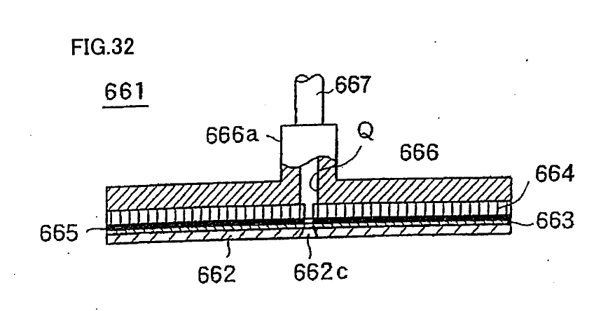

The structure of the adsorption pad can be varied depending on its use. When a commonly-used substrate or press-processed product is adsorbed, an adsorption pad 651 as shown in FIG. 31 can be used. When a bonded display panel substrate for which two glass substrates are bonded to each other is adsorbed, an adsorption pad 661 as shown in FIG. 32 is used such that an uneven distribution of spacer between two glass substrates does not occur. Furthermore, when a large-sized bonded glass substrate is adsorbed at a plurality of spots, a plurality of adsorption pads 661 is used. In such a case, due to the attachment difference between each adsorption pad and the tilt of the adsorption head, to which a plurality of adsorption pads are attached, with respect to the object to be adsorbed, conventionally, a gap occurs between each adsorption pad and the object to be adsorbed. Thus, when all of the adsorption planes of the adsorption pads are contacted so as to adsorb the object to be adsorbed, there are some cases in which some of the adsorption planes strongly push the object to be adsorbed. In this case, when the object to be adsorbed is, for example, a brittle material substrate, there is a possibility that damages are caused to the brittle material substrate or the gap between two glass substrates of a liquid crystal display panel is changed. In this sense, when the object to be adsorbed is adsorbed using a conventional vacuum adsorption head, it is desirable to have a gap, for example, of 0.0 mm to 0.3 mm between the adsorption pad and the object to be adsorbed. However, the vacuum adsorption head according to the present invention adsorbs the object to be adsorbed after contacting it. The vacuum adsorption head 600 according to the present invention softly contacts the object to be adsorbed and smoothly moves in the upwards and downwards directions. Therefore, a height between each adsorption pad can be different. Thus, even when the vacuum adsorption head 600 strongly pushes the object to be adsorbed, it does not cause any damage to the object to be adsorbed and can firmly adsorb the object to be adsorbed.

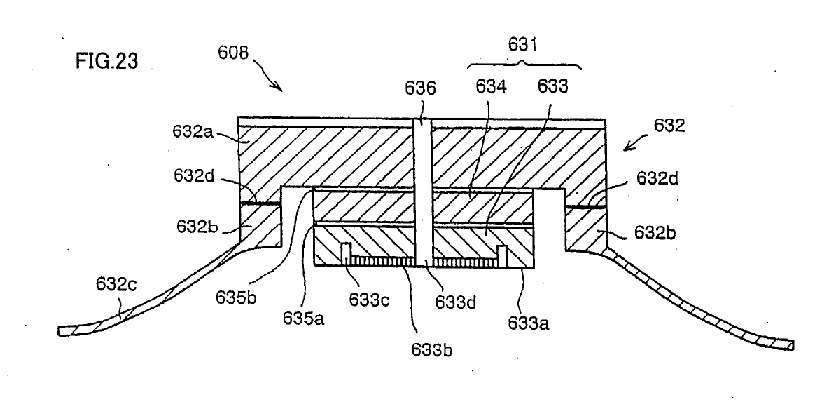

The structure of adsorption pad 608 according to another embodiment of the present invention will be described with reference to FIG. 23. The adsorption pad 608 includes a vacuum adsorption pad 631 and a skirt pad 632. The vacuum adsorption pad 631 is a multi-layered structure in which an adsorption board 633 and a reinforcement layer 634 are joined with a double-faced adhesive sheet 635a. The adsorption board 633 includes a sealing section 633a which is a flat face in the periphery of the adsorption board 633 and an adsorption section 633b on which multiple concave-convex portions are formed.

The adsorption board 633 is made of a photo-sensitive resin material and has a disc shape. An opening 633d penetrates on the center of the adsorption board 633 in the upwards and downwards directions. The opening 633d is provided as a part of the suction opening 636. The sealing section 633a is an area in which the photo-sensitive resin material is not etched. An annular groove 633c is formed as a new concaved portion on each inner circumferential side of the sealing section 633a. The opening 633d is provided in the center of the adsorption board 633. The grooves are connected to the opening 633d and are used as a passage when air present in the concaved portion is exhausted. The reinforcement layer 634 is a bonded layer such that the photo-sensitive resin material, which configures the enforcement board 633, does not deform due to an external force.

The skirt pad 632 is a rubber molding in which a plate section 632a, an annular section 632b and a skirt section 632c are integrally molded. The plate section 632a is a holding member in a disc shape for holding the vacuum adsorption pad 631 via a double-faced adhesive sheet 635b. The diameter of the plate section 632a is sufficiently larger than the outer diameter of the vacuum adsorption pad 631. An opening is provided in the center of the plate section 632a. The opening which is connected to the opening of the vacuum adsorption pad 631 forms the suction mouth 636. The annular section 632b is thickly formed in an annular shape at the 631 with a predetermined interval. The annular section 632b is formed such that the vacuum adsorption pad 631 protrudes below the annular section 632b. The lower surface of the annular section 632b is formed above the lower surface of the vacuum adsorption pad 631. The skirt section 632c has the annular section 632b at its root. The skirt section 632c is a thin annular-rubber member and is spread conically in a direction facing the brittle material substrate.

The skirt pad 632 acts to enlarge the exhaust space at the vicinity of the adsorption section and enlarge an adsorable interval between the vacuum adsorption pad 631 and the object to be adsorbed when it adsorbs the object to be adsorbed. Since the thickness of the skirt pad 632o is thin, when the adsorption pad 608 approaches the object to be adsorbed, the outer circumferential portion of the skirt section 632c contacts the object to be adsorbed and elastically deforms. As described above, when the skirt section 632o of the skirt pad 632 contacts the object to be adsorbed, it exhibits a sealing function to shut off the inflow of air from outside.

A slit 632d is a gap provided at the annular section 632b, through which air leaks between the inside and outside of the skirt. The slit 632d is realized, for example, by cutting a portion of the sides of the skirt pad 632 after the skirt pad 632 is molded. The slit 632d is a penetration hole having a size which can maintain the inner space in negative pressured state during the time after the skirt section 632c contacts the object to be adsorbed and before the vacuum adsorption pad 631 contacts the object to be adsorbed, and does not prevent the vacuum adsorption pad 631 from adsorbing the object to be adsorbed.

Compared to the conventional adsorption pad of example 2 shown in FIG. 32, the adsorption pad 608 shown in FIG. 23 has the skirt section added thereto, so that the contacting area of the adsorption pad 608 is enlarged. Thus, there is an effect that the adsorption pad 608 is likely to move in accordance with the tilt or the undulation of the surface of the brittle material substrate which is an object to be adsorbed. As a result, the vacuum adsorption pad according to the present invention is further easily tilted in accordance with the tilt or the undulation of the surface of the brittle material substrate. Therefore, the vicinity of the adsorption board 633 can be stably negative-pressurized at an early stage immediately before the vacuum adsorption pad 608 adsorbs the brittle material substrate.

In FIGS. 20 to 22, as an adsorption pad, the adsorption pad 608 in FIG. 23 is shown as an example to be attached. However, depending on the material, the structure and the shape of an object to be absorbed, the adsorption pads shown in FIGS. 31 and 32 can be attached. For example, the adsorption pad 651 shown in FIG. 31 can be used for a commonly-used substrate or press-processed product. In the case of a bonded glass substrate (e.g., liquid crystal display panel) or a bonded plastic substrate, it is preferable to use the adsorption pad 661 shown in FIG. 32 in order to avoid the gap between the two substrates from being changed.

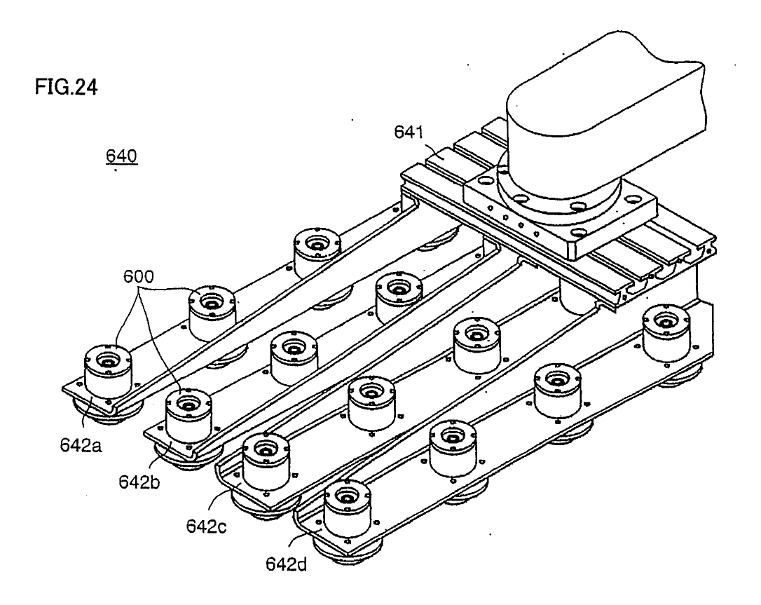

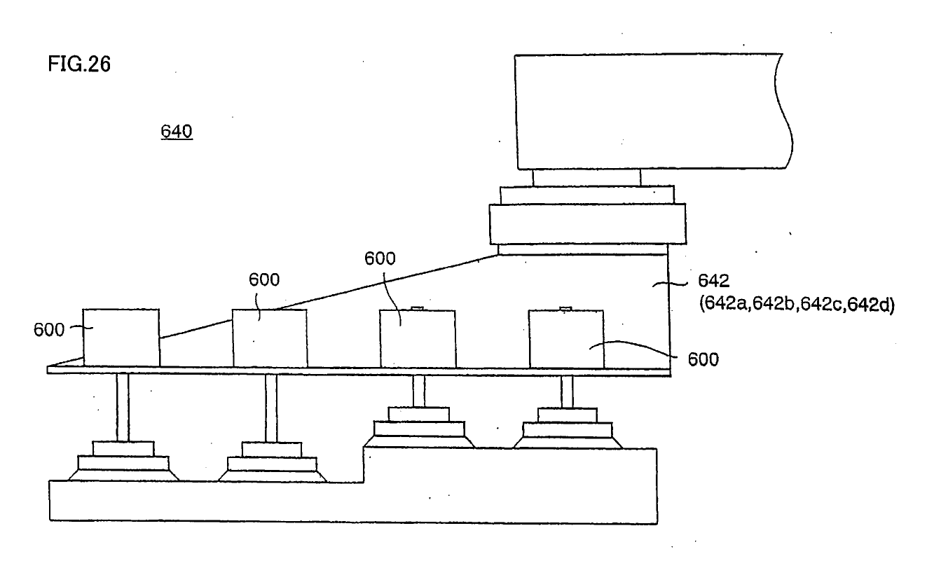

The operation when a large-sized object to be adsorbed is adsorbed and transferred using the vacuum adsorption head 600 structured as described above will be described. FIG. 24 is a view schematically showing an example of a transportation robot 640 to which a plurality of vacuum adsorption heads 600 are attached. A plurality of angles 642a, 642b, 642c and 642d are fixed to a chucking table 641, depending on the size of an object to be adsorbed. A row of a plurality of vacuum adsorption heads 600 is attached to each angle 642 depending on the size of the object to be adsorbed. Even when the object to be adsorbed which is mounted on a working table (not shown) has undulations on its surface, the adsorption pad 608 can move in accordance with the undulations. Thus, there is no need for a height determination mechanism or for individually adjusting the height of the adsorption head as conventionally required, thereby making the process for attaching and adjusting the adsorption head easy. FIG. 26 is a view schematically showing an example of adsorbing an object to be adsorbed by the transportation robot 640 to which a plurality of vacuum adsorption heads 600 are attached, the object to be adsorbed having steps. As shown in FIG. 26, even in the case of the object to be adsorbed which has a small step (offset) on the adsorption plane, the adsorption pad moves in the upwards and downwards directions in accordance with shape of the surface of the object to be adsorbed. Thus, the object to be adsorbed can be firmly adsorbed. When the object to be adsorbed is small, only one vacuum adsorption head 600 needs to be provided on the transportation robot 640.

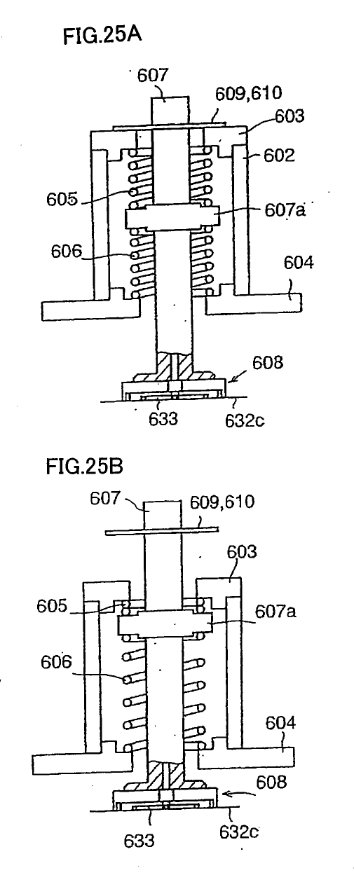

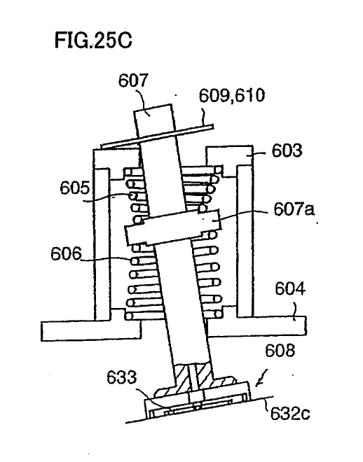

FIG. 25 is a view schematically showing a change of the position of the adsorption pad 608 when a plurality of adsorption pads 608 is used to adsorb a large-sized object to be adsorbed in order to lift the large-sized object. Undulations occur in the large-sized object to be adsorbed. FIG. 25A is a cross-sectional view showing the state of the vacuum adsorption head 600 before adsorption. FIG. 25A shows the state in which the adsorption pad 608 drops to the lowermost end due to the elasticity of the upper spring 605 as described above. In this state, the heights of all of the adsorption pads 608 of the vacuum adsorption heads 600 shown in FIG. 24 are aligned in the x direction and the tilts of the adsorption pads 608 are approximately aligned due to the spring within the vacuum adsorption device.

Next, all of the vacuum adsorption heads 600 approach the object to be adsorbed, which is mounted on the working table (not shown), and each of the adsorption pads 608 firmly sticks to the object to be adsorbed. When the descent amount of the vacuum adsorption head 600 is large, each of the adsorption pads 608 moves by a large amount in the −z direction as shown in FIG. 25B. Even in the case that there are large undulations on the object to be adsorbed or the surface of the object to be adsorbed is slightly tilted, the adsorption shaft 607 moves in accordance with the undulations so as to respond. Therefore, a desired adsorption force of each adsorption pad is held.

Next, a case, in which the object to be adsorbed is lifted from the working table and is transported to another place, is considered. When a large-sized object to be adsorbed is adsorbed and transported, there are some cases in which the object to be adsorbed bends due to its own weight on its way. In particular, when a large-sized object to be adsorbed is held mainly at the central portion thereof, the outer circumferential portion of the object to be adsorbed is likely to bend downward. In this case, the line normal to the surface of the object to be adsorbed in the outer circumferential portion is out of the z direction of the vacuum adsorption head 600.

When an adsorption pad 661 which does not have a neck-movement function is used as shown in FIG. 32, after the adsorption board 662 firmly sticks to the surface of the object to be adsorbed, the surface of a portion of the object to be adsorbed is tilted, the parallel relationship between the adsorption board 662 and the surface of the object to be adsorbed is destroyed. As a result, vacuum in the adsorption board 662 can not be held. However, when the vacuum adsorption head 600 according to the present embodiment is used, the adsorption board 622 arranged outside moves freely in accordance with the tilt of the surface of the object to be adsorbed since the adsorption board 662 moves in accordance with the tilt of the object to be adsorbed. Thus, the adsorption force of the adsorption board 662 can be held.

Before the vacuum adsorption head according to the present embodiment adsorbs the object to be adsorbed and after the vacuum adsorption head completes the adsorption and releases the object to be adsorbed, the state does not remain as does the adsorption pad in a conventional example, and the position of the adsorption pad is returned to a state in which the adsorption plane faces substantially downward due to the restoring force of the spring within the adsorption head. Therefore, when the vacuum adsorption head adsorbs the next object to be adsorbed, it does not cause any damage to the object to be adsorbed and does not fail to adsorb the object to be adsorbed.

In the case where the adsorption pad 608 shown in FIG. 23 is used, when the adsorption board 633 firmly sticks to the surface of the object to be adsorbed, the skirt section 632c does not contribute to the adsorption force. In this state, when the surface of a portion of the object to be adsorbed is tilted, the parallel relationship between the adsorption board 633 and the surface of the object to be adsorbed is broken. Therefore, the vacuum in the adsorption board 633 can not be held. However, in the case where the vacuum adsorption head 600 according to the present embodiment is used, even when the adsorption shaft 607 supported by the elastic supporting member and a portion of the surface of the object to be adsorbed are tilted, the vacuum adsorption head 600 can easily move in accordance with the tilt of the surface of the object to be adsorbed. Thus, the vacuum adsorption head 600 can firmly hold the object to be adsorbed. FIG. 25C shows this state. In other words, the adsorption board 633 itself moves in accordance with the bending of the object to be adsorbed so as to tilt. The allowable tilt angle of the adsorption shaft 607 is determined by the outer diameter of the adsorption shaft 607 and each inner diameter of the upper casing plate 603 and the lower casing plate 604. Since the tilting elasticity of the adsorption shaft 607 depends on the bending force or the eccentricity load of the upper spring 605 and the lower spring 606, the tilting elasticity of the adsorption shaft 607 becomes smaller when compared to the elongation force or compressive force in its axial direction. This means that the adsorption pad 608 can flexibly respond to the tilt of the adsorption plane of the adsorption pad 608. After the vacuum adsorption head 600 according the present embodiment completes the adsorption and releases the object to be adsorbed, the state does not remain as does the adsorption pad in a conventional example, and the position of the adsorption pad is returned to a state in which the adsorption plane faces substantially downward due to the restoring force of the spring within the adsorption head. Therefore, when the vacuum adsorption head adsorbs the next object to be adsorbed, it does not cause any damage to the object to be adsorbed and it does not fail to adsorb the object to be adsorbed.

In the vacuum adsorption head 600 according to the present embodiment, the adsorption shaft 607 thereof can move freely in its axial direction, is capable of neck-moving and can be returned to a state in which the position of the adsorption pad faces in a predetermined direction from a state in which the adsorption shaft 607 is neck-moving due to a spring force within the adsorption head. Thus, the adsorption pad 661 which is not appropriate for use of the conventional vacuum adsorption device can be used in accordance with the characteristics of the object to be adsorbed. In particular, the adsorption pad shown in FIG. 32 can be employed as appropriate.

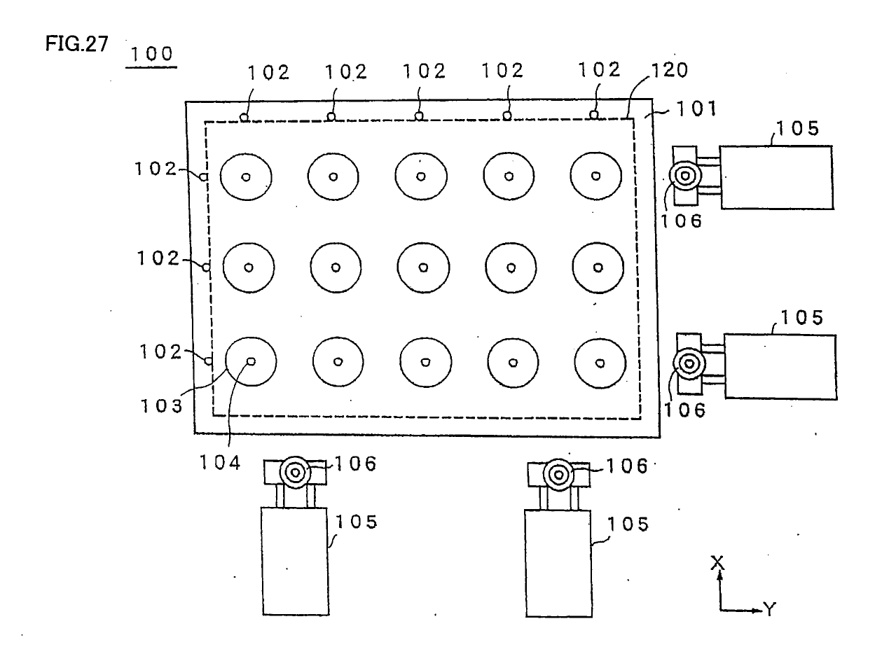

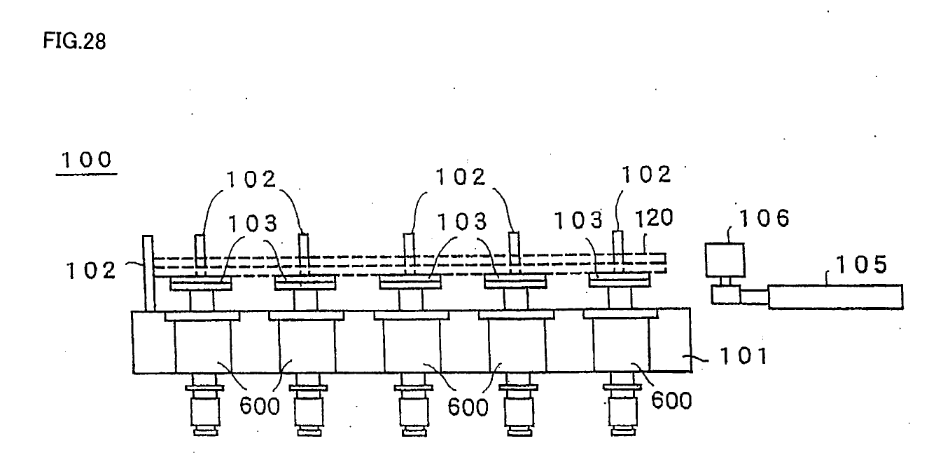

Next, a table for supporting the object to be adsorbed 100 will be described. The adsorption heads 600 according to the present invention are arranged in a grid on the table 100 with the adsorption heads 600 facing upward. Herein, as an example, a mother bonded substrate 120 is used as an object to be adsorbed. FIG. 27 is a front view of an example of the table 100. FIG. 28 is a side view thereof.

In the table 100, on a base plate 101 which is the base portion of the table 100, a plurality of vacuum adsorption heads 600 with respective adsorption boards facing upward are arranged in a grid with a predetermined interval. An adsorption pad 103 having a disc shape is attached to the adsorption section of the vacuum adsorption head. An exhaust hole 104 which penetrates in the upwards and down direction is provided in the center of the adsorption pad 103. However, there is no any concave or convex portion on the adsorption plane of the adsorption pad 103. The adsorption pad 103 is made of a resin material, and for example, a peak material which is an engineering plastic is used as the resin material. The exhaust hole 104 is connected to a pump (not shown) and can cause to compressed air to gush out and create a vacuum as appropriate.

Furthermore, a plurality of reference pins 102 and a plurality of pushers 105 are respectively provided. A plurality of reference pins 102 are aligned in a row with a predetermined interval in a vertical direction along the base plate 101 and along each one end face in the X and Y directions of the base plate 101. When the mother bonded substrate 120 mounted on the adsorption pads 103 are positioned, a plurality of pushers 105 causes the mother bonded substrate 120 to contact the references pins 102. A roller 106 which contacts the end face of the mother bonded substrate 120 is attached to the tip of the pusher 105 via a bearing. The reference pin 102 can include the roller 106.

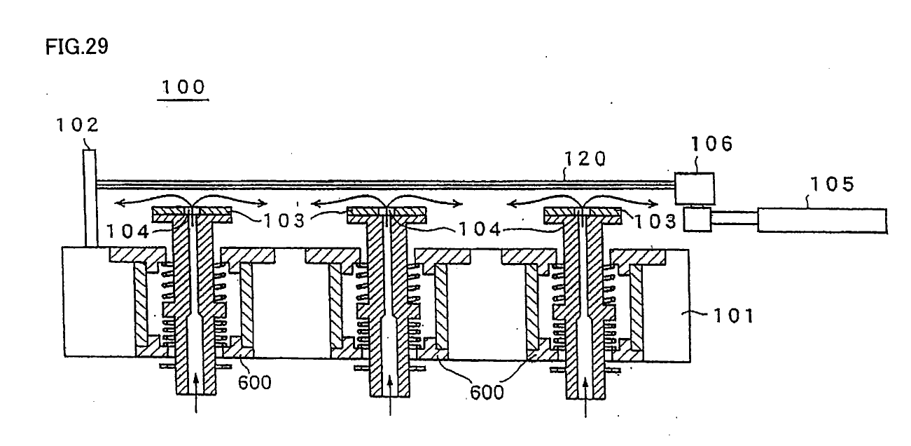

FIG. 29 is explanatory diagram for explaining the positioning operation using the table 100. When the mother bonded substrate 120 is mounted on the table 100 by the transportation robot, compressed air is caused to gush out of each exhaust hole 104 provided in the center of the adsorption pad 103. The substrate 120 floats due to the compressed air thus caused to gush. The floating mother bonded substrate 120 is placed in contact with the reference pins 102 in both X and Y directions by the pushers 105 so as to be positioned. When the mother bonded substrate 120 is positioned, the table 100 stops causing the compressed air to gush out, lowers the mother bonded substrate 120 and again mounts the mother bonded substrate 120 on the adsorption pads 103. When the mother bonded substrate 120 is mounted on the adsorption pads 103, the mother bonded substrate 120 is vacuum-adsorbed by vacuum pumps (not shown) through the exhaust holes 104 and is held by the adsorption pads 103 by adsorption. Once the mother bonded substrate 120 is held by the adsorption pads 103 by adsorption, the rollers 106 are returned to the original state.

The compressed air caused to gush out of the adsorption pad 103 during the positioning operation flows along the surface of the mother bonded substrate 120 as indicated by arrows in FIG. 29. At this time, since the adsorption pad 103 is a flat pad which does not have any concave or convex portion on its surface, the flow of the compressed air is stabilized and the occurrence of air turbulence is prevented. As a result, the mother bonded substrate 120 stably floats without vibrating.

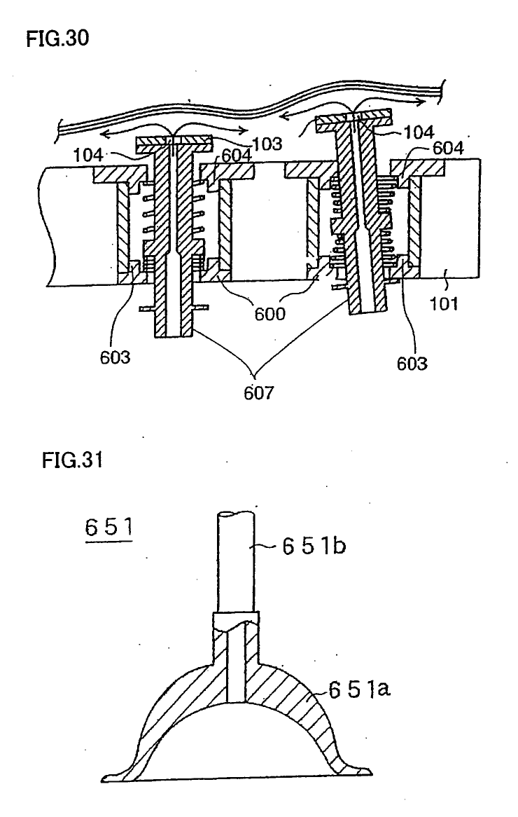

FIG. 30 is a view schematically showing a variation in which an object to be adsorbed is floated in the table according to the present embodiment. Conventionally, when a substrate is positioned, a gap is formed between the mother bonded substrate 120 and the table by causing compressed air to gush out. As a result, the mother bonded substrate 120 is floated. However, since the mother bonded substrate 120 is floated using the gushing air, there are cases in which bendings or undulations are created on the mother bonded substrate 120, the substrate on the lower surface side of the mother bonded substrate 120 partially contacts and rubs the table, and therefore, the surface of the substrate on the lower surface side is damaged. During the operation for positioning the mother bonded substrate 120, when the mother bonded substrate 120 contacts the table, a slight offset occurs. Thus, there is a problem that positioning (alignment) with a high accuracy can not be performed.

In the vacuum adsorption head 600 according to the present invention, the adsorption shaft is slightly movable in its axial direction and in a direction diagonal to the axial direction and is elastically supported. Thus, in the table 100 using the vacuum adsorption head 600, within the tilting allowable range of the adsorption shaft 607 which is determined by the outer diameter of the adsorption shaft 607 and each inner diameter of the upper casing plate 603 and the lower casing plate 604, due to the gushing of the compressed air (Bernoulli effect) as shown in FIG. 30, the adsorption pad 103 of the vacuum adsorption head 600 entirely moves in accordance with the bendings or undulations on the mother bonded substrate 120. Therefore, the table moves so as to maintain a constant interval, the interval being between the mother bonded substrate 120 and the adsorption pad 103. The compressed air caused to gush out of the exhaust hole 104 flows in layers to the outer circumferences of the adsorption pad 103. Therefore, the interval between the mother bonded substrate 120 and the adsorption pad 103 can be maintained constant. As a result, any damage to the back surface of the mother bonded substrate 120 can be prevented, and the mother bonded substrate 120 can remain stably floating.

Since the positioning is performed in a stable state described above, the mother bonded substrate 120 can be stably positioned with high accuracy without any offset. When the mother bonded substrate 120 thus positioned is mounted on the adsorption pads 103, the vacuum adsorption heads 600 move freely in accordance with the tilt of the surface of the mother bonded substrate 120 corresponding to the pressure difference which occurs due to the aforementioned Bernoulli's function and do not exert undesired force on the mother bonded substrate 120 mounted since the vacuum adsorption heads 600 follow freely. Even when the vacuum is created by the vacuum pumps thereafter, the mother bonded substrate 120 can be firmly held by to the adsorption pads 103 by adsorption.

In the table 100 using the vacuum adsorption heads according to the present embodiment, when the mother bonded substrate 120 is mounted on the table 100 before being positioned, and when the mother bonded substrate 120 is again mounted on the table 100 after being positioned, before the mother bonded substrate 120 is adsorbed and after the mother bonded substrate 120 is released after the completion of adsorption, the state does not remain tilted as the adsorption pad in a conventional example does, and the position of the adsorption pad is returned to a state in which the adsorption plane faces substantially upward due to the force of the spring within the adsorption head. Therefore, when the next mother bonded substrate 120 is mounted, it does not cause any damage to the mother bonded substrate 120 and it does not fail to adsorb the mother bonded substrate 120.

The table 100 only needs to include at least one vacuum adsorption head 600 depending on the size of a substrate. When a plurality of vacuum adsorption heads is provided, it is preferable to arrange them in a grid as shown in FIG. 27. A positioning device, in which a positioning means is provided, in addition to the table described above, is extremely effectively applied as a pre-alignment device before a substrate is transported in a step of manufacturing a flat panel display or a step of manufacturing a semiconductor element.

The adsorption head has been described in detail above.

(Detailed Description of Substrate-Adhered Material Removal Device)

Hereinafter, a substrate-adhered material removal device 700 (air knife 700) according to an embodiment of the present invention will be described with reference to the accompanying drawings.

The term “fluid” in the present invention includes gas (e.g., dried air, dried compressed air, nitrogen, helium and argon), water, treating liquid (e.g., washing liquid and etching liquid), processing liquid (e.g., grinding water, cutting water), mixed fluid of water and compressed air, mixed fluid of washing liquid and compressed air, and solvent.

FIG. 33 is a perspective view schematically showing an example of the substrate-adhered material removal device 700 according to the present invention. The substrate-adhered material removal device 700 dries the liquid adhered on top and bottom surfaces of a substrate as a step after a stem unit section 160 sprays steam onto both main surfaces of the substrate on which scribing lines are formed by the upper substrate cutting device 60 and the lower substrate cutting device 70 (see FIG. 1).

The term “substrate” in the present invention includes a single plate. The single plate includes a metal substrate (e.g., a steel plate), a wood plate, a plastic substrate, a print substrate, or a brittle material substrate (e.g., a ceramic substrate, a semiconductor substrate and a. glass substrate). However, the term “substrate” in the present invention is not limited to such a single plate. It also includes a liquid crystal display panel substrate, used for a flat panel display device, for which brittle material substrates are bonded to each other, and a mother substrate of the liquid crystal display panel substrate and the like.

The substrate-adhered material removal device 700 is mainly configured by a pair of air-knife units 710A and 710B, a pair of unit holding sections 712, 712 and an upper attachment base 708. The pair of unit holding sections 712, 712 supports the air-knives 710A and 710B, respectively. The upper attachment base 708 attaches the unit holding sections 712, 712. Furthermore, the substrate-adhered material removal device 700 is configured by a pair of air-knife units 710C and 710D, a pair of unit holding sections 712, 712 and a lower attachment base 709. The pair of unit holding sections 712, 712 supports the air-knives 710C and 710D, respectively. The lower attachment base 709 attaches the unit holding sections 712, 712.

The pair of unit holding sections 712, 712 supports an air knife body 715 such that a fluid lead-in path is formed between the air knife bodies and the main surfaces of the substrate in a substrate transportation path on which the air knife body 715 and the substrate are moved relative to each other, the fluid lead-in path having approximately a uniform shape in a direction perpendicular to a direction of relative movement.

The air knife units 710A and 710B are respectively arranged on the upper attachment base 708 through the pair of unit holding sections 712, 712 such that each longitudinal direction of the air knife units 710A and 710B are along the x direction. Fundamentally, the air knife unit 710B has a similar structure to the air knife unit 710A.

The air knife units 710C and 710D are respectively arranged on the lower attachment base 709 through the pair of unit holding sections 712, 712 such that each longitudinal direction of the all knife units 710C and 710D are along the x direction, respectively. Fundamentally, the air knife unit 710C and the air knife unit 710D have a similar structure to the air knife unit 710A.

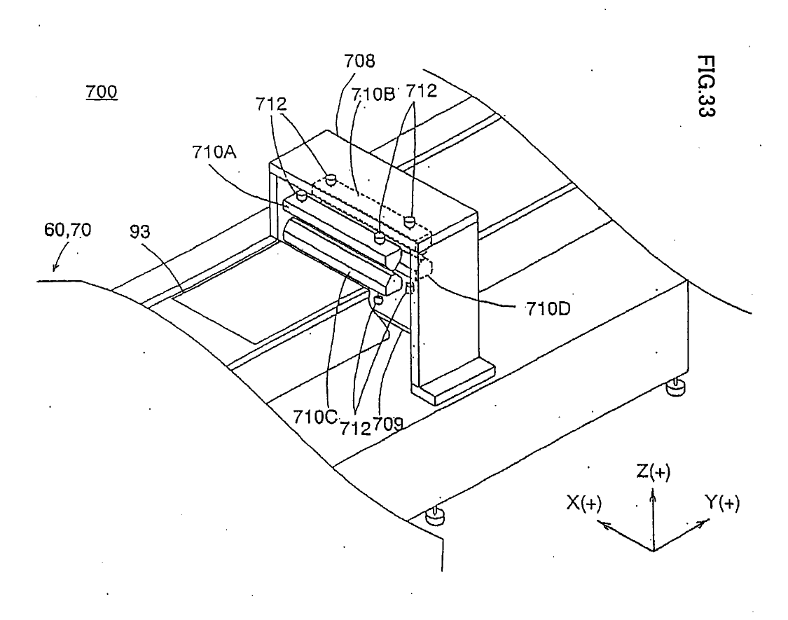

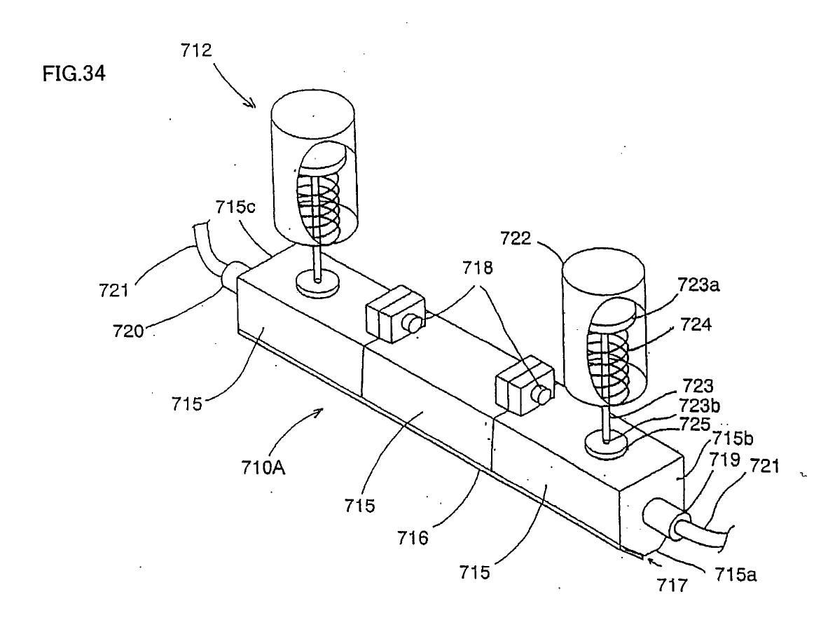

FIG. 34 is a perspective view schematically showing the air knife unit 710A and the unit holding section 712 for supporting the all knife unit 710A. The air knife unit 710A is configured by at least one air knife body 715. In FIG. 34, the air knife unit 710A is structured by three air knife bodies 715, for example, connected in a row by bolts 718.

For example, a cover 716 is attached to a side 715a, and a fluid gushing slit 717, capable of discharging pressurized dried air, is formed on the side 715a, such that the compressed air gushes out of the air knife unit 710A along the tilted surface of 715a. Couplings 719 and 720 are respectively attached to both side surfaces 715b and 715c of the air knife unit 710A. A tube 721 is connected to the couplings 719 and 720, respectively. Furthermore, Compressed air is supplied to the inside of the air knife unit 710A from the inside of the tube 721 through a compressed air supply source (not shown).

The pair of unit holding sections 712, 712 supporting the air knife unit 710A includes, for example, a rod 723, the rod 723 having a sliding section 723a sliding inside a casing 722. The pair of unit holding sections 712, 712 has a structure in which the rod 723 is inserted through compressive spring 724 which is inserted between the sliding section 723a and the surface of the casing of the tip 723b side. An attachment member 725 which is attached to the tip of the rod 723 is attached to the top surface of the air knife body 715 using a bolt and the like. The upper surface of the casing 722 opposite to the side of the tip 723b of the rode 723 of the unit holding section 712 is attached to the upper attachment base 708 such that the air knife unit 710A is along the x direction.

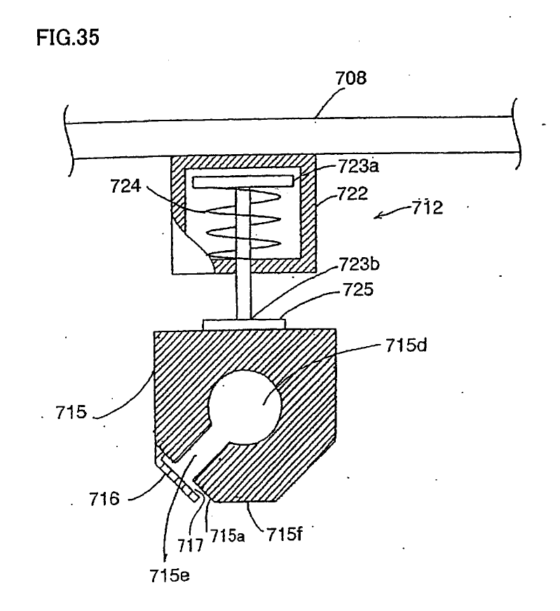

FIG. 35 is a cross-sectional view for explaining the structure of air knives which constitutes the air knife units 710A to 710D. A penetration hole 715d which penetrates in the longitudinal direction of the air knife body 715 is provided in the air knife body 715. A long hole 715e connecting the penetration hole 715d is provided on the surface 715a of the air knife body 715. An L-shaped cover 716 is provided on the surface 715a of the air knife body 715. A fluid gushing slit 717 is formed between the cover 716 and the air knife body 715. Compressed fluid, which is supplied to the penetration hole 715d of the air knife from the couplings 719 and 720 (FIG. 2) provided on the air knife unit 710A, flows through the long hole 715e, flows along the surface 715a of the air knife body 715 and gushes out of the fluid gushing slit 717. In FIG. 34, the gushing direction of fluid from the air knife unit 710A is in the +Y direction. On the other hand, the gushing direction of fluid from the air knife unit 710B is in the −Y direction. The gushing direction of fluid from the air knife unit 710C is in the +Y direction. On the other hand, the gushing direction of fluid from the air knife unit 710D is in the −Y direction.

The air knife unit 710A includes a clearance automatic adjustment means for adjusting the clearance between the air knife body 715 and the main surface of the substrate 93. The clearance automatic adjustment means includes a laminar flow forming face 715f and the unit holding sections 712, 712 as shown in FIG. 35. The laminar flow forming face 715f is formed on the lower portion (bottom surface) of the air knife body 715 and passes the liquid in laminar flow between the laminar flow forming face 715f and the main surface of the substrate. The unit holding sections 712, 712 support the air knife body 715 such that the air knife body 715 is movable in an oscillating manner.

The clearance automatic adjustment means, which is configured by the unit holding sections 712, 712, will be described. The clearance automatic adjustment means adjusts the clearance between the air knife body 715 and the main surface of the substrate 90 by making use of the Venturi effect which occurs when dry gas passes through the fluid lead-in path.

Since the pressurized fluid discharged from the fluid gushing slit 717 passes through the fluid lead-in path in a compressed laminar flow, the fluid lead-in path being formed between the laminar flow forming face 715f (bottom surface of the air knife body 715) and the top surface of the substrate 93, negative pressure is created on the top surface of the substrate 93 (Bernoulli effect). The compressive spring of the unit holding sections 712, 712 for holding the air knife unit 710A upward (holding force) and the negative pressure for attracting the laminar flow forming face 715f of the air knife body 715 of the air knife unit 710A (suction force) are balanced. As a result, uniform clearance in the longitudinal direction of the air knife unit 710A is created between the air knife unit 710A and the substrate 93.

Referring to the aforementioned clearance, at least one of the flow amount is discharged from the flow gushing slit 717, the pressurizing force which compresses the fluid and the flow speed when the fluid passes by the laminar flow forming face 715f is changed, so that the interval of the clearance is adjusted. Thus, the bending and the like of the substrate is adsorbed and the clearance can be stably maintained (above, function of claim 27).

Furthermore, when the laminar flow is passed through the fluid lead-in path formed between the laminar flow forming face 715f and the main surface (top surface and/or bottom surface) of the substrate, negative pressure is created in the vicinity of the main surface of the substrate (Bernoulli effect), and the holding force of the unit holding section which is used to hold the air knife unit 710A upward and the suction force (negative pressure) for attracting the air knife body 715 of the air knife unit 710A are balanced. As a result, a fluid lead-in path having approximately an uniform shape can be easily formed between the air knife body 715 and the main surface of the substrate in a direction perpendicular to the moving direction of the substrate 90 (above, function of claim 28).

The operation and the working function of the substrate-adhered material removal device 700 having such a structure will be described.

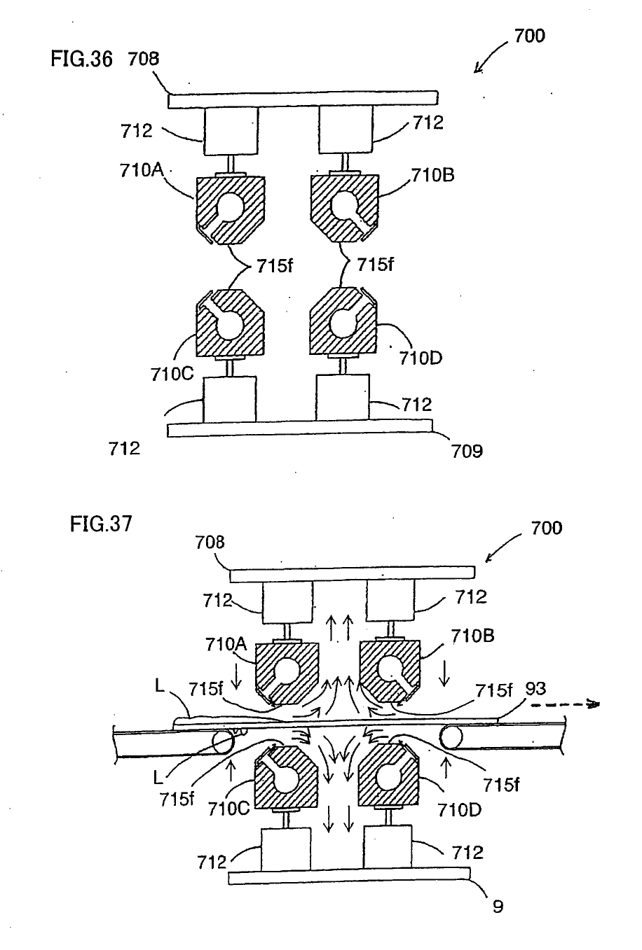

As shown in FIG. 33, the substrate 93 removed from the upper substrate cutting device 60 and the lower substrate cutting device 70 is mounted on an upstream conveyor and is transported to the substrate-adhered material removal device 700. FIG. 36 is a diagram for explaining the state of air knife unit before the substrate 93 is transported to the substrate-adhered material device 700. Before the substrate is transported, each air knife unit 710A to 710D is in a waiting state, with a distance of several millimeters from the transportation surface of the substrate 93 (bottom surface of the substrate 93).

FIG. 37 is a view for explaining the state of air knife unit when liquid adhered to top and bottom surfaces of the substrate 93 is being removed. When the substrate 93 is transported to the substrate-adhered material removal device 700 by the upstream conveyor in the direction indicated by the arrow in the figure, dried compressed air is supplied to the air knife units 710A to 710D. At the time when the substrate 93 passes by each laminar flow forming face 715f of each air knife body 715 of the air knife units 710A and 710C, dried compressed air is flowed through the fluid lead-in path between the substrate 93 and each laminar flow forming face 715f of the air knife units 710A and 710C, and therefore, negative pressure is created in the vicinity of both sides of the substrate 93 due to the Venturi effect. As a result, the air knife units 710A and 710C move close to or away from a position where the clearance of approximately 20 pm to 100 pm is maintained from top and bottom surfaces of the substrate 93. Wall surfaces (air wall) are formed between the air knife unit 710A and the air knife unit 710B and between the air knife unit 710C and the air knife unit 710D, the wall surfaces being formed by air discharged from each fluid gushing slit 717 of the respective air knife units 710A to 710D. The dried compressed air discharged from each of air knife units 710A and 710B is blocked by the wall surface. The dried compressed air flows along the fluid lead-in path so as to move away from the top and bottom surfaces of the substrate 93, the fluid lead-in path being formed between each of the air knife units 710A and 710C and the corresponding air wall surface. Furthermore, the dried compressed air discharged from the air knife units 710A and 710C passes through a fluid lead-in path between the substrate 93 and each laminar flow forming face 715f of each air knife body 715 of the respective air knife units 710A and 710C, the cross-sectional area of the fluid lead-in path being extremely small of the dried compressed air is caused to gush and diffused from the fluid lead-in path, whose cross-sectional area is small, into a fluid lead-out path, whose cross-sectional area is large, with a great force. Thus, the compressed air causes liquid L adhered to both sides of the substrate 90 to become misty, mixes the liquid L adhered to the top and bottom surfaces of the substrate 93 and then, flows upward or downward so as to move away, along the fluid lead-out path, from top and bottom surfaces of the substrate 93. Furthermore, when the dried compressed air caused to gush out of the narrow fluid lead-in path to the wide fluid lead-in path with a great force, then the flow speed of the compressed air containing the mist rises in one shot and the dried compressed air flows so as to move away from top and bottom surfaces of the substrate 90, thereby preventing the mist being again adhered to the top and bottom surfaces of the substrate 93.

Furthermore, when an air suction hole section (not shown) is provided in the vicinity of the substrate 93, the compressed air containing the mist flows from the substrate 93 to the suction hole section. Thus, there is no possibility that the blown mist is again adhered to the substrate 93.

Drying the substrate 93 using the substrate-adhered material removal device 700 according to the present invention is not like a conventional device which sweeps liquid to the rearward of the substrate by using an air knife. In order to dry the surface of the substrate 93, at least one pair of air knife units are arranged in the moving direction of the substrate. Dried compressed air discharged from one of the pair of air knife units which is provided facing the opposite direction with respect to the moving direction of the substrate 93 acts to push out the liquid L adhered to the substrate forward in the moving direction of the substrate 93 and to cause the liquid L to become misty. Furthermore, dried air discharged from the other of the pair of air knife units which is provided forward with respect to the moving direction of the substrate 93 causes the air (moisture) on the substrate to become misty, the air (moisture) being left behind by the dried compressed air discharged from the one of the pair of air knife units, and completely dries the substrate 93. At the same time, the dried air discharged from the other of the pair of air knife units joins the dried compressed air discharged from the one of the pair knife units at the fluid lead-in path and acts to help the fluid to rise along the fluid lead-out path with great force so as to move away from the surface of the substrates 93.

In the present embodiment, dried compressed fluid flows through the fluid lead-in path formed between the substrate 93 and each laminar flowing forming surface 715f of the respective air knife units 710A to 710D. The fluid is compressed at the narrow fluid lead-in path and thereafter, the fluid is diffused at the wide fluid lead-out path. Therefore, the material adhered to top and bottom surfaces of the substrate 93 does not condense and is mixed into the fluid so as to reduce the size of the material (fineness), whereby the material adhered to the substrate 93 is easily removed from the top and bottom surfaces of the substrate 93.

The wall surface formed by one of the air knife units 710A to 710D and/or the fluid is arranged on a position facing the one of air knife units 710A to 710D such that the cross-sectional area of the fluid lead-out path formed between the wall surface and one of the air knife units 710A to 710D is larger than the cross-sectional area of the fluid lead-in path. Thus, the pressurized fluid gushes out from the narrow fluid lead-in path to the wide fluid lead-out path with a great force. Therefore, the flow speed of the fluid increase in one shot. As a result, the effect, in which the capability of removing the adhered material from the top and bottom surfaces of the substrate 93 is further increased, is obtained (above, function of claim 26).

At least one pair of air knife units are arranged facing each side where each fluid gushing slit 717 of the respective air knife units are formed. Thus, the fluid steadily flows so as to move away from bottom and top surfaces of the substrate 93 along the fluid lead-out path. As a result, the effect, in which the removal of the material adhered to the top and bottom surfaces of the substrate 93, is facilitated.

Since at least one air knife is arranged on each of the top and bottom surfaces of the substrate 93, an effect that the material adhered to the top and bottom surfaces of the substrate 93 can be removed is obtained.

The unit holding sections 712 which support the air knife units 710A to 710D include clearance automatic adjustment means which adjusts the clearance between the air knife units 710A to 710D and the corresponding top and bottom surfaces of the substrate 93 using the Venturi effect which occurs when the fluid passes through the fluid lead-in path. Thus, an effect that the clearance can be adjusted in accordance with the material-to-be removed adhered to the top and bottom surfaces of the substrate 93 is obtained.

The clearance automatic adjustment means includes unit holding sections (elastic bodies) 712 and laminar flow forming faces 715f, the supporting sections 712 supporting the air knife units 710A to 710D such that the air knife units 710A to 710D can oscillate between the supporting sections 712 and the respective top and bottom surfaces, and the laminar flow forming faces 715f facing the respective top and bottom surfaces of the substrate 93, forming portions of the fluid lead-in path on one side surface of the respective air knife main bodies 715 of the respective air knife units 710A to 710D and passing the fluid in laminar flow between the laminar flow forming faces 715f and the respective top and bottom surfaces of the substrate 93. Thus, the laminar flow passes through the fluid lead-in pass which is formed on the laminar flow forming faces 715f and the respective top and bottom surfaces of the substrate 93. As a result, negative pressure is created in the vicinity of the top and bottom surfaces of the substrate 93. The compressive spring of the Unit holding sections (elastic bodies) 712 for holding the air knife units 710A to 710D upward (holding force) and the negative pressure for attracting the air knife body (suction force) are balanced. Thus, the interval of the fluid lead-in path between the air knife units 710A to 710D and the respective top and bottom surfaces of the substrate 93 becomes narrower. The laminar flow which passes the fluid lead-in path is caused to gush out of the narrow path to a wide path with a great force, and therefore, the speed of fluid increases in one shot. As a result, the effect that the capability which removes the material adhered to the top and bottom surfaces of the substrate 90 is further increased is obtained.

As described above, the flow of dry gas is formed in the fluid lead-in path, the dry gas being uniformly compressed in a direction perpendicular to the moving direction of the substrate. The fluid material adhered to top and bottom surfaces of the substrate 90 is mixed with the dry gas in the fluid lead-in path and is guided to the fluid lead-out path whose sectional area is larger than that of the fluid lead-in path. The dry gas diffused in the fluid lead-out path forms the flow which accompanies the fluid adhered material in misty state and moves away from top and bottom surfaces of the substrate along the wall surfaces. Thus, the dry gas is compressed in the fluid lead-in path, and thereafter, the dry gas is diffused in the fluid lead-out path. Therefore, the material adhered to the top and bottom surfaces of the substrate 90 does not condense and is mixed into the fluid so as to reduce the size of the material (misty, fineness), whereby the material adhered to the substrate is removed. As a result, both sides of the substrate 90 can be completely dried (above, function of claim 25).

Since a pair of air knife bodies 715 is arranged facing each side where the fluid gushing slit 717 is formed, the dry gas steadily flows along the fluid lead-out path so as to move away from the main surface of the substrate 90, thereby facilitating the drying of the substrate (above, function of claims 29 and 30).

Hereinafter, other embodiments of the clearance adjustment means will be described.

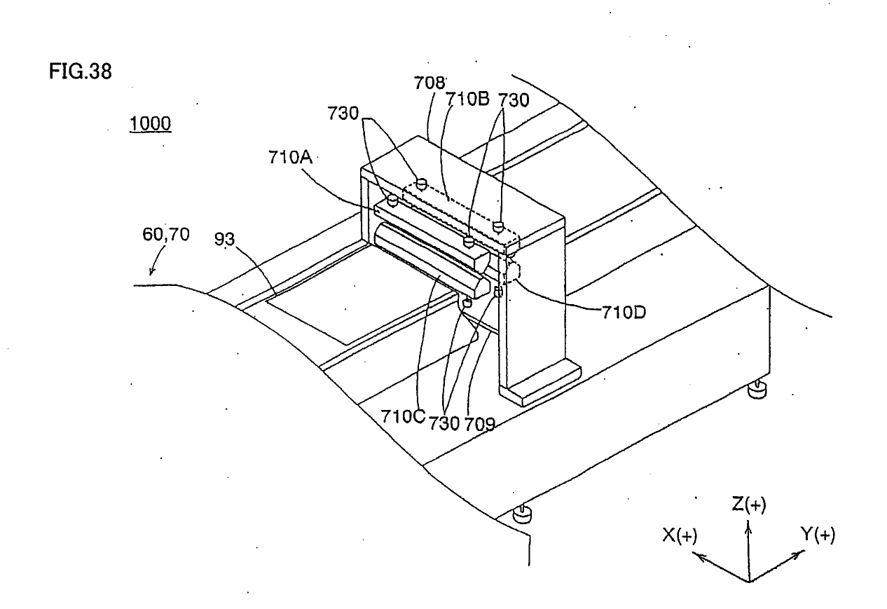

FIG. 38 is a perspective view schematically showing a substrate-adhered material removal device 1000 according to an embodiment of the present invention. The substrate-adhered material removal device 1000 has the same structure as the substrate-adhered material removal device 700 except that unit holding sections 730 are used in the substrate-adhered material removal device 1000, instead of the unit holding sections 712. Thus, the explanation of each member in the substrate-adhered material removal device 1000 will be omitted by denoting the same reference numerals as in the substrate-adhered material removal device 700.

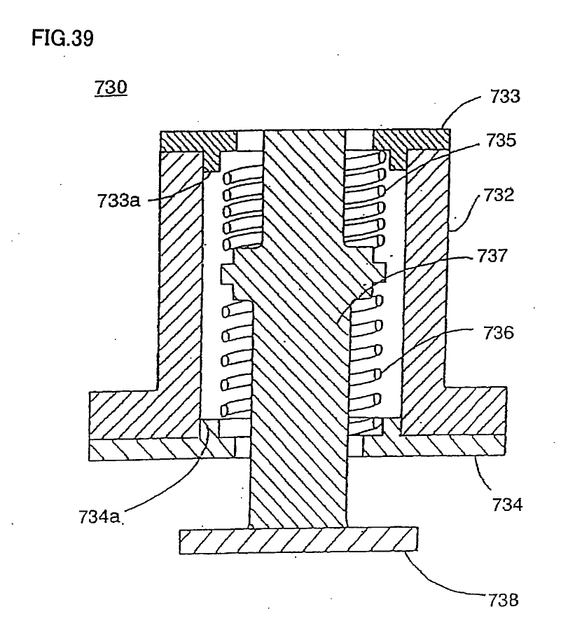

FIG. 39 is a cross-sectional view schematically showing the structure of the unit holding section 730. The unit holding section 730 will be described with reference to FIG. 39. The casing 732 is a cylindrical member with a flange 732a integrally formed at the lower portion of the casing 732 and has a clearance in which the upper spring 735 and the lower spring 736 can freely deform inside the casing 732. The flange section 732a has a thickness such that a screw hole for fixing can be provided. The upper casing plate 733 has a first opening in the middle thereof. When the upper casing plate 733 holds the suction shaft 737 via the upper spring 735 and the lower spring 736 such that the shaft 737 can freely move in the upwards and downwards directions, the upper casing plate 733 fixes the upper portion of the upper spring 735. The upper casing plate 733 is fixed to the upper end surface of the casing 732 by a screw. A protrusion 733a in a ring shape is provided inside the upper casing plate 733. The lower casing plate 734 is configured by a circular plate. The lower casing plate 734 has a second opening in the center thereof. A protrusion 734a in a ring shape is provided inside the lower casing plate 734. The protrusion 733a controls the upper end position of the upper spring 735 so that the upper end position of the upper spring 735 is in the same axis as the upper casing spring plate 733. The protrusion 734a controls the lower end position of the lower spring 736 so that the lower end position of the lower spring 736 is in the same axis as the lower casing spring plate 734. The shaft 737 contacts the inside of the first opening and the second opening, the inside being provided in the center of the upper casing plate 733 and in the center of the lower casing plate 734, respectively, so that the tilt of the shaft 737 is controlled.

The flange in the center of the shaft 737 acts to press the upper spring 735 and the lower spring 736, respectively.

An attachment metal fitting 738 is attached to the tip of the lower spring 736 side of the shaft 737 and is joined with one of the air knife units 710A to 710D using a bolt or the like. The upper casing plate 733 is joined with the upper attachment base 708 or the lower attachment base 709 using a bolt or the like.

By employing the unit holding section 730, as shown in FIG. 39, in the substrate-adhered material removal device 1000 according to the present invention, in the case where the substrate-adhered material removal device 1000 is used for processing the substrate 93, even when a tilt in the upwards and downwards directions (Z direction) along approximately the X direction occurs on the substrate 93 due to a condition of mounting an upstream conveyor or a down stream conveyor, the interval between each of the laminar flow forming face 715f of the air knife units 710A to 710D and the respective corresponding top or bottom surfaces of the substrate can be maintained at about 20 μm and 100 μm.

Hereinafter, other embodiments of the air knife unit will be described.

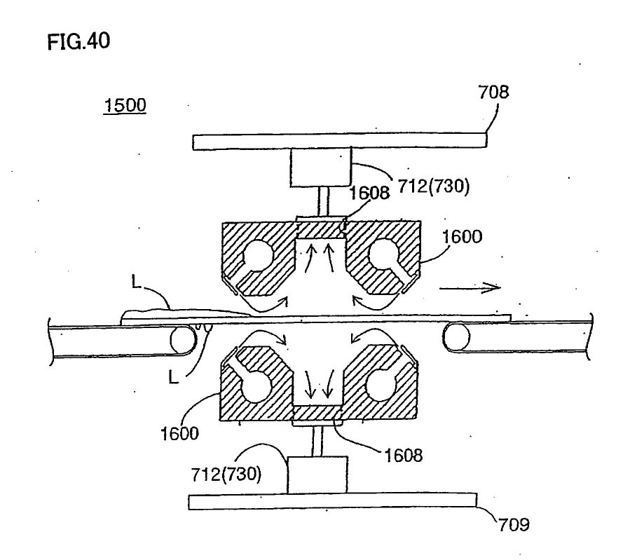

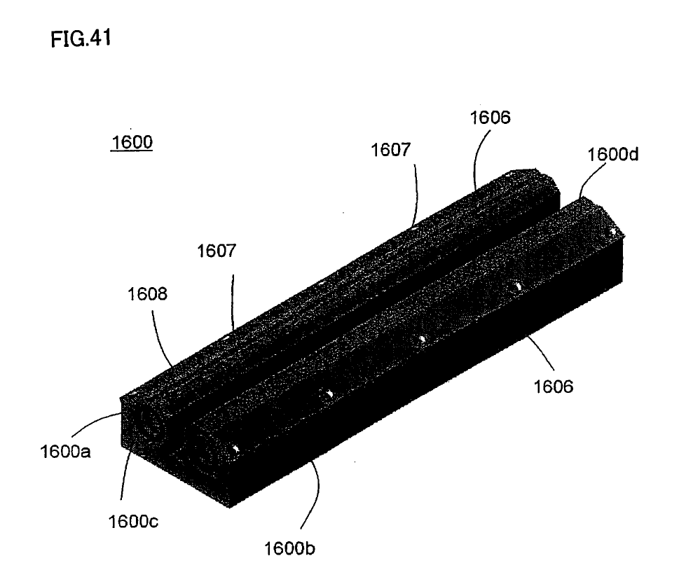

FIG. 40 is a cross-sectional view schematically showing a substrate-adhered material removal device 1500 according to an embodiment of the present invention. FIG. 41 is an external perspective view showing a connection air knife unit 1600 which is provided in the substrate-adhered material removal device 1500 according to an embodiment of the present invention. The connection air knife unit 1600 is held by the aforementioned pair of unit holding sections 712 and 712 or a pair of unit holding sections 730 and 730. The connection air knife unit 1600 is coupled to the upper attachment base 708 or the lower attachment base 709 using a bolt and the like such so as to be along the X direction which is perpendicular to the moving direction (+Y direction) of the substrate 93.

As shown in FIG. 41, the connection air knife unit 1600 includes a plurality of hole sections 1608 (broken line portion of FIG. 40) for fluid opening and integrally formed such that the air knife sections 1600a and 1660b face the corresponding fluid gushing slits 1607. The air knife sections 1600a and 1600b are similar to the air knife body 715 (see FIG. 35). Referring to FIGS. 35 and 41, penetration holes 715d are provided penetrating in a longitudinal direction of the air knife sections 1600a and 1600b. Long holes 715e, which are connected with the penetration holes 715d, are provided on surfaces 1600c and 1600d of the corresponding air knife sections 1600a and 1600b. L-shaped covers 1606 are provided on the surfaces 1600c and 1600d of the corresponding air knife sections 1600a and 1600b of the connection air knife unit 1600. The compressed fluid, which is supplied to the penetration holes 715d of the air knife sections 1600a and 1600b from connectors (not shown) provided on the connection air knife unit 1600, passes through the long holes 715e and flows along each surface 1600c and 1600d of the corresponding air knife sections 1600a and 1600b of the connection air knife unit 1600, and gush out of the corresponding fluid gushing slits 1607.

As described above, in the substrate-adhered material removal device 1500 using the connection air knife unit 1600 shown in FIG. 40 according to the present invention, since the number of the members which constitutes the substrate processing section is reduced, the time for assembling the substrate-adhered material removal device 1500 can be reduced.

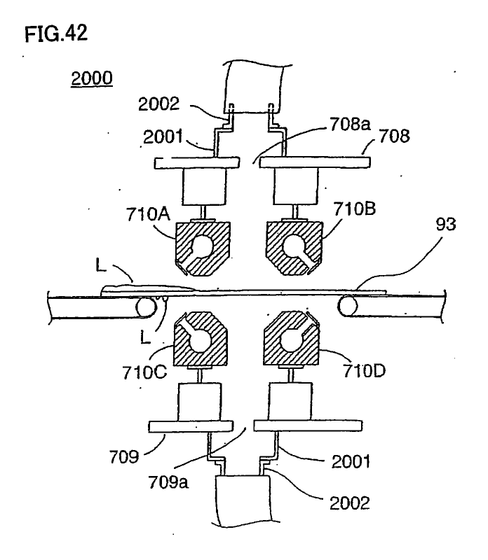

Hereinafter, an example is illustrated, in which a supplemental means for supplementing the fluid of the fluid lead-out path, which is lead-out from the main surfaces of the substrate, is attached. FIG. 42 is a view schematically showing the structure of a substrate-adhered material removal device 2000 according to an embodiment of the present invention. The substrate-adhered material removal device 2000 includes exhaust openings 708a and 709a with long holes. The exhaust openings 708a and 709a are respectively provided on the upper attachment base 708 and the lower attachment base 709 in the substrate-adhered material removal device 700, the substrate-adhered material removal device 1000 and the substrate-adhered material removal device 1500 having been described with reference to FIGS. 33, 38 and 40. Suction covers 2001 are provided to cover the exhaust openings 708a and 708b. Flanges 2002 are provided for connecting tubes to the suction covers 2001, whereby the connecting tubes are connected to exhaust ducts (suction means) which are suctioned by suction motors (not shown).

In the substrate-adhered material removal device 2000, the compressed air containing the mist can be effectively discharged out of the substrate-adhered material removal device 2000, the compressed air flowing upstream or downstream from the top and bottom surfaces of the substrate with a great force along the fluid lead-out path formed between the air knife units (air knife sections).

When the exhaust ducts suctioned by the suction motors or the like are connected to the fluid lead-in path, the fluid in the fluid lead-out path that is led out from the top and bottom surfaces of the substrate 93 is forceably supplemented. Thereby, the adhered material removed from the top and bottom surfaces of the substrate 93 is prevented from adhering again.

The shape of the air knife is hexagonal for the sake of convenience such that the compressed fluid is more likely to rise or fall along the shape of the air knife. However, the shape of the air knife unit is not limited to a hexagon, but can be any shape as long as the compressed air is likely to rise and the air knife unit has a face 715f which is parallel to the substrate.

When a plurality of air knife units is arranged in the transportation path of the substrate 93, with the side opposite to the side where the fluid gushing slit 717 of the air knife body 715 is formed being used as a wall face, the removal of the material adhered to the surfaces of the substrate is performed several times. Thus, the material adhered to the surfaces of the material can be almost completely removed.

Furthermore, the liquid that is discharged from the liquid gushing slit of at least one air knife unit of the plurality of the air knife units is cleaning liquid, and the liquid that is discharged from the liquid gushing slit of at least one air knife unit of the plurality of the air knife units is compressed gas. Thus, after the surfaces of the substrate are cleaned with the cleaning liquid for the substrate, the surfaces of the cleaned substrate can be dried.

The substrate processing apparatus and the substrate processing method can be applied to a panel substrate, such as a PDP (plasma display used for an FPD (flat panel display)), a liquid crystal display panel, a reflective projector panel, a transmissive projector panel, an organic EL device panel, an FED (field emission display) and the like, as a bonded mother substrate for which brittle material substrates are bonded to each other and a mother substrate of the panel substrate.

The aforementioned embodiment shows a structure in which air knife units are arranged above and/or below the main surface of the substrate with respect to the substrate whose main surface extends in a horizontal direction. However, the structure is not limited to such an embodiment. For example, the structure can be one in which air knife units are arranged on the one side and/or the other side (i.e., left side and/or right side) of the main surface of the substrate with respect to the substrate whose main surface extends in a perpendicular direction.

According to the substrate-adhered material removal device of the present invention, fluid flows through a fluid lead-in path formed between the substrate and each laminar flowing forming surface of the respective air knife units. The fluid is compressed at the narrow fluid lead-in path and thereafter, the fluid is diffused at the wide fluid lead-in path. Therefore, the material adhered to main surfaces of the substrate does not condense and is mixed into the fluid so as to reduce the size of the material (fineness), whereby the material adhered to the substrate is easily removed from the main surfaces of the substrate.

The substrate-adhered material removal device has been described in detail above.

The substrate cutting system 1 according to Embodiment 1 of the present invention has been described with reference to FIG. 1 to FIG. 42.

### Embodiment 2

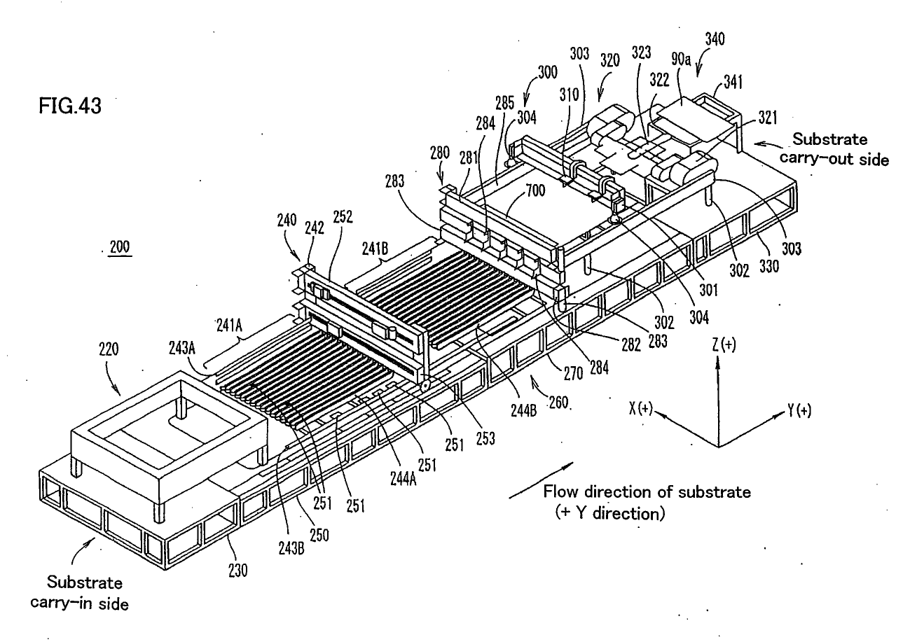

A substrate cutting system 200 according to Embodiment 2 of the present invention will be described with reference to FIG. 43 to FIG. 55.

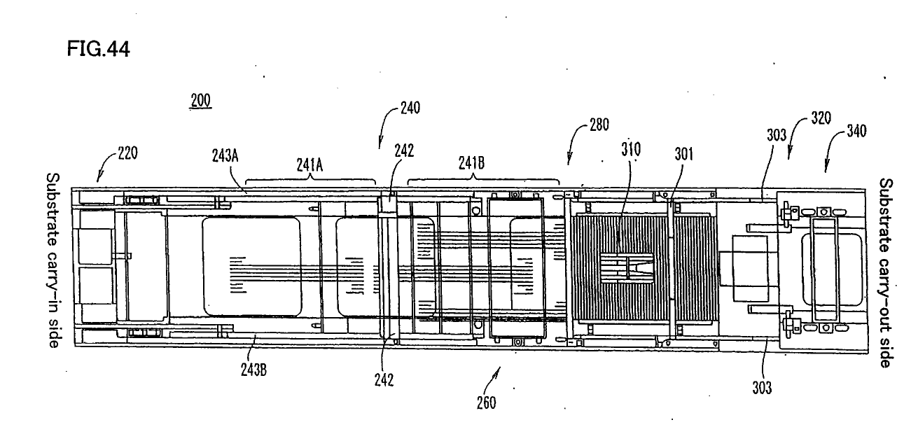

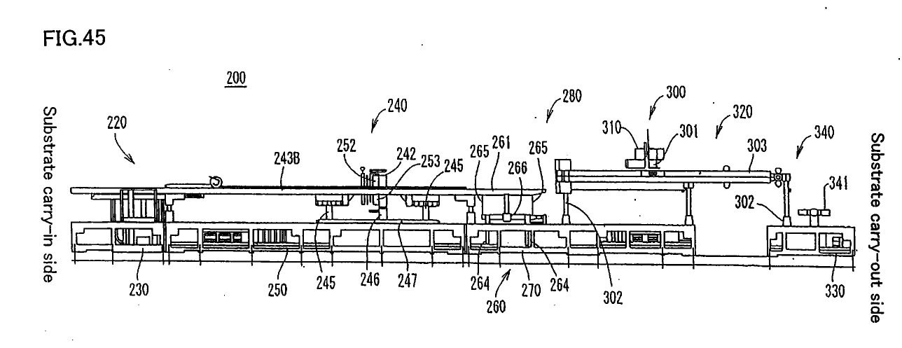

FIG. 43 is a perspective view schematically showing the entire substrate cutting system 200 according to Embodiment 2 of the present invention. FIG. 44 is a plan view of the substrate cutting system 200. FIG. 45 is a side view of the substrate cutting system 200. In the present invention, the term “substrate” includes a single plate, such as a mother substrate cut into a plurality of substrates, a metal substrate (e.g., a steel plate), a wood plate, a plastic plate and a brittle material substrate (e.g., a ceramic substrate, a semiconductor substrate and a glass substrate). However, the substrate according to the present invention is not limited to such a single plate. Furthermore, the substrate according to the present invention includes a bonded substrate for which a pair of substrates is bonded to each other and a stacked substrate for which a pair of substrates is stacked on each other.

In the substrate cutting system in the present invention, for example, when a panel substrate (bonded substrate for display panel) for a liquid crystal device is manufactured from a pair of glass substrates bonded to each other, a plurality of panel substrates (bonded substrate for display panel) are cut, by the substrate cutting system according to the present invention, from the bonded mother substrate 90 for which a pair of mother glass substrates is bonded to each other.

The substrate cutting system 200 according to Embodiment 2 includes a positioning section 220, a scribing unit section 240, a lift conveyor section 260, a steam break unit section 280, a substrate transportation unit section 300, a panel inversion unit section 320 and a panel terminal separation section 340.

In a substrate cutting system 200 according to Embodiment 2 of the present invention, description will be made by referring to the side where a positioning unit section 220 is arranged as a “substrate carry-in side” and to the side where a panel terminal separation section 340 is arranged as a “substrate carry-out side”, respectively. In the substrate cutting system 200 according to the present invention, the direction in which a substrate is transported (flow direction of the substrate) is +Y direction from the substrate carry-in side to the substrate carry-out side. The direction in which the substrate is transported is a direction perpendicular to a scribing device guide body 242 of the scribing unit section 240 in a horizontal state. The scribing device body guide 242 is provided along the X direction.

A case in which a bonded mother substrate 90 used as a substrate is cut will be described as an example. The bonded mother substrate 90 is carried in the positioning section 220 by a transportation device (not shown), which is used for the previous step. Thereafter, the positioning unit section 220 mounts the bonded mother substrate 90 on a first substrate supporting section 241A of the scribing unit section 240 and positions the bonded mother substrate 90 on the first substrate supporting section 241A. The substrate cutting system 200 includes the positioning unit section 220, so that the substrate cutting system 200 can accurately form scribing lines along lines to be scribed on the top and bottom surfaces of the substrate (above, function of claim 39).

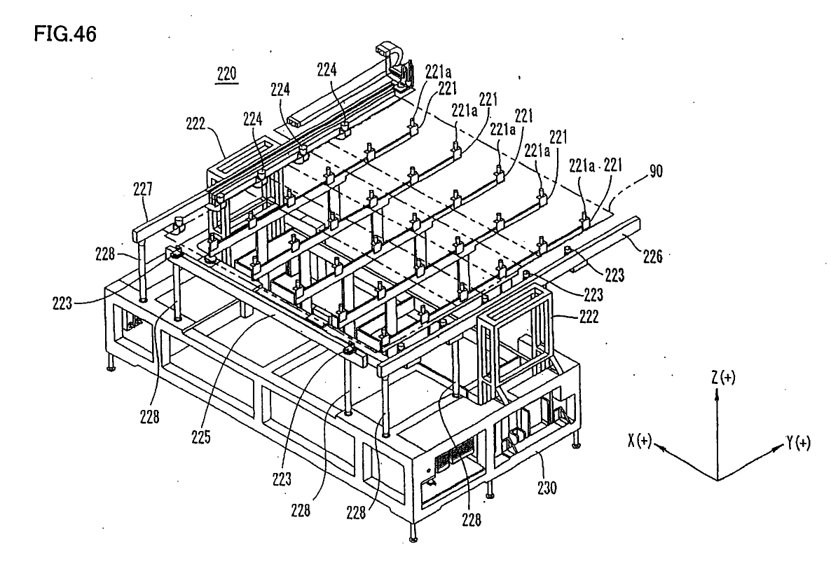

As shown in FIG. 46, the positioning unit section 220 includes a guide bar 226 and a guide bar 227 above a mounting base 230. The guide bar 226 extends along one side edge of the mounting base 230 along a Y direction via a pillar 228. The guide bar 227 extends along one side edge of the mounting base 230 in parallel to the guide bar 226. The positioning unit section 220 includes a guide bar 225 above the mounting base 230 between the guide bar 226 and the guide bar 227 on the substrate carry-in side of the mounting base 230. The guide bar 225 extends along an X direction via the pillar 228.

A plurality of reference rollers 223 are provided on the guide bar 225 and the guide bar 226, respectively, the plurality of reference rollers 223 are used as a reference when the bonded mother substrate 90 is positioned. The guide bar 227 includes a plurality of pushers 224. The plurality of pushers 224 push the bonded mother substrate 90 toward the reference rollers 223 provided on the guide bar 226 when the bonded mother substrate 90 is positioned.

A plurality of suction pad bases 221 is provided, above the mounting base 230, between the guide bar 226 and the guide bar 227 with a predetermined interval. The suction pad bases 221 are held by an up-and-down moving device 222 provided on the upper surface of the guide bar 226 side of the mounting base 230 and an up-and-down moving device 222 provided on the upper surface of the guide bar 227 side of the mounting base 230.

The suction pad bases 221 each includes a plurality of suction pads 221a. The plurality of suction pads 221a receives the bonded mother substrate 90 from the transportation device (not shown) used for the previous step. The bonded mother substrate 90 is suctioned and adsorbed by a suction device (not shown).

In the plurality of suction pad bases 221 of the positioning unit section 220, for example, the plurality of suction pads 221a can be attached to a plurality of vacuum adsorption heads 600, the vacuum adsorption heads 600 being described with reference to FIGS. 20 to 32. In this case, the plurality of vacuum adsorption heads 600 firmly can receive the substrate 90 from the previous step and stably lift the substrate 90 so as to position the substrate 90 (above, function of claim 40).

For example, the vacuum adsorption head each includes an adsorption pad for holding the substrate 90 by suction and lifting the substrate 90 by causing compressed air to gush. The vacuum adsorption heads position the substrate 90 between each of the plurality of respective adsorption pads and the substrate 90 while a laminar flow is formed. In this case, the compressed air is caused to gush out from the respective adsorption pads of the vacuum adsorption heads, and the adsorption pads follow undulations or bendings of the substrate due to the Venturi effect. The compressed air moves so as to maintain the interval constant, the interval being between the substrate and the adsorption pads. Thus, the flow of air between the substrate and the adsorption pads becomes a laminar flow, and the interval between the substrate and the adsorption pads are maintained constant. As a result, the substrate is not damaged and can be accurately positioned (above, function of claim 44).

The first substrate supporting section 241A of the scribing unit section 240 moves to the substrate carry-in side and is in a state of waiting at the position of the positioning unit section 220. The plurality of suction pad bases 221 holding the bonded mother substrate 90 lowers, by the up-and-down moving device 222, in the first substrate supporting section 241A in the state of waiting, and the bonded mother substrate 90 is mounted on the first substrate supporting section 241A.

The scribing unit section 240 has a similar structure to the substrate cutting system 1 in Embodiment 1 except that the substrate carry-out device 80 and the steam unit section 160 are removed from the substrate cutting system in Embodiment 1.

A scribing device guide body 242 of the scribing unit section 240 is coupled to a first substrate supporting section 241A and a second substrate supporting section 241B. Along with the movement of the scribing device guide body 242 in a Y direction, the first substrate supporting section 241A and the second substrate supporting section 241B move in the same direction as the scribing device guide body 242, simultaneously.

The first substrate supporting section 241A and the second substrate supporting section 241B includes a plurality of substrate supporting units 244A and a plurality of second substrate supporting units 244B, respectively. Each of the plurality of substrate supporting units 244A and the plurality of second substrate supporting units 244B are movable in the same direction as the movement of the scribing device guide body 242. The plurality of substrate supporting units 244A and the plurality of second substrate supporting units 244B are arranged in line in an X direction along a direction (Y direction) parallel to frames 243A and 243B, respectively.

One of the plurality of first substrate supporting units 244A provided on the first substrate supporting section 241A is similar to the first substrate supporting unit 21A in Embodiment 1 shown in FIG. 6. A timing belt provided on the first substrate supporting unit 244A is caused to circle when a clutch provided on the first substrate supporting section 241A is connected to a driving axis.

The first substrate supporting unit 244A is provided in plurality with a predetermined interval. The first substrate supporting unit 244A moves in the Y direction along the frames 243A and 243B together with the scribing device guide body 242.

The mechanism for causing the timing belt of the first substrate supporting unit 244A, having such a structure, to circle is similar to that in Embodiment 1 shown in FIGS. 7 to 9. The frames 11A and 11B in FIG. 7 are the frames 243A and 243B in Embodiment 2, respectively.

Clamp units are provided on the frames 243A and 243B sides, respectively, the clamp units including clutches for causing the timing belts to circle by rotating timing pulleys for driving of the plurality of the first substrate supporting units 244A provided on the first substrate supporting section 241A, as shown in FIG. 7.

As shown in FIG. 45, a pillar 245 on the frame 243A side and a pillar 245 on the frame 243B side for supporting the first substrate supporting unit 244A are held by a guide base 247, and movers (not shown) for a linear motor are attached to guide bases 247 for holding pillars 246 which supports both ends of the scribing device guide body 242. Thus, the scribing device guide body 242 moves to the substrate carry-in side and at same time, the plurality of the first substrate supporting units 244A of the first substrate supporting section 241A moves to the substrate carry-in side due to the drive of the linear motor.

When the scribing device guide body 242 moves, a pinion of a clutch unit on the frame 243A side and a pinion on the frame 243B side are caused to rotate along the frame 243A and the frame 243B, the pinions being engaged with the respective racks attached in a similar manner as shown in FIG. 8.

In order to cause the timing belt to circle by rotating the timing pulley for driving of the first substrate supporting unit 244A, both clutches of the frame 243A and the frame 243B can be connected to a driving axis, to which the rotation of pinions are transmitted. Alternatively, either one of the clutch of the frame 243A or the clutch of the frame 243B can be connected to the driving axis, to which the rotation of pinions is transmitted.

The second supporting section 241B includes a plurality of second substrate supporting units 244B which are capable of moving in the same direction as the moving direction of the scribing device guide body 242. The second substrate supporting unit 244B has a similar structure to the first substrate supporting unit 244A. The second substrate supporting unit 244B is held by the pillar 245 on the frame 243A side and the pillar 245 on the frame 243B side, each of the pillars 245 being held by the guide base 247, such that the second substrate supporting unit 244B is symmetrical to the first substrate supporting unit with respect to the scribing device guide body 242 and the mounting direction of the second substrate supporting unit 244B is opposite to that of the first substrate supporting unit 244A in the Y direction.

Movers (not shown) for a linear motor are attached to guide bases 247 for holding the pillars 246, which support both ends of the scribing device guide body 242. Thus, the scribing device guide body 242 moves to the substrate carry-in side and at same time, the plurality of the second substrate supporting units 244B of the second substrate supporting section 241B moves to the substrate carry-in side due to the drive of the linear motor.

Clutch units similar to those in the first substrate supporting section 241A are provided in the frame 243A side and the frame 243B side of the second substrate supporting section 241B. When the scribing device guide body 242 moves, a pinion of a clutch unit on the frame 243A side and a pinion on the frame 243B side are caused to rotate along the frame 243A and the frame 243B, the pinions being engaged with the respective racks attached.

In order to cause the timing belt to circle by rotating the timing pulley for driving of the second substrate supporting unit 244B, both clutches of the frame 243A side and the frame 243B side can be connected to a driving axis, to which the rotation of pinions are transmitted. Alternatively, either one of the clutch of the frame 243A or the clutch of the frame 243B can be connected to the driving axis, to which the rotation of pinions is transmitted.

Furthermore, a clamp device 251 is provided above the mounting base 250, the clamp device clamping the bonded mother substrate 90 supported by the first substrate supporting section 241A. For example, the clamp device 251, as shown in FIG. 43, includes a plurality of clamp devices 251, which is attached to the frame 243B with a predetermined interval therewith, for clamping the side edge of the bonded mother substrate 90 along the frame 243B and a plurality of clamp devices 251, which is arranged with a predetermined interval along a direction perpendicular to the frame 243B, for clamping the side edge of the bonded mother substrate 90 on the substrate carry-in side.

The operation of each clamp device 251 is similar to that described in Embodiment 1 in FIGS. 12 and 13. Thus, description of the operation of the clamp device 251 will be omitted herein.

The arrangement of the clamp devices 251 is not limited to a case when the clamp devices 251 for holding the bonded mother substrate 90 are provided on the frame 243B and on the substrate carry-in side in a direction perpendicular to the frame 243B. However, even when the clamp devices 251 are provided only on the frame 243B, the bonded mother substrate 90 is held without sustaining any damage.

The clamp device 251 described above only shows one example used in a substrate cutting system according to the present invention. Thus, the clamp devices 251 are not limited to these. In other words, a clamp device can be arbitrary, as long as the clamp device has a structure for gripping or holding the side edge of the bonded mother substrate 90. For example, when the size of the substrate is small of the substrate is held by clamping one part of the side edge of the substrate, and the substrate can be cut without causing any defect to the substrate.

An upper substrate cutting device 60 in Embodiment 1 shown in FIG. 3 is attached to the upper guide rail 252 of the scribing device guide body 242. A lower substrate cutting device 70 is attached to the lower guide rail 253, the lower substrate cutting device 70 having a similar structure to the upper substrate cutting device 70 in Embodiment I shown in FIG. 4 and being in a state of inversion to the upper substrate cutting device 60 in a vertical direction. The upper substrate cutting device 60 and the lower substrate cutting device 70 slide along the upper guide rail 252 and the lower guide rail 253, respectively, due to a linear motor.

For example, in the upper substrate cutting device 60 and the lower substrate cutting device 70, cutter wheels 62a for scribing a bonded mother substrate 90 are rotatably attached to tip holders 62b, respectively, the cutter wheels being similar to those shown in Embodiment 1 in FIGS. 3 and 4. Furthermore, the tip holders 62b are rotatably attached to respective cutter heads 62c with a direction vertical to top and bottom surfaces of the bonded mother substrate 90 held by the clamp devices 251 at its axis. The cutter heads 62c are movable along a direction vertical to top and bottom surfaces of the bonded mother substrate 90 by a driving means (not shown). A load is applied to the cutter wheels 62a, as appropriate, by an energizing means (not shown).

As the cutter wheel 62a held by the tip holder 62b, a cutter wheel which has a blade edge with the center in the width direction protruded in an obtuse V shape is used as disclosed in Japanese Laid-Open Publication No. 9-188534. The protrusions with a predetermined height are formed on the blade edge with a predetermined pitch in the circumferential direction.

The lower substrate cutting device 70 provided on the lower side guide rail 253 has a structure similar to the upper substrate cutting device 60, but is provided in an inverted state thereto. The cutter wheel 62a (see FIG. 4) of the lower substrate cutting device 70 is arranged so as to face the cutter wheel 62a of the upper substrate cutting device 60.

The cutter wheel 62a of the upper substrate cutting device 60 is pressed so as to make contact onto the top surface of the bonded mother substrate 90 by the aforementioned energizing means and the moving means of the cutter head 62c. The cutter wheel 62a of the lower substrate cutting device 70 is pressed so as to make contact onto the bottom surface of the bonded mother substrate 90 by the aforementioned energizing means and the moving means of the cutter head 62c. When the upper substrate cutting device 60 and the lower substrate cutting device 70 are simultaneously moved in the same direction, the bonded mother substrate 90 is cut.

As described above, the first substrate supporting section 241A includes the plurality of substrate supporting units 244A. The plurality of substrate supporting units 244A moves in parallel along the moving direction of the scribing device guide body 242. The plurality of first substrate supporting units 244A moves together with the scribing device guide body 242 along with the movement of the scribing device guide body 242. Thus, with a structure such that a space is provided between the scribing device guide body 242 and the first substrate supporting unit 244A, and the space is moved in the Y direction, and the substrate 90 is fixed by the clamping device 251, when the space is moved or scribing is performed on both mains surfaces of the substrate 90, the first substrate supporting unit 244A does not rub the substrate 90 or exert any force on the substrate. As a result, when a vertical crack is created within the substrate 90 by the cutter wheel 62a, there is no possibility that an undesired crack will result from the cutter wheel 62a (above, function of claim 5)

Furthermore, the first substrate supporting units 244A include the timing belts for supporting the substrate 90. Thus, the first substrate supporting unit 244A does not rub the substrate 90 or does not exert any force on the substrate 90 when the timing belts 21e move in the Y direction. As a result, when a vertical crack is created within the substrate 90 by the cutter wheel 62a, there is no possibility that an undesired crack will result from the cutter wheel 62a (above, function of claim 6).

The first substrate supporting unit 244A may include a plurality of cylindrical rollers. In this case, the substrate 90 is better supported (above, function of claim 7). For example, the plurality of cylindrical rollers is rotated by the clutch 116. The clutch 116 rotates the plurality of cylindrical rollers in accordance with the movement of the scribing device guide body 242. The clutch 116 can select the direction of rotation or stop the rotation of the plurality of cylindrical rollers in accordance with the movement of the space. In this case, when the clamping of the substrate 90 by the clamping device 251 is released, the substrate supporting device (first substrate supporting section 241A and second substrate supporting section 241B) can be used for transporting the substrate 90 (above, function of claim 8).

The clutch unit 110 rotates the plurality of cylindrical rollers in accordance with the movement of the scribing device guide body 242. For example, the outer circumferential speed of the plurality of cylindrical rollers is controlled so as to match the moving speed of the scribing device guide body in the Y direction. Therefore, when the plurality of cylindrical rollers moves in the Y direction, the plurality of cylindrical rollers does not rub the substrate 90 or does not exert any force on the substrate 90. As a result, when a vertical crack is created within the substrate 90 by the cutter wheels 62a, there is no possibility that an undesired crack will result from the cutter wheels 62a (above, function of claim 9).

When the first substrate supporting unit 244A is the timing belt, the surface of the substrate is supported on a surface of the timing belt 21e compared to when a cylindrical roller is used. As a result, the substrate is stably supported (above, function of claim 10).

As described above, even when the first substrate supporting unit 244A is the timing belt, the clutch 116 can circle the plurality of belts in accordance with the movement of the scribing device guide body 244. In this case, the belt can select, by the clutch 116, the direction of the circling movement or stop the circling movement of the belt 21e in accordance with the movement of the space. Therefore, when the clamping of the substrate 90 by the clamping device 251 is released, the substrate supporting device (first substrate supporting section 241A and second substrate supporting section 241B) can be used for transporting the substrate 90 (above, function of claim 11).

The clutch unit 110 circles the plurality of belts in accordance with the movement of the scribing device guide body 244. As described above, the circling speed of the plurality of belts is controlled so as to match the moving speed of the scribing device guide body 242 in the Y direction. Therefore, when the plurality of belt moves in the Y direction, the plurality of belts does not rub the substrate 90 or does not exert any force on the substrate 90. As a result, when a vertical crack is created within the substrate 90 by the cutter wheel 62a, there is no possibility that an undesired crack will result from the cutter wheel 62a (above, function of claim 12).

The structure and the function of the first substrate supporting section 241A have been described above. The second substrate supporting section 241B may have a structure and a function similar to those of the first substrate supporting section 241A (above, function of claims 14 to 21).

It is preferred that the cutter wheel 62a is rotatably supported by the cutter head 65 using the servo motor disclosed in WO 03/011777.

FIG. 14 shows a side view of the cutter head 65 and FIG. 15 shows a front view of the important constituents thereof as one example of the cutter head 65 using the servo motor. The servo motor 65b is supported in an inverted manner between a pair of side walls 65a. A holder holding member 65c is provided below the pair of side walls 65a so as to be rotatable via a supporting axis 65d, the holder holding member 65c having an L shape when viewed from the side. A tip holder 62b is attached in front (on the right-hand side in FIG. 15) of the holder holding member 65c. The tip holder 62b is attached to rotatably support the cutter wheel 62a via an axis 65e. Flat bevel gears 65f are mounted on the rotation axis of the servo motor 65b and the supporting axis 65d so as to engage with each other. Thus, the holder holding member 65c performs an upwards and downwards tilt operation with the supporting axis 65d as its supporting point and the cutter wheel 62a moves upwards and downwards due to the forward and reverse rotation of the servo motor 65b. The cutter heads 65 themselves are provided on the upper substrate cutting device 60 and the lower substrate cutting device 70.

FIG. 16 is a front view showing another example of cutter head using a servo motor. The rotation axis of the servo motor 65b is directly connected to the holder member 65c.

The cutter heads shown in FIGS. 14 and 16 move the cutter wheels 62a upwards and downwards by rotating the servo motors using the position control so as to position the cutter wheel 62a. The cutter heads transmit the scribing pressure for the brittle material substrate to the cutter wheel 62a by controlling the rotation torque. The rotation torque acts to return the cutter wheel 62a to the set position when the position of the cutter wheel 62a is shifted from the positions set in the servo motors 65b beforehand during the scribing operation for forming a scribing line on the bonded mother substrate 90 by moving the cutter heads in a horizontal direction. In other words, the servo motor 65b controls the position in the perpendicular direction of the cutter wheel 62a, and at the same time, the servo motor 65b is an energizing means for the cutter wheel 62a.

By using the cutter head including the aforementioned servo motor, when the bonded mother substrate 90 is being scribed, the rotation torque of the servo motor is corrected immediately in response to the change of the scribing pressure by the change in resistive force received by the cutter wheel 62a. Thus, scribing is stably performed and a scribing line with excellent quality can be formed.

A cutter head is effectively applied to cutting the mother substrate in the substrate cutting system according to the present invention. The cutter head includes a mechanism for vibrating a scribing cutter (e.g., a diamond point cutter or a cutter wheel) which scribes the bonded mother substrate 90 so as to periodically change the pressure force of the scribing cutter on the bonded mother substrate 90.

The structure of the upper substrate cutting device 60 and the lower substrate cutting device 70 is not limited to the aforementioned structure. In other words, any structure can be used, as long as the device has a structure for processing the top and bottom surfaces of the substrate so as to cut the substrate.

For example, the upper substrate cutting device 60 and the lower substrate cutting device 70 can be a device which cuts the mother substrate by using such as a laser light, a dicing saw, a cutting saw, a cutting blade or a diamond cutter.

When the mother substrate is made of a metal substrate (e.g., a steel plate), a wood plate, a plastic substrate or a brittle material substrate (e.g., a ceramic substrate, glass substrate or semiconductor substrate), a substrate cutting device for cutting the mother substrate by using, for example, a laser light, a dicing saw, a cutting saw, a cutting blade or diamond cutter is used.

Furthermore, when a bonded mother substrate for which a pair of mother substrate is bonded to each other, a bonded mother substrate for which different types of mother substrates are bonded to each other or a stacked substrate for which a plurality of mother substrates are stacked on each other is cut, a substrate cutting device similar to the one used for cutting the aforementioned mother substrate can be used.

The upper substrate cutting device 60 and the lower substrate cutting device 70 may include a cutting assistance means for assisting the cutting of the substrate. As a cutting assistance means, for example, a means for pressing (e.g., a roller on the substrate), a means for spraying compressed air onto the substrate, a means for irradiating a laser onto the substrate or a means for warming (heating) the substrate by spraying such as heated air onto the substrate is used.

Furthermore, in the description above, the upper substrate cutting device 60 and the lower substrate cutting device 70 have the same structure. However, the upper substrate cutting device 60 and the lower substrate cutting device 70 can have structures different from each other, depending on the cutter pattern of the substrate or the cutting condition of the substrate.

The lift conveyor section 260 transports the processed bonded mother substrate 90 to the steam break unit section 280, the bonded mother substrate 90 being mounted on the plurality of substrate supporting units 244B of the second substrate supporting section 241B after the bonded mother substrate 90 is scribed by the upper substrate cutting device 60 and the lower substrate cutting device 70 of the scribing device guide body 242 of the scribing unit section 240 and the clamping (holding) of the bonded mother substrate 90 by the clamp devices 251 are released.

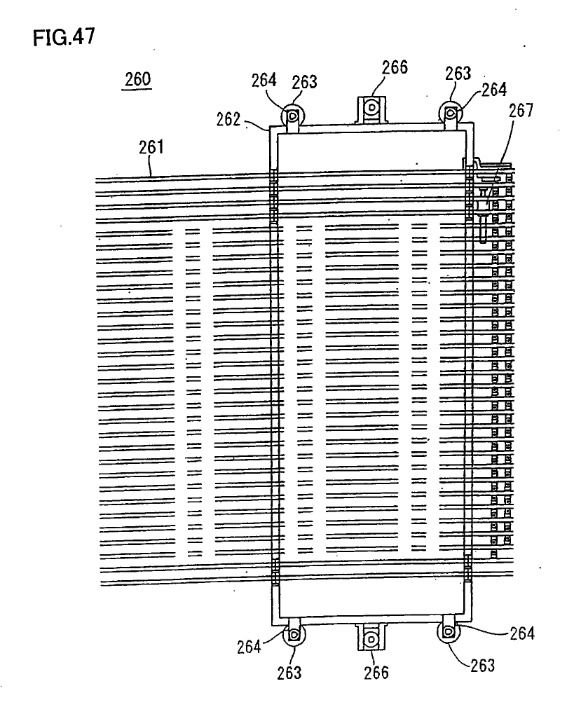

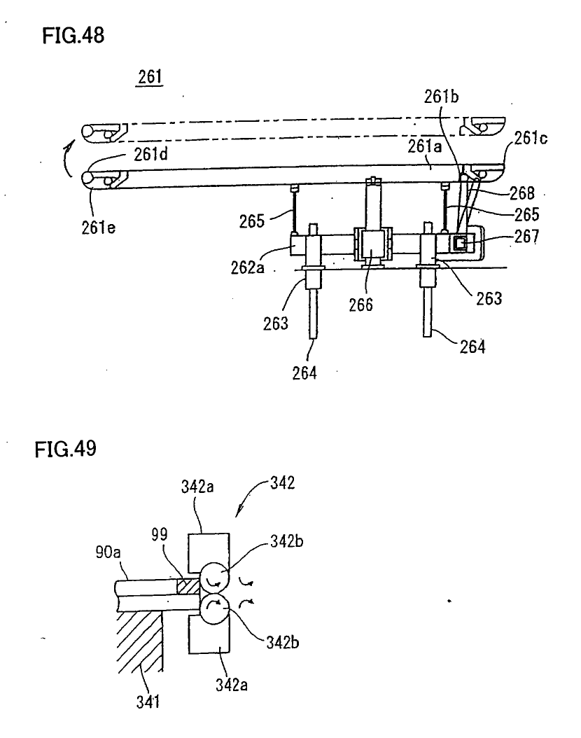

FIG. 47 is a plan view of the lift conveyor section 260. FIG. 48 is a side view of third substrate supporting units 261 which constitute the lift conveyor section 260.

The third substrate supporting unit 261 includes a supporting body section 261a, which linearly extends along a direction (Y direction) parallel to the frame 243A and the frame 243B. Timing pulleys 261c and 261d which, for example, guide a timing belt 261e, are attached to each end of the supporting body section 261a, respectively. The timing pulley 216b for driving is connected to a driving axis to which the rotation of the rotating motor 267 is transmitted by the belt 268, so as to cause the timing belt 261e to circle.

The plurality of third substrate supporting units 261 is arranged in the lift conveyor section 260 with a predetermined interval. The plurality of third substrate supporting units 261 is held by a holding frame 262 via the pillars 265 such that the plurality of second substrate supporting units 244B of the second substrate supporting section 241B of the scribing unit section 240 is inserted into each respective interval.

Cylinders 266 are provided in the center of each frame 262a of the holding frame 262 of the frame 243A side and the frame 244B side. Bodies of the cylinders 266 are respectively joined to the upper surface of the mounting base 270, and rods of the cylinders 266 are respectively joined to each frame 262a of the holding frame 262. Guide shafts 264 are provided on both sides of the respective frames 262a of the holding frame 262, and the guide shafts are inserted into respective linear guides 263 which are provided on the upper surface of the mounting base 270.

After the bonded mother substrate 90 is scribed by the upper substrate cutting device 60 and the lower substrate cutting device 70 of the scribing device guide body 242 of the scribing unit section 240, the clamping (holding) of the bonded mother substrate 90 by the clamp devices 251 is released. The scribed bonded mother substrate 90 mounted on the plurality of second substrate supporting units 244B of the second substrate supporting section 241B is transported to the steam break unit section 280 when a rotating motor 267 is rotated and the plurality of timing belts 261e is moved after the scribed bonded mother substrate 90 mounted on the plurality of the third substrate supporting units 261 is moved to a predetermined position, which is located above, (+Z direction) along a perpendicular direction due to the drive of the cylinders 266.

The steam break unit section 280 has a structure similar to the steam unit section 160 in Embodiment 1 shown in FIG. 10 except that the steam break unit section 280 does not move along the Y direction and is fixed. In the steam break unit section 280, an upper steam unit attachment bar 281 and a lower steam unit attachment bar 282 are attached to pillars 283, respectively, along the x direction, parallel to the scribing device guide body 242. The upper steam unit attachment bar 281 attaches a plurality of steam units 284 for spraying steam onto the mother substrate 91 on the upper side of the bonded mother substrate 90. The lower steam unit attachment bar 282 attaches a plurality of steam units 284 for spraying steam onto the mother substrate 92 on the lower side of the bonded mother substrate 90.

Each pillar 283 on the respective frame 243A and 243B sides of the steam break unit section 280 is joined to the upper surface of the mounting base 270, respectively. A belt conveyor 285 is provided on the substrate carry-out side of the steam break unit section 280 after the steam is sprayed onto top and bottom surfaces of the bonded mother substrate 90 from the steam unit 284. The belt conveyor is provided with, for example, a sheet belt which circles, and supports and transports the completely cut bonded mother substrate 90.

The circling speed of the belt conveyor 285 provided on the substrate carry-out side of the steam break unit section 280 is set at approximately the same circling speed of each timing belt 261e of the plurality of the respective third substrate supporting units 261 of the lift conveyor 260 and moves in synchronization therewith.

The steam break unit section 280 has a structure similar to the steam unit section 160 in Embodiment 1 shown in FIG. 10. A plurality of steam units 284 is attached to the upper steam unit attachment bar 281. The plurality of steam unit attachment bar 284 is attached to the lower steam unit attachment bar 282 with a gap GA with respect to the plurality of steam unit 284 on the upper side. The gap GA is adjusted such that the bonded mother substrate 90 passes through the gap GA.

The structure of the steam unit 284 is similar to that of the steam unit section 261 in Embodiment 1 shown in FIG. 11. The steam unit 284 is almost entirely constructed by an aluminum material. A plurality of heaters 161a is embedded in the steam unit 284 in a perpendicular direction. When an open/close valve, which automatically opens and closes, is opened, water flows into the steam unit 284 from a water supplying mouth 161b. The water is heated by the heater 161a and the supplied water vaporizes into steam. The steam is sprayed toward the surface of the mother substrate from a gushing mouth 161d through a conducting hole 161c.

An air knife (any one of substrate adhesion removal devices 700, 1000, 1500 and 2000) is provided on the carry-out side of the upper stem unit attachment bar 281. The air knife (any one of substrate adhesion removal devices 700, 1000, 1500 and 2000) is provided for removing the moisture that remains on the surface of the mother substrate 90 after the steam is sprayed onto the upper surface of the mother substrate 90. A steam unit 284 and any one of the substrate-adhered material removal device 700, 1000, 1500, 2000 similar to those attached to the upper steam unit attachment bar 281 are provided in the lower steam unit attachment bar 282.

After the scribed bonded mother substrate 90 that is mounted on the second substrate supporting units is moved mounted on the third substrate supporting units 261 to a predetermined position, which is located above, (+Z direction) along a perpendicular direction, when the belt conveyor 285 provided on the substrate carry-out side of the steam break unit section 280 is moved at the circling speed at approximately the same circling speed of each timing belt 261e of the plurality of the respective third substrate supporting units 261, the scribed bonded mother substrate 90 passes through the steam break unit section 280, is cut into panel substrates 90a and is held by the belt conveyor 285.

The substrate transportation unit section 300 lifts the panel substrates 90a, which is moving or stopped, supported by the belt conveyor 285, and mounts the panel substrates 90a on a panel supporting section 322 of an inversion transportation robot 321 of a panel inversion unit section 320, when the bonded mother substrate 90 passes through the steam break unit section 280 and is cut.

Above the mounting base 270 and the mounting base 330 of the substrate transportation unit section, a substrate carry-out device guide 301 is constructed. The substrate transportation device guide 301 is capable of moving the transportation robot 310, which transports the panel substrates cut from the bonded mother substrate 90, in the X direction in parallel to the steam break unit section 280 and the scribing device guide body 242, perpendicular to the flow direction of the substrate in the Y direction.

In the substrate carry-out unit section 300, along guides 303 on the frame 243A side and on the frame 243B side provided on each respective top surface of the mounting base 270 and the mounting base 330 via pillars 302, both ends of the substrate carry-out device guide 301 slide due to linear motors via respective supporting members 304. In this case of the linear motors, movers (not shown) of the linear motors are inserted in the stators for the linear motors, provided on the respective guides 303. The movers for the linear motors are attached to the supporting members 304.

An adsorption section (not shown) is provided on the carry-out robot 310. The adsorption section adsorbs, by suction, each panel substrate 90a that is cut from the bonded mother substrate. While the panel substrate 90a is in a state of being adsorbed by the adsorption section, when the transportation robot 310 is slid to the substrate carry-out side, each panel substrate 90a is mounted on the panel supporting section 322 of the inversion transportation robot 321 in the panel inversion unit section 320.

The structure of the carry-out robot 310 in the substrate transportation unit section 300 is similar to that of the carry-out robot 140 or the carry-out robot 500 in Embodiment 1 shown in FIG. 5A to FIG. 5E. Thus, the detailed description thereof will be omitted herein. The carry-out robot 310 is attached to the substrate carry-out device guide 301. The carry-out robot 310 is movable by a moving mechanism in a direction (X direction) along the substrate carry-out device guide 301, the moving mechanism combining a driving means due to a linear motor or a servo motor and a straight-line guide. In the transportation of the panel substrate 93 that is cut from the bonded mother substrate 90 by the transportation robot 310, the cut panel substrate 90a is held by the adsorption pads on the carry-out robot due to the suction of a suction mechanism (not shown). After the entire carry-out robot 310 is moved upward by an up-and-down moving mechanism (not shown) once, the cut substrate 93 is transported to the inversion transportation robot 321 in the panel inversion unit section 320 for the next step. Thereafter, the carry-out robot 310 is moved downward by the up-and-down moving mechanism (not shown) again and then, the cut substrate 93 is mounted on a predetermined position of the panel holding section 322 of the inversion transportation robot 321 in the panel inversion unit section 320 in a predetermined state in the next step.

An inversion panel robot 321 is provided in the panel inversion unit section 320. The inversion panel robot 321 receives the panel substrate 90a from the carry-out robot 310 of the substrate transportation unit section 300, inverts the sides (top and bottom) of the panel substrates 90a and mounts the panel substrate 90a on a separation table 341 of a panel terminal separation section 340. Thus, when it is necessary to invert the substrate (invert the sides of a unit panel) for a device of the next step, it is easily handled (above, function of claim 38).

The panel holding section 322 of the inversion transportation robot 321 includes, for example, a plurality of adsorption pads. The panel holding section 322 is rotatably supported with respect to a robot body section 323 of the inversion transportation robot 321.

Referring to the panel substrates 90a mounted, by the inversion transportation robot 321, on the separation table 341 of the panel terminal separation section 340, for example, an undesired portion 99 of the panel substrates 90a is separated from the panel substrate 90a by an undesired portion removal mechanism 342 which is provided in the vicinity of each side edge of the separation table 341, as shown in FIG. 49, whereby the undesired portion removal mechanism 342 is provided by an insertion robot (not shown).

In the undesired portion removal mechanism 342, as shown in FIG. 49, a plurality of removal roller sections 342a is arranged with a predetermined pitch along each side edge of the separation table 341, each of the plurality of removal roller section 342a having a pair of rollers 342b facing each other. Each roller 342b, facing each other, provided on each removal roller section 342a is energized in a direction so as to approach each other. The undesired portion 99 on the upper side of the panel substrate 90a of the substrate and the side edge on the lower side of the panel substrate 90a are inserted between each roller 342b by the insertion robot (not shown). Each roller 342b rotates only in one direction in which the panel substrate 90a is inserted between each roller 342b. The pair of rollers 342b facing each other is set such that the rotating directions thereof are opposite with respect to each other. As described above, the undesired portion removal mechanism 342 can easily remove undesired portions remaining on unit substrates cut from the substrate (above, function of claim 45).

The operation of the substrate cutting system, having such a structure, according to Embodiment 2 will be described, mainly using a case in which a bonded substrate for which large-sized glass substrates are bonded to each other is cut.

When a bonded mother substrate 90 for which large-sized glass substrates are bonded to each other is cut into a plurality of panel substrates 90a (see FIG. 18), a plurality of adsorption pads 221a receive the bonded mother substrate 90 from a transportation device (not shown) in the previous step and adsorb the bonded mother substrate 90, the plurality of adsorption pads 221a provided in a plurality of adsorption pad bases 221 of a positioning unit section 220 according to Embodiment 2.

Four clutches of a first substrate supporting section 241A and a second substrate supporting section 241B of a scribing unit section 240 release the coupling with a driving axis such that timing pulleys, which cause each timing belt of respective first substrate supporting units 244A and respective second substrate supporting units 244B to circle, do not rotate (hereinafter, this state is referred to as “clutch off”).

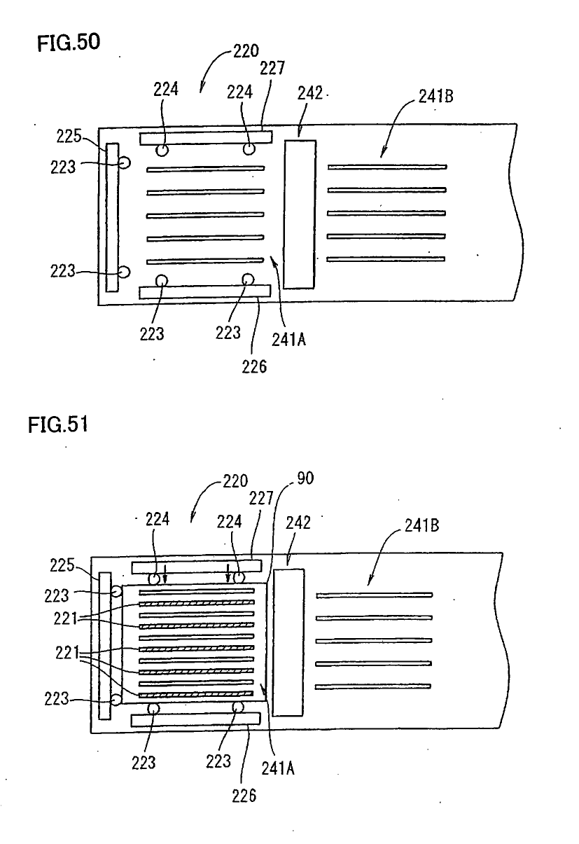

With the clutches off, as shown in FIG. 50, the first substrate supporting section 241A moves, together with the scribing device guide body 242 and the second substrate supporting section 241B, to the substrate carry-in side and waits at the positioning unit section 220.

Thereafter, as shown in FIG. 51, a plurality of adsorption pad bases 221, which holds the bonded mother substrate 90, lower in the first substrate supporting section 241A in a state of waiting, by an up-and-down moving device 222. Adsorption of the bonded mother substrate by the plurality of adsorption pads is released, and the bonded mother substrate 90 is mounted on the first substrate supporting section 241A.

As described above, while the bonded mother substrate 90 is mounted on the first substrate supporting section 241A and the four clutches of the first substrate supporting section 241A and the second substrate supporting section 241B are off, the first substrate supporting section 241A slightly moves, together with the scribing device guide body 242 and the second substrate supporting section 241B, to the substrate carry-in side, and the side edge of the bonded mother substrate 90 on the substrate carry-in side is contacted to a plurality of reference rollers 223 provided in a guide bar 225 of the positioning unit section 220.

After the side edge of the bonded mother substrate 90 on the substrate carry-in side is contacted to a plurality of reference rollers 223 provided in the guide bar 225 of the positioning unit section 220, the bonded mother substrate 90 is pushed toward reference rollers 223 of a guide bar 226 by pushers 224 of a guide bar 227 of the positioning unit section 220, and the side edge of the bonded mother substrate 90 on the guide bar 226 is contacted to the reference roller 223 provided on the guide bar 226. Thus, the bonded mother substrate 90 is positioned within the first substrate supporting section 241A of the scribing unit section 240.

Thereafter, the push of the bonded mother substrate 90 toward the reference rollers 223 of the guide bar 226 by pushers 224 of a guide bar 227 of the positioning unit section 220 is stopped. While the four clutches of the first substrate supporting section 241A and the second substrate supporting section 241B are off, the first substrate supporting section 241A moves together with the scribing device guide body 242 and the second substrate supporting section 241B. After the bonded mother substrate 90 is moved to a position where the bonded mother substrate 90 is to be held by a clamp device 251, the side edges of the bonded mother substrate 90 are clamped by the clamp device 251.

When each side edge of the bonded mother substrate 90 is clamped by the clamp device 251, each side edge being perpendicular to each other, each clamp member, which clamps the side edge of the bonded mother substrate 90, lowers at approximately the same time due to the weight of the bonded mother substrate 90. Therefore, the bonded mother substrate 90 is additionally supported by the timing belts of all of the first substrate supporting units 244A.

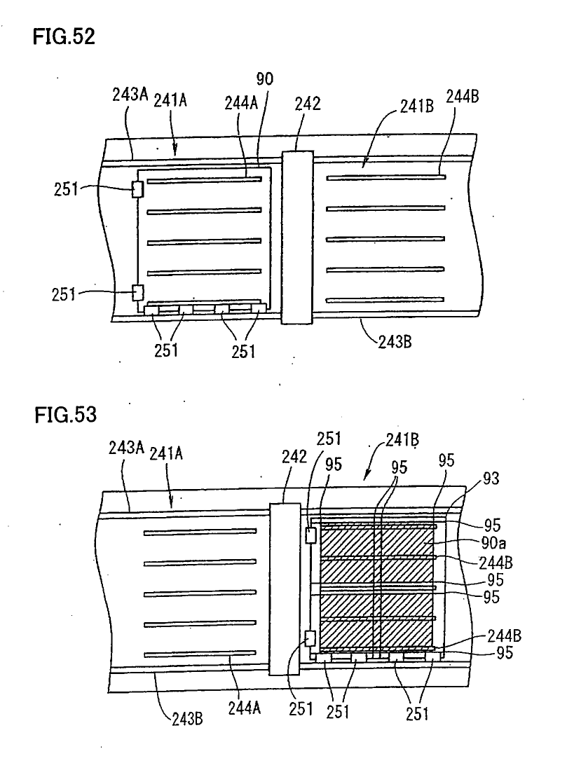

As shown in FIG. 52, when each side edge of the bonded mother substrate 90 perpendicular to each other is clamped by the clamp device 251, and is supported by each first substrate supporting unit 244A, the four clutches of the first substrate supporting section 241A and the second substrate supporting section 241B of the scribing unit section 240 are coupled to the driving axis such that the timing pulleys, which cause each timing belt of respective first substrate supporting units 244A and respective second substrate supporting units 244B to circle (hereinafter, this state is referred to as “clutch on”).

After the four clutches of the first substrate supporting section 241A and the second substrate supporting section 242B are on, the scribing device guide body 242 is slid to the substrate carry-in side so as to be at a predetermined position above the side edge of the bonded mother substrate 90 on the substrate carry-out side, the bonded mother substrate 90 being clamped by the clamp devices in a horizontal direction. A first optical device 38 and a second optical device 39 provided on the scribing device guide body 242, move along the scribing device guide body 242 from respective waiting positions and capture a first alignment mark and a second alignment mark, respectively, provided on the bonded mother substrate 90.

When the scribing guide body 242 slides, the first substrate supporting section 241A is slid to the substrate carry-in side and the second substrate supporting section 241B is slid to the substrate carry-in side, and at the same time, the timing belts of the first substrate supporting units 244A of the first substrate supporting section 241A and the timing belts of the second substrate supporting units 244B of the second substrate supporting section 241B try to move the bonded glass substrate in a direction opposite to the moving direction of the scribing device guide body 242 at the same speed as the moving speed of the scribing device guide body 242. Therefore, the bonded mother substrate 90 does not move. Thus, the bonded mother substrate 90 remains held by the clamp device 251, and the bonded mother substrate 90 is also supported by the timing belts 21e of the first substrate supporting units 244A of the first substrate supporting section 241A and the timing belts of the second substrate supporting units 244B of the second substrate supporting section 241B without being rubbed.

Next, based on the result of the captured first alignment mark and second alignment mark, the inclination of the bonded mother substrate 90 with respect to the direction along the scribing device guide body 242, the starting position of cutting the bonded mother substrate 90 and the ending position of cutting the bonded mother substrate 90 are calculated by an operational processing device (not shown), the bonded mother substrate 90 being supported by the clamp device 251 in a horizontal state. Based on the result of the operation, the upper substrate cutting device 60 and the lower substrate cutting device 70 are moved in the X direction corresponding to the inclination of the bonded mother substrate 90, and at the same time, the scribing device guide body 242 is moved so as to cut the bonded mother substrate 90 (which is referred to as “scribing by linear interpolation” or “cutting” by linear interpolation).

In this case, each cutter wheel 62a facing each other is pressed so as to make contact onto the top surface and the bottom surface of the bonded mother substrate 90 and rolled on the top surface and the bottom surface of the bonded mother substrate 90, respectively, so as to form scribing lines 95 on the top surface and the bottom surface of the bonded mother substrate 90.

FIG. 53 is a diagram showing a state in which the bonded mother substrate is supported by the second substrate supporting section 241B when the forming of the scribing line 95 on each side edge of the respective four panel substrates 90a is completed in order to cut the four panel substrates 90a from the bonded mother substrate 90, by pressing so as to make contact onto the bonded mother substrate 90 and rolling the cutter wheel 62a of the upper substrate cutting device 60 and the cutter wheel 62a of the upper substrate cutting device 70.

The bonded mother substrate 90 is, for example, as shown in FIG. 53, cut so that two panel substrates 90a are cut into two lines in a direction along the upper guide rail 252 and the lower guide rail 253. The cutter wheel 62a of the upper substrate cutting device 60 and the cutter wheel 62a of the lower substrate cutting device 70 are pressed so as to make contact and rolled along the side edge of the panel substrates 90a in order to cut four panel substrates 90a from the bonded mother substrate 90.

In this case, vertical cracks are created, by the cutter wheel 62a of the upper substrate cutting device 60 and the cutter wheel 62a of the lower substrate cutting device 70 on the part where each cutter wheel 62a is respectively pressed so as to make contact each glass substrate and rolled on each glass substrate. As a result, scribing lines 95 are formed thereon. Protrusions are formed, with a predetermined pitch, on the blade edge of each cutter wheel 62a in a circumferential direction. Thus, a vertical crack having about 90% of thickness of the glass substrate in the thickness direction is formed on each glass substrate.

A scribing method is effectively applied to cutting the bonded mother substrate 90 in the substrate cutting system according to the present invention, the scribing method using the cutter head including a mechanism for vibrating a scribing cutter (e.g., a diamond point cutter or a cutter wheel), which scribes the bonded mother substrate 90 so as to periodically change the pressure force of the scribing cutter on the bonded mother substrate 90.

When scribing of the top and bottom surfaces of the bonded mother substrate 90 is completed and the state shown in FIG. 53 is formed. The clamping (holding) of the bonded mother substrate 90 by the clamp devices 251 are released, the bonded mother substrate 90 is mounted on the second substrate supporting section 241B, and at the same time, each clutch in the four clutch units of the second substrate supporting section 241B is turned off.

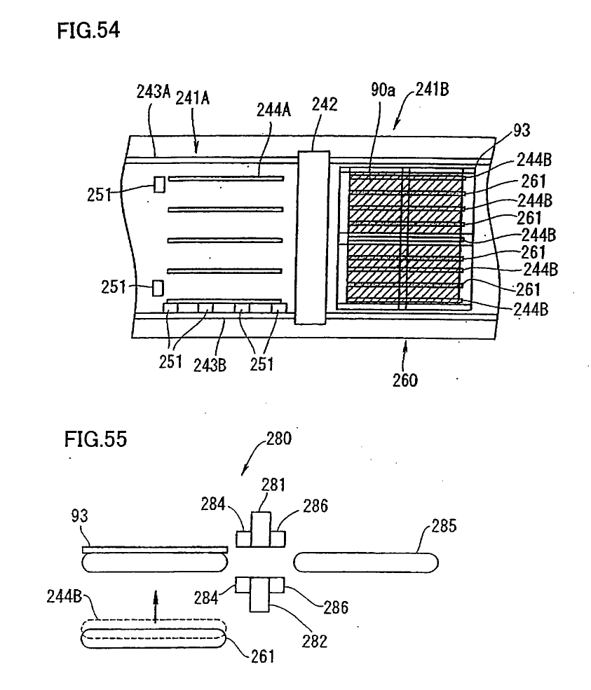

Thereafter, as shown in FIG. 54, the second substrate supporting section 241B, on which the scribed bonded mother substrate 90 is mounted, moves to the substrate carry-out side together with the first substrate supporting section 241A and the scribing device guide body 242, and the second substrate supporting section 241 is moved to a position on intervals of a plurality of third substrate supporting units 261 which is arranged with a predetermined interval in a lift conveyor section 260. As a method of forming a scribing line on each side edge of the respective four panel substrates 90a in order to cut the four panel substrates from the bonded mother substrate 90 by pressing so as to make contact the bonded mother substrate 90 and rolling the cutter wheel 62a of the upper substrate cutting device 60 and the cutter wheel 62a of the upper substrate cutting device 70, a scribing method in Embodiment 1 shown in FIG. 19, which is different from the one shown in FIG. 53, can be effectively applied to the substrate cutting system according to Embodiment 2.

The plurality of third substrate supporting units 261 is arranged in the lift conveyor section 260 with a predetermined interval. The plurality of third substrate supporting units 261 is held by a holding frame 262 via the pillars 265 as shown in FIG. 48 such that the plurality of second substrate supporting units 244B of the second substrate supporting section 241B of the scribing unit section 240 is inserted into each respective interval. As shown in FIG. 55, the plurality of third substrate supporting units 261 is arranged such that the faces of the respective timing belts 261e, which receive the scribed bonded mother substrate 90, are positioned below the face of the second substrate supporting units 244B where the scribed bonded mother substrate 90 is mounted.

The scribed bonded mother substrate 90 mounted on the plurality of substrate supporting units 244B of the second substrate supporting section 241B is transported to the steam break unit section 280 when a rotating motor 267 is rotated and the plurality of timing belts 261e is moved after the scribed bonded mother substrate 90 mounted on the plurality of the third substrate supporting units 261 is moved to a predetermined position, which is located above, (+Z direction) along a perpendicular direction due to the drive of the cylinders 266.

In the steam break unit section 280, an upper steam unit attachment bar 281 and a lower steam unit attachment bar 282 are attached to pillars 283 along the x direction in parallel to the scribing device guide body 242. The upper steam unit attachment bar 281 attaches a plurality of steam units 284 for spraying steam onto the mother substrate 91 on the upper side of the bonded mother substrate 90. The lower steam unit attachment bar 282 attaches a plurality of steam units 284 for spraying steam onto the mother substrate 92 on the lower side of the bonded mother substrate 90.

The circling speed of the belt conveyor 285 provided on the substrate carry-out side of the steam break unit section 280 is set at approximately the same circling speed of each timing belt 261e of the plurality of the respective third substrate supporting units 261 of the lift conveyor 260 and moves in synchronization therewith, and the scribed bonded mother substrate 90 passes through the steam break unit section 280.

An air knife 286 is provided on an upper steam unit attachment bar 281 on the substrate carry-out side. An air knife 284 and an air knife 286 that are similar to the air knife attached to the upper steam unit attachment bar 282 are provided on the lower steam unit attachment bar 282. Thus, after steam is sprayed on the top and bottom surfaces of the bonded mother substrate 90, the moisture remaining on the top and bottom surfaces of the bonded mother substrate 90 is completely removed.

When the steam is sprayed onto the top and bottom surfaces of the substrate 90 where a scribing line is formed, the heated moisture infiltrates inside a vertical crack of each scribing line, and the vertical crack extends due to the expanding force. As a result, the substrate can be cut (above, function of claim 23).

When the scribed bonded mother substrate 90 passes through the steam break unit section 280, the bonded mother substrate 90 is cut into panel substrates 90a and held by the belt conveyor 285.

When the bonded mother substrate 90 passes through the steam break unit section 280, the bonded mother substrate 90 is cut into a plurality of panel substrates 90a. The panel substrates 90a, which is moving or stopped, supported by the belt conveyor 285 are lifted by the transportation robot 310, and are mounted on the panel supporting section 322 of an inversion transportation robot 321 in a panel inversion unit section 320.

The inversion transportation robot 321 of the panel inversion unit section 320 receives the panel substrates 90a from the transportation robot 310 of the substrate transportation unit section robot 310, inverts the top and bottom surfaces of the panel substrates 90a, and mounts them on the separation table 341 of the panel terminal separation section 340.

Referring to the panel substrates 90a mounted, by the inversion transportation robot 321, on the separation table 341 of the panel terminal separation section 340, for example, an undesired portion 99 of the panel substrates 90a are separated from the panel substrate 90a by an undesired portion removal mechanism 342 which is provided in the vicinity of each side edge of the separation table 341 as shown in FIG. 49, the undesired portion removal mechanism 342 being provided by an insertion robot (not shown).

The substrate includes a bonded substrate for which mother substrates are bonded to each other, a bonded substrate for which different mother substrates are combined and bonded to each other, and a stacked substrate for which mother substrates are combined and stacked on each other, other than the mother substrate.

The substrate cutting system 200 according to Embodiment 2 of the present invention has been described above with reference to FIGS. 43 to 55.

### Embodiment 3

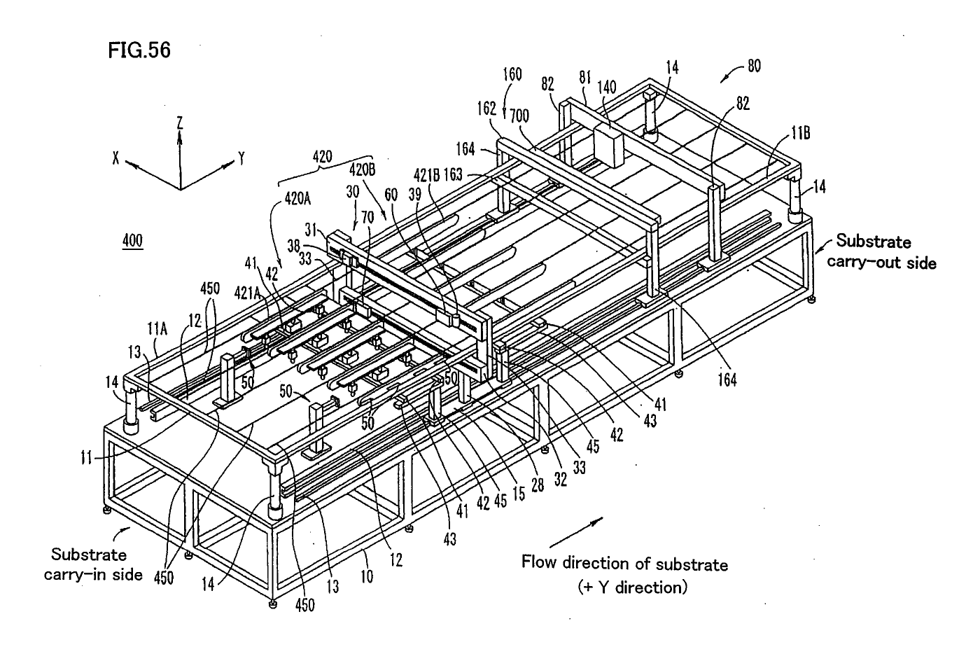

Hereinafter, a substrate cutting system 400 according to Embodiment 3 of the present invention will be described with reference to FIGS. 56 to 62.

FIG. 56 is a perspective view schematically showing the entire cutting substrate system 400 according to Embodiment 3 of the present invention. In the present invention, the term “substrate” includes a single plate, such as a mother substrate cut into a plurality of substrates, a metal substrate (e.g., a steel plate), a wood plate, a plastic plate and a brittle material substrate (e.g., a ceramic substrate, a semiconductor substrate and a glass substrate). However, the substrate according to the present invention is not limited to such a single plate. Furthermore, the substrate according to the present invention includes a bonded substrate for which a pair of substrates is bonded to each other and a stacked substrate for which a pair of substrates is stacked on each other.

In the substrate cutting system of the present invention, for example, when a panel substrate (bonded substrate for display panel) for a liquid crystal device is manufactured from a pair of glass substrates bonded to each other, a plurality of panel substrates (bonded substrate for display panel) are cut, by the substrate cutting system according to the present invention, from the bonded mother substrate 90 for which a pair of mother glass substrates is bonded to each other.

The substrate cutting system 400 according to Embodiment 3 has a structure similar to the one in Embodiment 1 except that the substrate supporting device 20 in the substrate cutting system I according to Embodiment I is replaced with a substrate supporting device 420 in Embodiment 3, and a plurality of supporting belts 450 are wound in the substrate cutting system according to Embodiment 3. The same members in FIG. 56 as used in Embodiment 1 are denoted by the same reference numerals as used in Embodiment 1 and the detailed explanation thereof will be omitted.

In a substrate cutting system 400 according to Embodiment 3 of the present invention, description will be made by referring the side where a first substrate supporting section 420A is arranged, as a “substrate carry-in side”, and the side where a substrate carry-out device 80 is arranged, as a “substrate carry-out side”, respectively. In the substrate cutting system 400 according to the present invention, the direction in which a substrate is transported (flow direction of the substrate) is +Y direction from the substrate carry-in side to the substrate carry-out side. The direction in which the substrate is transported is perpendicular to a direction of a scribing device guide body 30 in a horizontal state. The scribing device body guide 30 is provided along the X direction.

The first substrate supporting section 420A and the second substrate supporting section 420B of the substrate supporting device 420 include, for example, five first substrate supporting units 421A and five second substrate supporting units 421B, respectively. The first substrate supporting units 421A and second substrate supporting units 421E are movable in the same direction as the moving direction of the scribing device guide body 30, respectively. Each first substrate supporting unit 421A and each second substrate supporting unit 421B are arranged in line in the X direction along a direction (Y direction) parallel to the frames 11A and 11B in the longitudinal direction of the main frame 11, respectively.

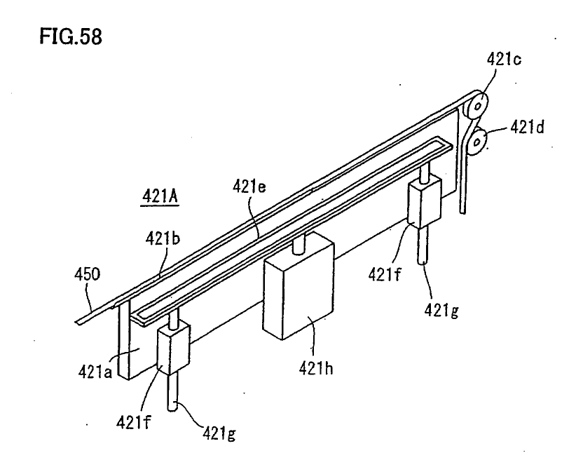

FIG. 58 is a perspective view showing one first substrate supporting unit 421A provided in the first substrate supporting section 420A. The first substrate supporting unit 421A includes a supporting body section 421a which linearly extends along a direction (Y direction) in parallel to a main frame 11. A belt holder 421b which guides a supporting belt 450 is provided on the upper portion of the supporting body section 421a. Pulleys 421o and 421d are attached to the end of the supporting body section 421a on the substrate carry-out side. A cylinder 421h is provided in the center of a bottom portion of the supporting body section 421a. A cylinder rod of the cylinder 421h is joined with a suction plate 421e. Furthermore, linear guides 421f are provided on both ends of the bottom portion of the supporting body section 421a. One end of each shaft 421g, which is inserted into the linear guides 421f, is joined with the suction plate 421e.

The suction plate 421e moves to a position above the supporting belt 450 due to the drive of the cylinder 421h and receives a bonded mother substrate 90 which is transported to the first substrate supporting section 420 from the previous step by a transportation device (not shown). The bonded mother substrate 90 is suctioned and adsorbed by a suction mechanism (not shown) and is mounted on the supporting belt 450 of the first substrate supporting unit 421A.

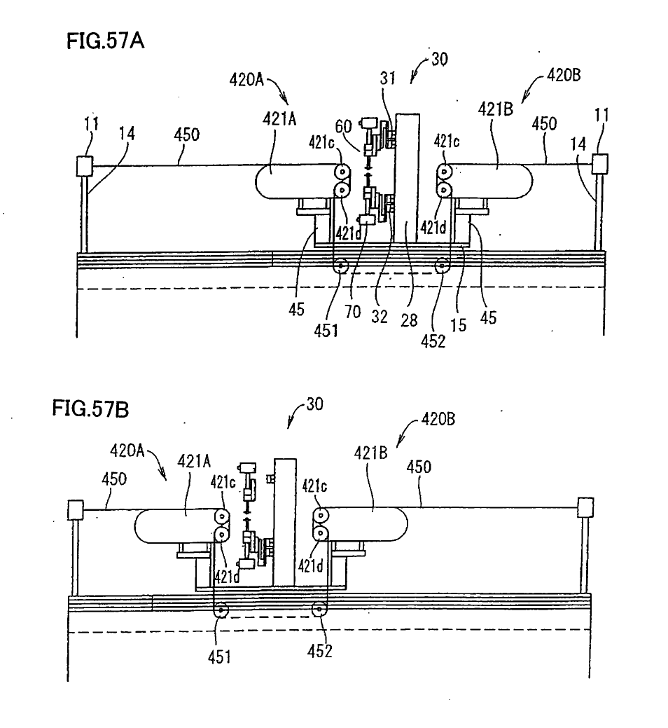

The cylinder 421h has a two-step cylinder structure. When a pattern for injecting compressed air into the cylinder is controlled by an electromagnetic valve (not shown), the suction plate 421e selectively is positioned at a lowermost position below the supporting belt 450, at a uppermost position of receiving the bonded mother substrate 90, and at a middle position of mounting the bonded mother substrate 90 on the supporting belt 450 shown in FIG. 57.

Pillars 45 are provided on the upper surface of guide bases 15 held by respective movement units of a pair of guide rails 13 which is provided on the upper surface of the mounting base 10. Supporting members 43 are provided above the pillars 45, the supporting members 43 being parallel to the Y direction along frames 11A and 11B of the main frame 11. Supporting body sections 21a are attached to respective two unit attachment members 41 and 42 through joining members 46 and 47, the respective two unit attachment members 41 and 42 being constructed on respective supporting members 43 in the X direction perpendicular to the frames 11A and 11B of the main frame 11.

FIGS. 57A and 57B are diagrams for explaining the state that the first substrate supporting unit 421A has moved to the substrate carry-in side together with a scribing device guide body 30 and a second substrate supporting unit 421B. The supporting belt 450 connected to the main frame 11 on the substrate carry-in side as shown in FIG. 57A is supported by the belt holder 421b of the first substrate supporting unit 421A and is wound around the pulleys 421c and 421d of the first substrate supporting unit 421A. Thereafter, the supporting belt 450 is wound around a pulley 451 below the first substrate supporting unit 421A and thereafter, it is wound around a pulley 452 below the second substrate supporting unit 421B. Thereafter, the supporting belt 450 is wound around the pulleys 421d and 421c of the second substrate supporting unit 421B, and it is supported by the belt holder 421b of the second substrate supporting unit 421B. Thereafter, the supporting belt 450 is connected to the main frame 11 on the substrate carry-out side and tensioned.

The pillar 45 on the side of the frame 11A and the pillar 45 on the frame 11B side which support the first substrate supporting units 421A are held by the guide bases 15. Movers (not shown) for the linear motor are connected to the guide bases 15 holding the pillars 28. The pillars 28 support both ends of the scribing device guide body 30. Thus, due to the drive of the linear motor, the scribing device guide body 30 moves to the substrate carry-in side, and at the same time, the five first substrate supporting units 421A of the first substrate supporting section 420A move to the substrate carry-in side.

A plurality (five in the description of the present embodiment) of first substrate supporting units 421A are arranged with a predetermined interval, and move together with the scribing device guide body 30 in the Y direction along the frames 11A and 11B of the main frame 11.

The second substrate supporting section 420B of the substrate supporting device 420 includes, for example, five second substrate supporting units 421B. The second substrate supporting units 421B are movable in the same direction as the moving direction of the scribing device guide body 30. The second substrate supporting unit 421B has a structure in which an adsorption plate 421e, a cylinder 421h fox moving the adsorption plate 421e upward and downward, a linear guide 421f and a shaft 421g are removed from the first substrate supporting unit 421A. The second substrate supporting unit 21B is supported by the pillars 45 on the frame 11A side and on the frame 11B side so as to be attached opposite to the Y direction with respect to the scribing device guide body 30. Each pillar is supported by the guide base 15.

Movers (not shown) for the linear motor are connected to the guide bases 15 which hold the pillars 28, the pillars 28 supporting the both ends of the scribing device guide body 30. Thus, due to the drive of the linear motor, the scribing device guide body 30 moves to the substrate carry-in side, and at the same time, the five second substrate supporting units 421B of the second substrate supporting section 420B move to the substrate carry-in side.

When the first substrate supporting unit 421A moves to the substrate carry-in side together with the scribing device guide body 30 and the second substrate supporting unit 421B as shown in FIG. 57B, the supporting belts 450 of the first substrate supporting unit 421A lower below the scribing device guide body, and the supporting belts 450 of the second substrate supporting units 421B emerge on the belt holders 421b of the second substrate supporting units 421B from under the scribing device guide body 30. As described above, the first substrate supporting section 421A does not rub the bonded mother substrate 90 and it does not exert any force on the substrate. Therefore, when a vertical crack is created within the substrate 90 by the cutter wheel 62a, there is no possibility that an undesired crack will result from the cutter wheel 62a (above, function of claim 46).

When the second substrate supporting unit 421B moves to the substrate carry-in side together with the scribing device guide body 30 and the first substrate supporting unit 421A, the supporting belts 450 of the second substrate supporting unit 421B lower below the scribing device guide body 30, and the supporting belts 450 of the first substrate supporting units 421A emerge on the belt holders 421b of the first substrate supporting units 421A from the under the scribing device guide body 30. As described above, the second substrate supporting section 421B does not rub the substrate 90 and it does not exert any force on the substrate. Therefore, when a vertical crack is created within the substrate 90 by the cutter wheel 62a, there is no possibility that an undesired crack will result from the cutter wheel 62a (above, function of claim 47).

The operation of the substrate cutting system having such a structure according to Embodiment 3 will be mainly described as an example for the case where a bonded substrate for which large-sized glass plates are bonded to each other is cut.

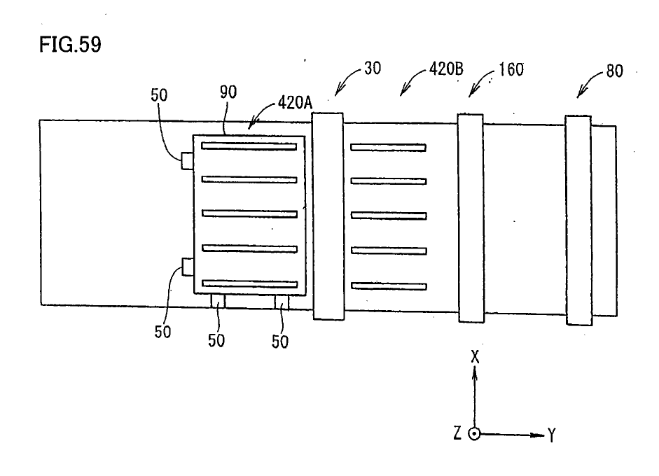

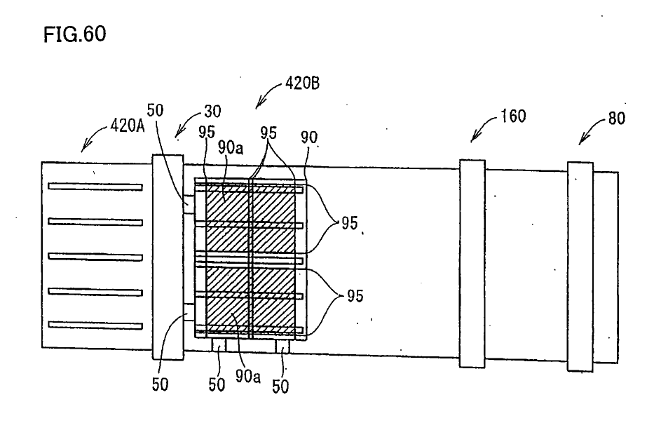

When the bonded mother substrate 90 for which large-sized glass substrates are bonded to each other is cut into a plurality of panel substrates 90a (see FIG. 60), first, as shown in FIG. 59, the bonded mother substrate 90 is carried in, by a transportation robot, etc., from the end of the substrate carry-in side to the present substrate cutting system. Thereafter, the bonded mother substrate 90 is mounted, in a horizontal state, on each supporting belt 450 of all of the first substrate supporting units 421A of the first substrate supporting section 420A.

In this state, the bonded mother substrate 90 is pushed by pushers (not shown) similar to Embodiment 1 so as to contact positioning pins (not shown) arranged along the frame 11B of the main frame 11, and at the same time, the bonded mother substrate 90 is pushed by pushers (not shown) so as to contact positioning pins (not shown) arranged along the direction perpendicular to the frame 11B. Thereby, the bonded mother substrate 90 is positioned in a predetermined position in the mounting base 10 in the substrate cutting system.

Thereafter, as shown in FIG. 59, the side edge of the bonded mother substrate 90 being positioned on the substrate carry-in side is clamped by each clamp member 51 of the clamp device 50, the side edge being along the frame 11B of the main frame 11, and at the same time, the side edge of the bonded mother substrate 90 is clamped by each clamp member 51 of the clamp device 50 which is arranged on the substrate carry-in side in order to be perpendicular to the frame 11B.

When the side edge of the bonded mother substrate 90 is clamped by the clamp device 50, the side edge being perpendicular to each other, each clamp member 51 which clamps the side edge of the bonded mother substrate 90 lowers at approximately the same time due to the weight of the bonded mother substrate 90. Therefore, the bonded mother substrate 90 is additionally supported by the supporting belts 450 of all of the first substrate supporting units 421A.

In this state, the scribing device guide body 30 is slid to the substrate carry-in side so as to be positioned at a predetermined position which is above the side edge of the bonded mother substrate 90 clamped by the clamp device 50 on the substrate carry-out side in a horizontal state. When the first optical device 38 and the second optical device 39 provided on the scribing device guide body 30 are moved along the scribing device guide body 30 from respective waiting positions, the first optical device 38 and the second optical device 39 capture the first alignment mark and the second alignment mark provided on the bonded mother substrate 90, respectively.

When the scribing guide body 30 slides, the first substrate supporting section 420A is slid to the substrate carry-in side and the second substrate supporting section 420B is slid to the substrate carry-in side. Simultaneously, the supporting belts 450 of the first substrate supporting units 421A on the scribing device guide body 30 side lower below the scribing device guide body 30, and the supporting belts 450 of the second substrate supporting units 421B emerge on the belt holders 421b of the second substrate supporting units 421B, respectively, from under the scribing device guide body 30. Thus, the supporting belts 450 do not rub the lower surface of the bonded mother substrate 90.

Next, based on the result of the captured first alignment mark and second alignment mark, the inclination of the bonded mother substrate 90 with respect to the direction along the scribing device guide body 30 and the starting and ending position of cutting the bonded mother substrate 90 are calculated by an operational processing device (not shown). The bonded mother substrate 90 is supported by the clamp devices 50 in a horizontal state. Based on the result of the operation, the upper substrate cutting device 60 and the lower substrate cutting device 70 are moved in the X direction corresponding to the inclination of the bonded mother substrate 90, and at the same time, the scribing device guide body 30 is moved in the Y direction so as to cut the bonded mother substrate 90 (which is referred to as “scribing by linear interpolation” or “cutting” by linear interpolation). In this case, as shown in FIG. 60, each cutter wheel 62a facing each other is pressed so as to make contact onto the top surface and the bottom surface of the bonded mother substrate 90 and rolled on the top surface and the bottom surface of the bonded mother substrate 90, respectively, so as to form scribing lines 95 on the top surface and the bottom surface of the bonded mother substrate 90.

The bonded mother substrate 90 is, for example, cut so that two panel substrates 90a are cut forming two lines in a line direction along the upper guide rail 31 and the lower guide sail 32. The cutter wheel 62a of the upper substrate cutting device 60 and the cutter wheel 62a of the lower substrate cutting device 70 are pressed so as to make contact and rolled along the side edge of the panel substrates 90a in order to cut four panel substrates 90a from the bonded mother substrate 90.

In this case, vertical cracks are created, by the cutter wheel 62a of the upper substrate cutting device 60 and the cutter wheel 62a of the lower substrate cutting device 70 on the part of the glass substrate where each cutter wheel 62a is pressed so as to make contact and rolled. As a result, scribing lines 95 are formed thereon. Protrusions are formed, with a predetermined pitch, on the outer circumferential ridge of the blade edge of each cutter wheel 62a. Thus, a vertical crack having about 90% of the thickness of the glass substrate in the thickness direction is formed on each glass substrate.

A scribing method is effectively applied to cutting the bonded mother substrate 90 in the substrate cutting system according to the present invention. The scribing method uses a cutter head including a mechanism for vibrating a scribing cutter (e.g., a diamond point cutter or a cutter wheel) which scribes the bonded mother substrate 90 so as to periodically change the pressure force of the scribing cutter on the bonded mother substrate 90.

Furthermore, as a scribing method for forming scribing lines on respective side edges of four panel substrates 90a in order to cut the four panel substrates 90a from the bonded mother substrate 90 by pressing and rolling the cutter wheel 62a of the upper substrate cutting device 60 and the cutter wheel 62a of the lower substrate cutting device 70 the scribing method according to Embodiment 1 shown in FIG. 19 is effectively applied to the substrate cutting system according to Embodiment 2, other than the one shown in FIG. 44.

During the scribing by the cutter wheel 62a of the upper substrate cutting device 60 and the lower substrate cutting device 70, all of the first substrate supporting units 421A of the first substrate supporting section 420A and all of the second substrate supporting unit 421B of the second substrate supporting section 420B move to the substrate carry-in side and the substrate carry-out side. However, when all of the first substrate supporting units 421A of the first substrate supporting section 420A and all of the second substrate supporting unit 421B of the second substrate supporting section 420B move to the substrate carry-in side, the supporting belts 450 of the first substrate supporting units 421A on the scribing device guide body 30 side lower below the scribing device guide body 30, and the supporting belts 450 of the second substrate supporting units 421B emerge on the belt holders 421b of the second substrate supporting units 421B from under the scribing device guide body 30. When all of the first substrate supporting units 421A of the first substrate supporting section 420A and all of the second substrate supporting unit 421B of the second substrate supporting section 420B move to the substrate carry-out side, the supporting belts 450 of the second substrate supporting units 421B lower below the scribing device guide body 30, and the supporting belts 450 of the first substrate supporting units 421A emerge on the belt holders 421b of the first substrate supporting units 421A from under the scribing device guide body 30. Thus, there is no possibility that the supporting belts 450 rub the lower surface of the bonded mother substrate 90.

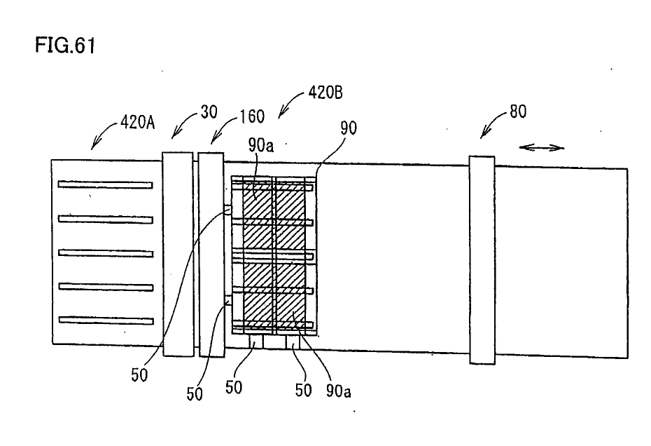

After the scribing line is formed on the bonded mother substrate using the scribing method described above, as shown in FIG. 61, while the bonded mother substrate 90, on which the scribing line 95 is formed, is supported by the supporting belts 450 of the second substrate supporting units 421B, a steam unit section 160 moves to the substrate carry-in side. The steam unit section 160 sprays steam on the entire top and bottom surfaces of the bonded mother substrate 90, on which the scribing line is formed, and completely cuts the bonded mother substrate 90. After the steam is sprayed, a substrate-adhered material removal device 700 removes the moisture remaining on the top and bottom surfaces of the bonded mother substrate 90.

When the steam is sprayed on the entire top and bottom surfaces of the bonded mother substrate 90 on which the scribing line is formed, the scribing line formed by the cutter wheel 62a expands in volume when the upper surface portion of the mother bonded substrate 1 is heated. Thus, a vertical crack extends in the thickness direction of the mother substrate, and the bonded mother substrate 90 is completely cut.

Thereafter, as shown in FIG. 61, all of the panel substrates 90a cut from the bonded mother substrate 90 on the supporting belts 450 of all of the second substrate supporting units 421B of the second substrate supporting section 420B are carried out by the carry-out robot 140 or the carry-out robot 500 of the substrate carry-out device 80, thereby the substrate 93 (edge member) being supported.

The substrate carry-out device 80 and the steam unit section 160 move to the end of the substrate carry-out side.

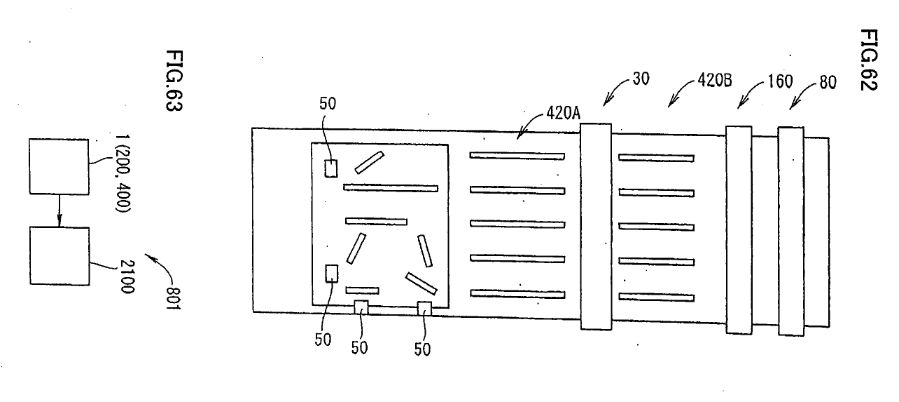

Thereafter, as shown in FIG. 62, the scribing device guide body 30, the second substrate supporting section 420B and the first substrate supporting section 420A are slid to the substrate carry-out side. Simultaneously, the supporting belts 450 of the second substrate supporting units 421B on the scribing device guide body 30 side lower below the scribing device guide body 30, and the supporting belts 450 of the first substrate supporting units 421A emerge on the belt holders 421b of the first substrate supporting units 421A from under the scribing device guide body 30. Thus, there is no possibility that the lower surface of the cut substrate 93 (edge member) rubs the supporting belts 450.

Thus, the supporting belts 450 of the first substrate supporting units 421A of the first substrate supporting section 420A and the supporting belts 450 of the second substrate supporting units 421B of the second substrate supporting section 420B sequentially become in a non-contact state from the lower surface of the substrate 93 without rubbing thereof. Therefore, the support of the cut substrate 93 by each supporting belt 450 is sequentially released. Thereafter, the holding of the substrate 93 (edge member) by the clamping device 50 is released. As a result, the cut substrate 93 (edge member) falls down. In this case, the substrate 93 (edge member) thus fallen is guided by a guide plate arranged in a slanted state so as to be accommodated into a cullet accommodation box.

When the mother substrate is made of a metal substrate (e.g., a steel plate), a wood plate, a plastic substrate or a brittle material substrate (e.g., a ceramic substrate, glass substrate or semiconductor substrate), a method for cutting the mother substrate by using, for example, a laser light, a dicing saw, a cutting saw, a cutting blade or diamond cutter is used.

Furthermore, the substrate includes a bonded substrate for which mother substrates are bonded to each other, a bonded substrate for which different mother substrates are combined and bonded to each other, and a stacked substrate for which mother substrates are combined and stacked on each other, other than the mother substrate.

The substrate cutting system 400 according to Embodiment 3 of the present invention has been described above with reference to FIGS. 56 to 62.

### Embodiment 4

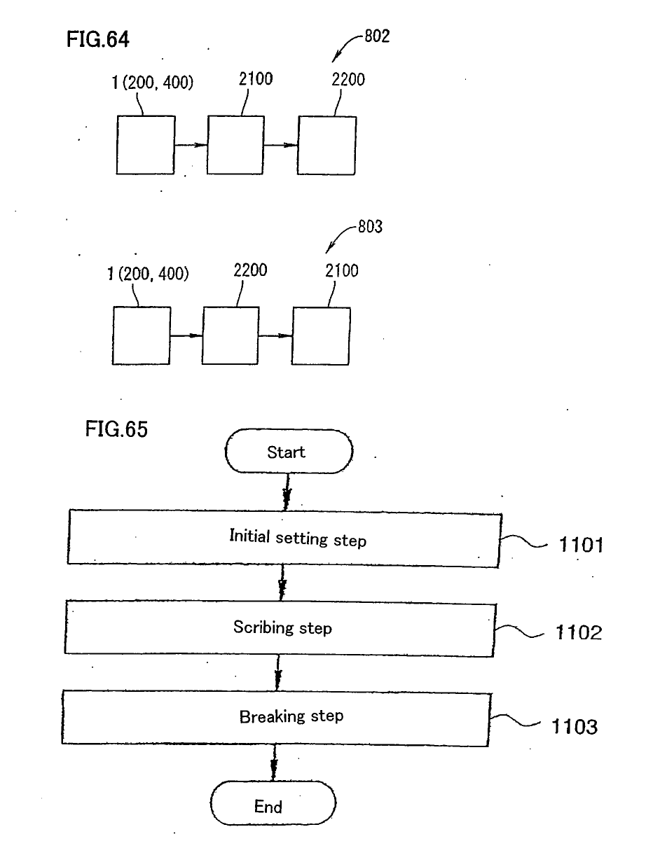

Hereinafter, a substrate manufacturing apparatus according to Embodiment 4 of the present invention will be described with reference to FIGS. 63 and 64.

FIG. 63 shows a substrate manufacturing apparatus 801 according to Embodiment 4 of the present invention.

A substrate manufacturing apparatus 801 is obtained by connecting a substrate chamfering system 2100 for chamfering end surfaces of the cut substrates to one of the substrate cutting systems 1, 200 and 400 according to the present invention.

When a cut unit substrate is transported to a device for the next or later step, an edge of an end face of the cut unit substrate can be chipped and a micro fissure cab be created. As a result, a crack resulting from the chip or the fissure can extend in the entire unit substrate and damage the substrate. However, according to the substrate manufacturing apparatus 801, a chamfering system is connected to the substrate cutting system according to the present invention so as to chamfer end faces of the unit substrate. Thus, it is possible to prevent the damage to the substrate (above, the function of claim 49).

FIG. 64 shows a substrate manufacturing apparatus 802 and a substrate manufacturing apparatus 803 according to Embodiment 4 of the present invention.

The substrate manufacturing apparatuses 802 and 803 are obtained by incorporating an inspection system 220 for inspecting the size, conditions of the top and bottom surfaces, end surfaces, and the like of the cut substrates and for inspecting the functions of the substrates into the substrate manufacturing apparatus 801 described above.

When a cut unit substrate is transported to a device for the next or later step, an edge of an end face of the cut unit substrate can be chipped and a micro fissure can be created. As a result, an undesired crack resulting from the chip or the fissure can extend in the entire unit substrate and damage the substrate. However, according to the substrate manufacturing apparatus 802 or the substrate manufacturing apparatus 803, a chamfering system is connected to the substrate cutting system according to the present invention so as to chamfer end faces of the unit substrate. Thus, it is possible to prevent the damage to the substrate.

Furthermore, powder (cullet powder) created when the substrate is cut into the unit substrates damages the top surface of the substrate and cuts an electrode formed on the unit substrate. However, according to the substrate manufacturing apparatus 802 and the substrate manufacturing apparatus 803, the inspection system is connected to the substrate cutting system so as to be able to detect a defect in the substrate (e.g., a scratch or cut of the electrode) at an early stage. Thus, the cost for the unit substrate in manufacture can be reduced (above, function of claim 51).

In the above description of the operations of the substrate cutting systems according to Embodiments 1 to 3, examples in which the bonded mother glass substrate formed by bonding glass substrates to each other is cut have been described. However, the present invention is not limited to these. For example, operations different from the above description may be performed depending on the types of the substrates to be cut or in order to enhance the functionalities of the devices which constitute the substrate cutting system.

In the above description of Embodiments 1 to 3, the substrate cutting systems for cutting the bonded mother substrate formed by bonding glass substrates to each other into a plurality of display panels have been mainly described. However, the substrate which can be applied to the present invention is not limited to this.

The substrate used in the substrate cutting system according to the present invention includes a metal substrate (e.g., a steel plate), a wood plate, a plastic plate and a brittle material substrate (e.g., a ceramic substrate, a semiconductor substrate and a glass substrate) as a mother substrate. Furthermore, the substrate used in the substrate cutting system according to the present invention includes a bonded substrate for which mother substrates are bonded to each other, a bonded substrate which different mother substrates are combined and bonded to each other, and a stacked substrate for which mother substrates are combined and stacked on each other.

The substrate cutting system can be applied to the cutting of the mother substrate for a PDP (plasma display) used for an FPD (flat panel display)), a liquid crystal display panel, a reflective projector panel, a transmissive projector panel, an organic EL device panel, an FED (field emission display) and the like as a bonded brittle mother substrate for which brittle material substrates are bonded to each other.

The substrate cutting system and the substrate manufacturing apparatus according to the present invention has been described above with reference to FIGS. 1 to 64.

### Embodiment 5

Hereinafter, a substrate cutting method according to Embodiment 5 of the present invention will be described with reference to FIGS. 65 to 67.

For example, a substrate cutting process is performed by the substrate cutting system 1 which has been described with reference to FIG. 1.

According to the substrate cutting method according to Embodiment 5 of the present invention, scribing lines can be formed with a single stroke on both surfaces of the bonded mother substrate 90. Herein, the “scribing line with the single stroke” means only one scribing line formed in order to retrieve a plurality of unit substrates from the bonded mother substrate 90. The scribing line with the single stroke is formed without detaching a scribing cutter from the bonded mother substrate 90, from the start point to the end point of the scribing line with the single stroke, while the state of pressing the bonded mother substrate 90 from the start point to the end point of the scribing line with the single stroke is maintained.

An upper substrate cutting device 60 forms a scribing line with a single stroke on the upper surface (first surface) of the bonded mother substrate 90. A lower substrate cutting device 70 forms a scribing line with a single stroke on the lower surface (second surface) of the bonded mother substrate 90.

FIG. 65 shows a cutting processing procedure for cutting the bonded mother substrate 90 according to an embodiment of the present invention. The execution of the cutting processing is, for example, controlled by a computer included in the substrate cutting system 1. The computer controls the movement of the upper substrate cutting device 60, the lower substrate cutting device 70, the scribing device guide body 30 and a substrate supporting device 20.

Hereinafter, a procedure for cutting the bonded mother substrate 90 using the substrate cutting system 1 will be described step by step.

The procedure for cutting the bonded mother substrate 90 using the substrate cutting device 1 includes a scribing step and a breaking step. As necessary, an initial setting step is performed.

Step 1101: The initial setting step is performed. The initial setting step is a step for setting an initial state of the substrate cutting system 1 before the scribing step is started.

After the initial setting step is completed, the process continues to step 1102.

Step 1102: The scribing step is performed. The scribing step is a step for forming a scribe line on the bonded mother substrate 90. The scribing step will be described later in detail.

After the scribing step is completed, the process continues to step 1103.

Step 1103: The breaking step is performed. The breaking step is a step for breaking the bonded mother substrate 90 along the scribe line.

After the breaking step is completed, the process is terminated.

Hereinafter, the scribing step performed in step 1102 (see FIG. 65) will be described in detail.

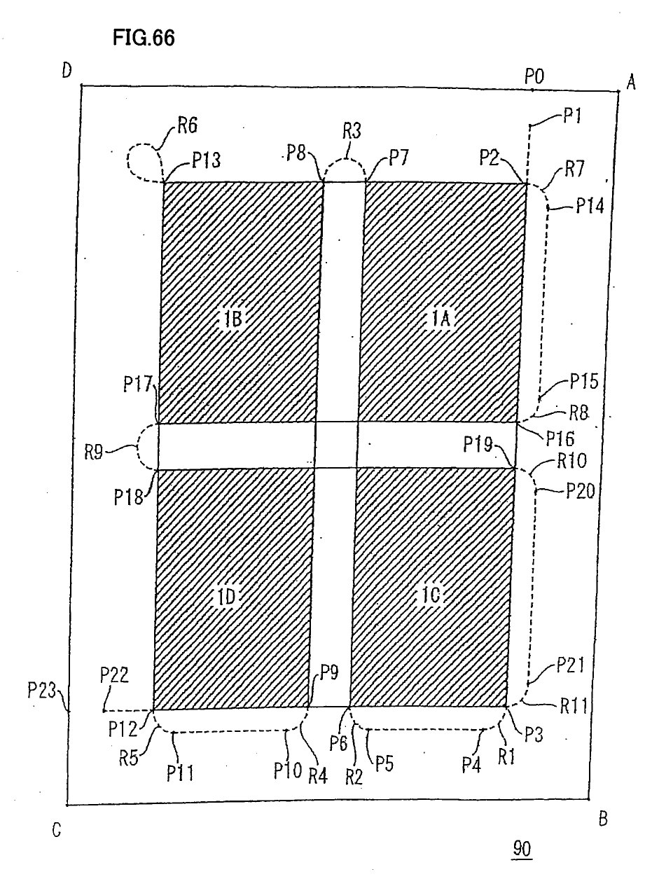

FIG. 66 shows the upper surface of the bonded mother substrate 90 which is used in the scribing step performed in step 1102 (FIG. 65). A line to be scribed is formed in the upper surface of the bonded mother substrate 90. When the upper substrate cutting device 60 and the lower substrate cutting device 70 are moved along the line to be scribed, a scribing line is formed the upper surface of the on the bonded mother substrate 90. A line to be scribed is also formed on the lower surface of the bonded mother substrate 90, the line to be scribed corresponding to the line to be scribed on the upper surface of the bonded mother substrate 90.

The line to be scribed formed on the upper surface of the bonded mother substrate 90 includes a plurality of straight lines (straight line P1P2, straight line P2P3, straight line P4P5, straight line P6P7, straight line P8P9, straight line P10P11, straight line P12P13, straight line P13P2, straight line P14P15, straight line P16P17, straight line P18P19, straight line P20P21, straight line P3P12 and straight line P12P22) and a plurality of curves (curve R1 to curve R11).

When the substrate cutting system 1 forms the scribing line along the line to be scribed and breaks the scribing line along the bonded mother substrate 90, it cuts the bonded mother substrate 90 to retrieve unit substrates 1A, 1B, 1C and 1D.

Of the bonded mother substrate 90, the unit substrate 1A is a portion circumscribed by the straight line P2P3, the straight line P6P7, the straight line P13P2 and the straight line P16P17. Of the bonded mother substrate 90, the unit substrate 1B is a portion circumscribed by the straight line P8P9, the straight line P12P13, the straight line P13P2 and the straight line P16P17. Of the bonded mother substrate 90, the unit substrate 1C is a portion circumscribed by the straight line P2P3, the straight line P6P7, the straight line P18P19 and the straight line P3P12. Of the bonded mother substrate 90, the unit substrate 1D is a portion circumscribed by the straight line P8P9, the straight line P12P13, the straight line P18P19 and the straight line P3P12. The unit substrates 1A, 1B, 1C and 1D are arranged with appropriate spaces between each other.

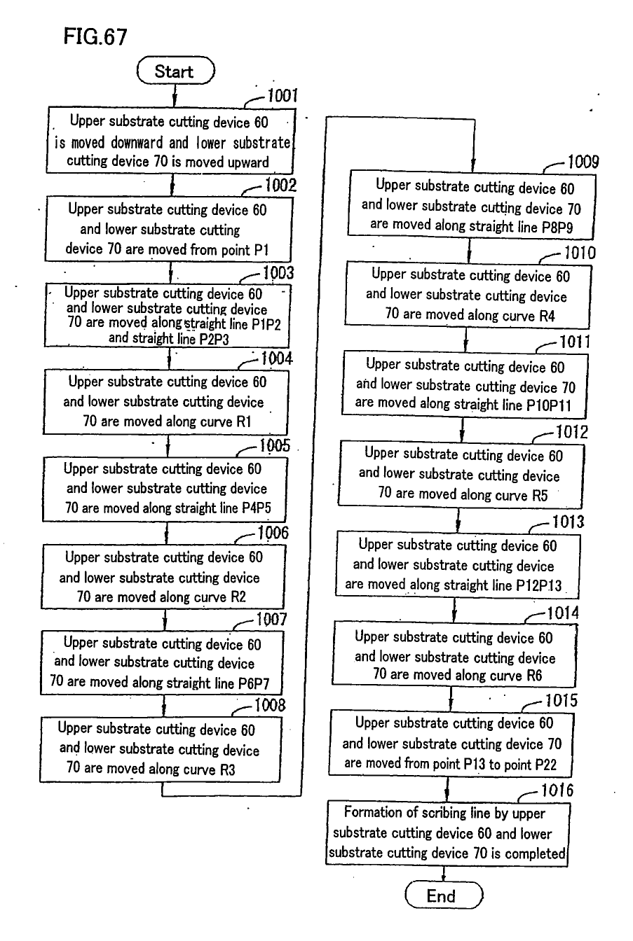

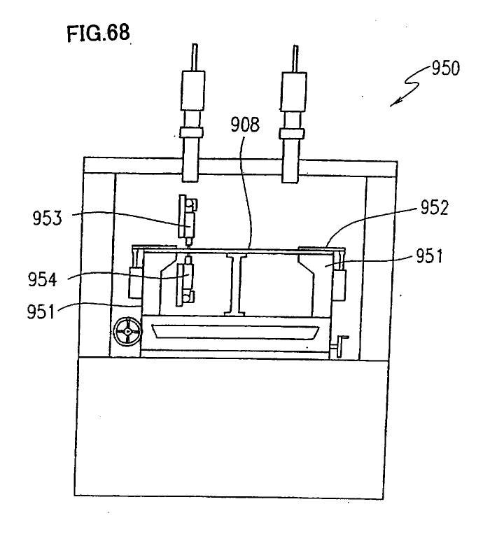

FIG. 67 is a scribing procedure which is performed during the scribing step performed in step 1102 (see FIG. 65).

Hereafter, the scribing procedure will be described step by step with reference to FIGS. 66 and 67.

Step 1001: The computer controls the upper substrate cutting device 60 and the lower substrate cutting device 70 such that the upper substrate cutting device 60 moves downward and the lower substrate cutting device 70 moves upward, both of which are at predetermined waiting positions. When the upper substrate cutting device 60 moves downward to a position of 0.1 mm to 0.2 mm from the upper surface of the bonded mother substrate 90 and the lower substrate cutting device 70 moves upward to a position of 0.1 mm to 0.2 mm from the lower surface of the bonded mother substrate 90, the cutter wheels 62a, respectively, press the bonded mother substrate 90 so as to sufficiently respond to concave-convex portions of both main surfaces of the bonded mother substrate 90. The upper substrate cutting device 60 and the lower substrate cutting device 70 are moved along an upper guide rail 31 and a lower guide rail 32, respectively.

Step 1002: Formation of the scribing line starts from the outer circumferential edge (an area circumscribed by an area ABCD and an area P2P3P12P13) of the bonded mother substrate 90. Specifically, while each cutter wheel 62a is pressed onto the bonded mother substrate 90, each cutter wheel 62a is moved along the line to be scribed from point P1 (a point within the outer circumferential edge of the mother substrate). Thus, scribing lines are formed on both main surfaces of the bonded mother substrate 90.

Step 1003: Scribing lines are formed along an outside’ side of the unit substrate. Specifically, while each cutter wheel 62a is pressed onto the bonded mother substrate 90, the upper substrate cutting device 60 and the lower substrate cutting device 70 are moved along the straight line P1P2 and the straight line P2P3. Thus, scribing lines are formed on both main surfaces of the bonded mother substrate 90.

Step 1004: Scribing lines are formed at an outer circumferential edge of the bonded mother substrate 90. Specifically, while each cutter wheel 62a is pressed onto the bonded mother substrate 90, the upper substrate cutting device 60 and the lower substrate cutting device 70 are moved along the curve R1. Thus, scribing lines are formed on both main surfaces of the bonded mother substrate 90. The upper substrate cutting device 60 and the lower substrate cutting device 70 are moved such that the track of each cutter wheel 62a has an arc (curve R1) with a central angle of 90 degrees.

Step 1005: Scribing lines are formed at an outer circumferential edge of the bonded mother substrate 90. Specifically, while each cutter wheel 62a is pressed onto the bonded mother substrate 90, the upper substrate cutting device 60 and the lower substrate cutting device 70 are moved along the straight line P4P5. Thus, scribing lines are formed on both main surfaces of the bonded mother substrate 90.

Step 1006: Scribing lines are formed at an outer circumferential edge of the bonded mother substrate 90. Specifically, while each cutter wheel 62a is pressed onto the bonded mother substrate 90, the upper substrate cutting device 60 and the lower substrate cutting device 70 are moved along the curve R2. Thus, scribing lines are formed on both main surfaces of the bonded mother substrate 90. The upper substrate cutting device 60 and the lower substrate cutting device 70 are moved such that the track of each cutter wheel 62a has an arc (curve R2) with a central angle of 90 degrees.

Step 1007: While each cutter wheel 62a is pressed onto the bonded mother substrate 90, the upper substrate cutting device 60 and the lower substrate cutting device 70 are moved within the area between the unit substrates. Thus, scribing lines are formed along the inside’ side of the unit substrates. Specifically, while each cutter wheel 62a is pressed onto the bonded mother substrate 90, the upper substrate cutting device 60 and the lower substrate cutting device 70 are moved along the straight line P6P7. Thus, scribing lines are formed on both main surfaces of the bonded mother substrate 90.

Step 1008: Scribing lines are formed at an outer circumferential edge of the bonded mother substrate 90. Specifically, while each cutter wheel 62a is pressed onto the bonded mother substrate 90, the upper substrate cutting device 60 and the lower substrate cutting device 70 are moved along the curve R3. Thus, scribing lines are formed on both main surfaces of the bonded mother substrate 90. The upper substrate cutting device 60 and the lower substrate cutting device 70 are moved such that the track of each cutter wheel 62a has an arc (curve R3) with a central angle of 180 degrees.

Step 1009: While each cutter wheel 62a is pressed onto the bonded mother substrate 90, the upper substrate cutting device 60 and the lower substrate cutting device 70 are moved within the area between the unit substrates. Thus, scribing lines are formed along the inside side of the unit substrates. Specifically, while each cutter wheel 62a is pressed onto the bonded mother substrate 90, the upper substrate cutting device 60 and the lower substrate cutting device 70 are moved along the straight line P8P9. Thus, scribing lines are formed on both main surfaces of the bonded mother substrate 90.

Step 1010: Scribing lines are formed at an outer circumferential edge of the bonded mother substrate 90. Specifically, while each cutter wheel 62a is pressed onto the bonded mother substrate 90, the upper substrate cutting device 60 and the lower substrate cutting device 70 are moved along the curve R4. Thus, scribing lines are formed on both main surfaces of the bonded mother substrate 90. The upper substrate cutting device 60 and the lower substrate cutting device 70 are moved such that the track of each cutter wheel 62a has an arc (curve R4) with a central angle of 90 degrees.

Step 1011: Scribing lines are formed at an outer circumferential edge of the bonded mother substrate 90. Specifically, while each cutter wheel 62a is pressed onto the bonded mother substrate 90, the upper substrate cutting device 60 and the lower substrate cutting device 70 are moved along the straight line P10P11. Thus, scribing lines are formed on both main surfaces of the bonded mother substrate 90.

Step 1012: Scribing lines are formed at an outer circumferential edge of the bonded mother substrate 90. Specifically, while each cutter wheel 62a is pressed onto the bonded mother substrate 90, the upper substrate cutting device 60 and the lower substrate cutting device 70 are moved along the curve R5. Thus, scribing lines are formed on both main surfaces of the bonded mother substrate 90. The upper substrate cutting device 60 and the lower substrate cutting device 70 are moved such that the track of each cutter wheel 62a has an arc (curve R5) with a central angle of 90 degrees.

Step 1013: Scribing lines are formed along an outside side of the unit substrate. Specifically, while each cutter wheel 62a is pressed onto the bonded mother substrate 90, the upper substrate cutting device 60 and the lower substrate cutting device 70 are moved along the straight line P12P13. Thus, scribing lines are formed on both main surfaces of the bonded mother substrate 90.

Step 1014: Scribing lines are formed at an outer circumferential edge of the bonded mother substrate 90. Specifically, while each cutter wheel 62a is pressed onto the bonded mother substrate 90, the upper substrate cutting device 60 and the lower substrate cutting device 70 are moved along the curve R6. Thus, scribing lines are formed on both main surfaces of the bonded mother substrate 90. The upper substrate cutting device 60 and the lower substrate cutting device 70 are moved such that the track of each cutter wheel 62a has a smooth arc (curve R6).

Step 1015: The control section presses each cutter wheel 62a onto the bonded mother substrate 90, and moves the upper substrate cutting device 60 and the lower substrate cutting device 70, in the following order, along the straight line P13P2, the curve R7, the straight line P14P15, the curve R8, the straight line P16P17, the curve R9, the straight line P18P19, the curve R10, the straight line P20P21, the curve R11, the straight line P3P12 and the straight line P12P22. Thus, scribing lines are formed on both main surfaces of the bonded mother substrate 90.

Step 1016: Formation of the scribing line is completed at point P22.

When the upper substrate cutting device 60 is moved upward to the predetermined position and the lower substrate cutting device 70 is moved downward to the predetermined position, the scribing step is completed.

As shown in steps 1001 to 1016, while each cutter wheel 62a is pressed onto the bonded mother substrate 90 such that the pressing of each cutter wheel 62a onto the bonded mother substrate 90 is not interrupted, the upper substrate cutting device 60 and the lower substrate cutting device 70 are moved from point P1 to point P22. As a result, the scribing lines are formed on the bonded mother substrate 90 for cutting the unit substrates 1A, 1B, 1C and 1D from the bonded mother substrate 90. Thus, the scribing line for cutting the unit substrate 1A from the bonded mother substrate 90 and the scribing line for cutting the unit substrate 1B from the bonded mother substrate 90 are formed without stopping the movement of pressure onto the bonded mother substrate 90. Thus, the scribing processing time for forming the scribing lines can be reduced. The scribing lines formed on the bonded mother substrate 90 can prevent the bonded mother substrate 90 from being cut by an external factor (e.g., the movement of the substrate supporting device). Furthermore, since the mother substrate is unlikely to be cut into two or more portions during forming the scribing lines, it is unlikely that a chip, an oblique cut face or the like will be created on the cut faces of the unit substrate onto which steam is sprayed by the steam unit section (above, function of claims 52 to 55).

According to the scribing procedure, the upper substrate cutting device 60 and the lower substrate cutting device 70 are moved along a curve (e.g., 2.0R to 6.0R) for cutting the unit substrate 1A from the bonded mother substrate 90 such that a scribing line formed along a first direction and a scribing line to be formed along a second direction, which is different from the first direction, are connected by a curve. Thus, scribing lines are formed on both main surfaces of the bonded mother substrate 90. For example, where the moving direction of the upper substrate cutting device 60 and the lower substrate cutting device 70 changes to a direction along the straight line P4P5 from a direction along the straight line P2P3 (curve R1), while each cutter wheel 62a is pressed onto the bonded mother substrate 90, the upper substrate cutting device 60 and the lower substrate cutting device 70 are moved along the curve R1. Thus, scribing lines are formed on both main surfaces of the bonded mother substrate 90 (see FIG. 66).

As described above, the pressure onto the bonded mother substrate 90 can be moved such that the scribing line formed along the first direction and the scribing line to be formed along the second direction are connected by a curve. Thus, damage to each cutter wheel 62a can be reduced, the damage being created when the direction of each cutter wheel 62a is changed from the first direction to the second direction (above, function of claim 57).

Furthermore, as described with reference to FIG. 14, when a cutter head 65 including a servo motor is used, the response to the strength of the load to be transmitted to each cutter wheel 62a can be quicker. Thus, when the pressure of each cutter wheel 62a moves from an inside side of a unit substrate or an outside side of the unit substrate to an outer circumferential edge of the bonded mother substrate 90, the load onto each cutter wheel 62a can be reduced. Furthermore, when the pressure of each cutter wheel 62a is moved on the outer circumferential edge of the bonded mother substrate 90, the load onto each cutter wheel 62a can be reduced compared to the load when each cutter is moving on other portions.

Specifically, when each cutter wheel 62a is moved on a broken line (the straight line P1P2, the curve R1, the straight line P4P5, the curve R2, the curve R3, the curve R4, the straight line P10P11, the curve R5, the curve R6, the curve R7, the straight line P14P15, the curve R8, the curve R9, the curve R10, the straight line P20P21, the curve R11 and the straight line P12P22: see FIG. 66) of the line to be scribed, the load onto each cutter wheel 62a can be reduced.

As described above, in the case where the cutter head 65 including the servo motor is used, when each cutter wheel 62a scribes the bonded mother substrate 90, the pressure of each cutter wheel 62a onto the bonded mother substrate 90 can be reduced at an arbitrary location. Thus, abrasion, damage or the like of the cutter wheel 62a can be suppressed, and the cutter wheel 62a can be stably used for a long period of time (above, function of claim 56).

The substrate cutting system, substrate manufacturing apparatus and the substrate cutting method according to the present invention have been described above with reference to FIGS. 1 to 67. However, the present invention should not be interpreted solely based on the embodiments described above. It is understood that the scope of the present invention should be interpreted solely based on the claims. It is also understood that those skilled in the art can implement equivalent scope of technology, based on the description of the present invention and common knowledge from the description of the detailed preferred embodiments of the present invention. Furthermore, it is understood that any patent, any patent application and any references cited in the present specification should be incorporated by reference in the present specification in the same manner as the contents are specifically described therein.

### INDUSTRIAL APPLICABILITY

The substrate cutting system according to the present invention is capable of simultaneously performing a cutting processing in two directions orthogonal to each other on the top and bottom surfaces of the substrate with one setting of the substrate since the substrate cutting system according to the present invention has a structure that the substrate is held by clamp devices and is supported by a substrate supporting device which slides in accordance with to the movement of a cutting guide body. Thus, the size of the entire system can be reduced, and a variety of substrates can be effectively cut.

In the field of a substrate cutting system and a substrate cutting line system which are used for cutting a variety of mother substrate materials, such as a glass substrate used for a display panel of a liquid crystal display device, etc., the objective thereof is to make the footprint of the substrate cutting system and the substrate cutting line system reduced and compact and to efficiently cut a variety of mother substrates.

1. A substrate cutting system, comprising:
a pair of scribing line forming means arranged facing each other;
a pair of scribing devices for supporting the pair of scribing forming line means such that one of the pair of scribing forming line means moves on a first surface of a substrate in an X axial direction and the other of the pair of scribing forming means moves on a second surface of the substrate in the X axial direction;
a scribing device guide body for supporting the pair of scribing devices such that the pair of scribing devices moves in a Y axial direction; and
a substrate supporting means for supporting the substrate in an X-Y plane such that the pair of scribing forming line means scribes the first surface of the substrate and the second surface of the substrate.

2. A substrate cutting system according to claim 1, wherein the substrate supporting means includes:
a substrate supporting device being supporting by the scribing device guide body and moving together with the pair of scribing devices in the Y axial direction; and
a fixing device for fixing the substrate in the X-Y plane.

3. A substrate cutting system according to claim 2, wherein the substrate supporting device supports the substrate such that the substrate supporting device does not rub the substrate or exert any force on the substrate when the pair of scribing devices and the scribing device guide body move in the Y axial direction.

4. A substrate cutting system according to claim 2, wherein the substrate supporting device includes:
a first substrate supporting section being provided on one side of the substrate supporting device with respect to a moving direction of the scribing device guide body.

5. A substrate cutting system according to claim 4, wherein the first substrate supporting section includes a plurality of first substrate supporting units, the plurality of first substrate supporting units moving in parallel along the moving direction of the scribing device guide body, and
the plurality of first substrate supporting units moves together with the scribing device guide body along with the movement of the scribing device guide body.

6. A substrate cutting system according to claim 5, wherein the first substrate supporting unit includes a substrate supporting means for supporting the substrate.

7. A substrate cutting system according to claim 6, wherein the substrate supporting section is a plurality of cylindrical rollers.

8. A substrate cutting system according to claim 7, comprising at least one rotation transmission means for rotating the plurality of cylindrical rollers in accordance with the movement of the scribing device guide body.

9. A substrate cutting system according to claim 7, comprising a control section for rotating the plurality of cylindrical rollers in accordance with the movement of the scribing device guide body.

10. A substrate cutting system according to claim 6, wherein the substrate supporting means is a plurality of belts.

11. A substrate cutting system according to claim 10, comprising at least one rotation transmission means for circling the plurality of belts in accordance with the movement of the scribing device guide body.

12. A substrate cutting system according to claim 10, comprising a control section for circling the plurality of belts using a motor in accordance with the movement of the scribing device guide body.

13. A substrate cutting system according to claim 2, wherein the substrate supporting device includes:
a second substrate supporting section being provided on another side of the substrate supporting device with respect to a moving direction of the scribing device guide body.

14. A substrate cutting system according to claim 13, wherein the second substrate supporting section includes a plurality of second substrate supporting units, the plurality of second substrate supporting units moving in parallel along the moving direction of the scribing device guide body.

15. A substrate cutting system according to claim 14, wherein the second substrate supporting unit includes a substrate supporting means for supporting the substrate.

16. A substrate cutting system according to claim 15, wherein the substrate supporting section is a plurality of cylindrical rollers.

17. A substrate cutting system according to claim 16, comprising at least one rotation transmission means for rotating the plurality of cylindrical rollers in accordance with the movement of the scribing device guide body.

18. A substrate cutting system according to claim 16, comprising a control section for rotating the plurality of cylindrical rollers in accordance with the movement of the scribing device guide body.

19. A substrate cutting system according to claim 15, wherein the substrate supporting means is a plurality of belts.

20. A substrate cutting system according to claim 19, comprising at least one rotation transmission means for circling the plurality of belts in accordance with the movement of the scribing device guide body.

21. A substrate cutting system according to claim 19, comprising a control section for circling the plurality of belts using a motor in accordance with the movement of the scribing device guide body.

22. A substrate cutting system according to claim 1, wherein the pair of scribing devices each includes a cutter head for transmitting a pressing force of the scribing forming means onto the substrate using a servo motor.

23. A substrate cutting system according to claim 1, comprising a steam unit section for spraying steam onto the first surface and the second surface of the substrate.

24. A substrate cutting system according to claim 23, wherein a substrate drying means is provided in the steam unit section, the substrate drying means being for drying the first surface and the second surface of the substrate.

25. A substrate cutting system according to claim 24, wherein the substrate drying means includes:
at least one air knife body having a slit section formed thereon, the slit section capable of discharging a pressurized gas;
an air knife supporting section for supporting the at least one air knife body such that a fluid lead-in path is formed between the at least one air knife body and a main surface of the substrate in a substrate transportation path, the at least one air knife body and the substrate move relative to each other in the substrate transportation path, the fluid lead-in path having approximately a uniform shape in a direction perpendicular to the relative moving direction; and
a wall face, arranged facing the at least one air knife body in the relative moving direction, for constituting a fluid lead-out path, the fluid lead-out path leading out the dry gas such that the dry gas, which has been discharged from the slit section and passed through the fluid lead-in path, moves away from the main surface of the substrate.

26. A substrate cutting system according to claim 25, wherein the wall face is arranged at a position facing the at least one air knife unit body such that a fluid-sectional area of the fluid lead-out path is larger than fluid-sectional area of the fluid lead-in path.

27. A substrate cutting system according to claim 25, wherein the air knife supporting section includes a clearance adjustment means for adjusting a clearance between the at least one air knife body and the main face of the substrate using the Venturi effect which occurs when the dry gas passes through the fluid lead-in path.

28. A substrate cutting system according to claim 27, wherein the clearance adjustment means includes:
an elastic member for supporting the at least one air knife body between the elastic member and the main surface of the substrate in an oscillating manner; and
a laminar flow forming face for passing the dry gas between the laminar flow forming face and the main surface of the substrate in a laminar flow state, the laminar flow forming face being formed on one side surface of the at least one air knife body, the one side surface facing the main surface of the substrate and forming a portion of the fluid lead-in path.

29. A substrate cutting system according to claim 25, wherein each side of the at least one pair of air knife bodies on which the slit section is formed is arranged facing each other.

30. A substrate cutting system according to claim 26, wherein each side of the at least one air knife body on which the slit section is formed is arranged facing each other.

31. A substrate cutting system according to claim 23, comprising a substrate carry-out device for retrieving the substrate cut by the steam unit section.

32. A substrate cutting system according to claim 31, wherein the substrate carry-out device includes a carry-out robot,
the carry-out robot includes:
a substrate holding means for holding the substrate;
a substrate rotating means for rotating the substrate holding means, having the substrate supported thereby, around a first axis vertical to the substrate; and
a substrate circling means for circling the substrate rotating means around a second axis, the second axis being different from the first axis vertical to the substrate held by the substrate holding means.

33. A substrate cutting system according to claim 32, wherein the circling of the substrate holding means by the substrate circling means is transmitted to the substrate rotating means by a dynamic power transmission mechanism which results in the rotation of the substrate rotating means to rotate.

34. A substrate cutting system according to claim 33, wherein the rotating direction of the substrate holding means by the substrate rotating means is opposite to the circling direction of the substrate holding means by the substrate circling means.

35. A substrate cutting system according to claim 34, wherein the rotating angle of the substrate holding means by the substrate rotating means is twice the circling angle of the substrate holding means by the substrate circling means.

36. A substrate cutting system according to claim 32, wherein the rotating drive of the substrate holding means by the substrate rotating means and the circling drive of the substrate holding means by the substrate circling means are independent from each other.

37. A substrate cutting system according to claim 36, wherein the dynamic power supply of the substrate rotating means and the dynamic power supply of the substrate circling means are independent from each other.

38. A substrate cutting system according to claim 31, further comprising a substrate inversion device for inverting the top and bottom surfaces of the substrate transported by the substrate transportation device.

39. A substrate cutting system according to claim 1, comprising a positioning unit section for positioning the substrate.

40. A substrate cutting system according to claim 39, wherein the positioning unit section includes a plurality of vacuum adsorption heads for holding the substrate.

41. A substrate cutting system according to claim 32, wherein the substrate holding means is a plurality of vacuum adsorption heads for holding the substrate.

42. A substrate cutting system according to claim 40, wherein the vacuum adsorption head includes:
a vacuum adsorption pad for vacuum-adsorbing the substrate;
a suction shaft for holding the suction pad and having an exhaust hole provided thereon, the exhaust hole for exhausting air into the adsorption pad;
a casing section for regulating the moving range of the suction shaft to hold the suction shaft such that the suction shaft is slightly movable; and
an elastic supporting member for elastically holding the suction shaft such that the suction shaft is slightly movable within the casing section in its axial direction and in a direction oblique to the axial direction.

43. A substrate cutting system according to claim 42, wherein the suction shaft includes the step section in a shape of handguard provided at approximately in the middle of the casing section,
the casing section includes:
a cylindrical section having a space therewithin, the space for holding the elastic supporting member such that the elastic supporting member is deformable;
an upper casing plate for closing an upper end of the cylindrical section with a first opening remaining open; and
a lower casing plate for closing a lower end of the cylindrical section with a second opening remaining open,
the elastic supporting section includes:
an upper spring held between the upper casing plate and the step section;
a lower spring held between the lower casing plate and the step section.

44. A substrate cutting system according to claim 40, wherein the plurality of vacuum adsorption heads includes a plurality of adsorption pads for holding the substrate by suction or causing compressed air to gush so as to float the substrate, and
the plurality of vacuum adsorption heads positions the substrate in a state in which a laminar flow is formed between each of the plurality of adsorption pads and the substrate.

45. A substrate cutting system according to any one of claims 31, 32 and 38, comprising a removal means for removing an unnecessary portion of the cut substrate.

46. A substrate cutting system according to claim 10, wherein the plurality of belts is wound around between a frame on a carry-in side of the substrate and a frame on a carry-out side of the substrate, and
the plurality of belts lowers below the scribing device guide body or emerges above the scribing device guide body from under the scribing device guide body while the first substrate supporting section is moving.

47. A substrate cutting system according to claim 19, wherein the plurality of belts is wound around between a frame on a carry-in side of the substrate and a frame on a carry-out side of the substrate, and
the plurality of belts lowers below the scribing device guide body or emerges above the scribing device guide body from under the scribing device guide body while the second substrate supporting section is moving.

48. A substrate cutting system according to claim 1, wherein the substrate is a bonded mother substrate for which a pair of mother substrates are bonded to each other.

49. A substrate manufacturing apparatus, comprising:
a substrate cutting system according to claim 1; and
a chamfering system for chamfering an edge face of a cut substrate,
wherein the substrate cutting system is connected to the chamfering system.

50. A substrate manufacturing apparatus, comprising:
a substrate cutting system according to claim 1; and
an inspection system for inspecting the function of a cut substrate,
wherein the substrate cutting system is connected to the inspection system.

51. A substrate manufacturing apparatus according to claim 49, further comprising an inspection system for inspecting the function of the cut substrate.

52. A method for cutting a plurality of unit substrates from a mother substrate, the method comprising:
a forming step of forming scribing lines on a first surface of the mother substrate and a second surface of the mother substrate by a pair of scribing line forming means,
the forming step includes the step of forming, on the mother substrate, a first scribing line for cutting a first unit substrate from the mother substrate and a second scribing line for cutting a second unit substrate from the mother substrate by moving the pressure onto the mother substrate by each of the pair of scribing line forming means such that the pressure onto the mother substrate is not interrupted.

53. A substrate cutting method according to claim 52 wherein the forming step further includes the step of forming number N scribing line for cutting number N unit substrate from the mother substrate by moving the pressure onto the mother substrate such that the pressure onto the mother substrate is not interrupted, and N is an integer which is larger than or equal to 3.

54. A substrate cutting method according to claim 52 wherein the forming step includes the steps of:
(1) forming the scribing line on the mother substrate by moving the pressure onto the mother substrate along the outside side of the first unit substrate and the outside side of the second unit substrate;
(2) forming the scribing line on the mother substrate by moving the pressure onto the mother substrate on an edge of an outer circumference of the mother substrate; and
(3) forming the scribing line on the mother substrate by moving the pressure onto the mother substrate along the inside side of the first unit substrate and the inside side of the second unit substrate.

55. A substrate cutting method according to claim 54 wherein the inside side of the second unit substrate faces the insides side of the first unit substrate,
the step (3) includes the steps of:
(3a) forming the scribing line on the mother substrate by moving the pressure onto the mother substrate along the inside side of the first unit substrate;
(3b) after performing (3a), forming the scribing line on the mother substrate by moving the pressure onto the mother substrate on an edge of an outer circumference of the (mother) substrate;
(3c) after performing (3b), forming the scribing line on the mother substrate by moving the pressure onto the mother substrate along the inside side of the second unit substrate;
(3d) after performing (3c), forming the scribing line on the mother substrate by moving the pressure onto the mother substrate on an edge of an outer circumference of the (mother) substrate;

56. A substrate cutting method according to claim 52 wherein the forming step further includes the step of reducing the pressure onto the mother substrate.

57. A substrate cutting method according to claim 52 wherein the forming step includes the steps of:
forming the scribing line along a first direction; and
moving the pressure onto the mother substrate such that a scribing line formed along the first direction and a scribing line to be formed along a second direction are connected to each other by a curve, the second direction being different from the first direction.

58. A method for cutting a brittle material substrate, the brittle material substrate being cut by a device,
the device including:
a substrate supporting device for supporting a lower surface of the brittle material substrate and fixing at least one end of the brittle material substrate; and
a pair of scribing line forming means arranged on both sides of the brittle material substrate's surface, the pair of scribing forming section facing each other with the brittle material substrate therebetween,
the substrate supporting device has a space in the center of the substrate supporting device,
the pair of scribing line forming means is arranged in the space in the middle of the substrate supporting device,
the method comprising the step of:
moving the pair of scribing line forming means in at least one direction of an X axial direction and a Y axial direction and further moving the substrate supporting device in at least one direction of the X axial direction and the Y axial direction so as to cut the brittle material substrate.

59. A substrate cutting method according to claim 58, wherein the substrate supporting device supports the brittle material substrate so as not to rub the substrate or exert any force on the brittle material substrate.
